(19) United States
(12) Patent Application Publication
(10) Pub. No.: US 2011/0141027 A1
(43) Pub. Date: Jun. 16, 2011

(54) DATA ENTRY SYSTEM

(75) Inventor: Benjamin Firooz Ghassabian, Jerusalem (IL)

(73) Assignee: KEYLESS SYSTEMS LTD., Jerusalem (IL)

(21) Appl. No.: 13/059,049

(22) PCT Filed: Aug. 12, 2009
(86) PCT No.: PCT/IL09/00790

§ 371 Date: Feb. 14, 2011

Related U.S. Application Data
(60) Provisional application No. 61/136,104, filed on Aug. 12, 2008.

(30) Foreign Application Priority Data
Aug. 17, 2008 (IL) 193506
Aug. 24, 2008 (IL) 193644
Aug. 28, 2008 (IL) 193745
Sep. 9, 2008 (IL) 194002
Oct. 12, 2008 (IL) 194708
Oct. 22, 2008 (IL) 194731

(51) Int. Cl. G06F 3/02; G06F 3/041

(52) U.S. Cl. 345/168; 345/173

(57) ABSTRACT

A data entry system including a plurality of first keys, a plurality of second keys, a display and a processor adapted to interpret a first type of user interaction with the first keys as entrance of one or more characters and to interpret a second type of interaction with the first keys as mode signals which change the meanings of at least three of the second keys.

### RELATED APPLICATIONS

The present application claims the benefit, under 35 USC 119(e), of U.S. provisional application U.S. Ser. No. 61/136,104 filed Aug. 12, 2008, and Israeli patent applications:
193506 filed Aug. 17, 2008,
193644 filed Aug. 24, 2008,
193745 filed Aug. 28, 2008,
194002 filed Sep. 9, 2008,
194708 filed Oct. 12, 2008,
194731 filed Oct. 22, 2008,
   the disclosures of which are all incorporated herein by reference in their entirety.

This application is also related to various prior PCT publication, including WO01/131788, titled “Integrated Keypad System”, WO03/007288 titled “Features to Enhance Data Entry Through a Small Data Entry Unit”, WO04/095414 titled “System to Enhance Data Entry in Mobile and fixed Environment”, WO05/122401 titled “System to Enhance Data Entry in Mobile and fixed Environment”, WO07/114,833 titled “Data Entry System”, WO08/114,086 titled “Combined Data Entry Systems”, and PCT application WO09/027,817 titled “Improved Data Entry System”, the disclosures of all of which are also incorporated herein, by reference, in their entirety.

### FIELD OF THE INVENTION

The present invention relates to data input devices and particularly to devices and methods for entering data/text including letters and other symbols.

### BACKGROUND OF THE INVENTION

Mobile devices such as cellular phones, personal digital aids and miniature computers are widely used as they are easily carried around and can perform many tasks. One problem of the mobile devices is text entry, which is problematic due to their small size. One solution for text entry in mobile devices is using a limited key set in which at least some of the keys are ambiguously associated with a plurality of letters. Upon receiving a sequence of key strokes, a word dictionary is consulted to predict the word intended by the user. Such a solution is described, for example, in U.S. Pat. No. 5,818,437 to Grover et al., titled: “Reduced Keyboard Disambiguating Computer” and in US patent publication 2003/0193478 to Ng et al., titled: “Reduced Keyboard System that Emulates QWERTY-type Mapping and Typing”, the disclosures of which are incorporated herein by reference in their entirety.

One problem with the use of ambiguous keys is when a user inadvertently presses an incorrect key. In such cases the system will suggest to the user words that were not intended. The user then needs to erase the incorrect letter and enter the correct key stroke.

U.S. Pat. No. 5,818,437 suggests providing in addition to a main window, an additional window which provides feedback on the keys pressed, in the form of the letters associated with each key pressed for the current word. In one embodiment, the U.S. Pat. No. 5,818,437 suggests displaying a plurality of possible words directly in the main window for the user to select the intended word. These feedback methods may however be confusing and may not provide the user sufficient ease in identifying errors in typing.

It also has been suggested to encode all the letters of the alphabet by pairs of keys. Such suggestions are described, for example, in US patent publication 2006/0066583 to Toutonghi et al., titled: “Text entry method and system using a numeric or non-QWERTY keypad” and in U.S. Pat. No. 5,982,303 to Smith, titled: “Method for Entering Alphanumeric Data”, the disclosures of which are incorporated herein by reference in their entirety. This method, however, requires that the user remember the key sequences for all the letters.

Another problem of mobile devices is entering symbols other than the alphanumeric characters. The number of keys on the mobile devices is limited and various methods have been suggested to allow simple entering of symbols with limited keys. Still there is a need for better solutions.

Some mobile devices receive user input through a touch screen. Touch screens are also used on non-portable devices. US patent application 2007/0097092 to Jung et al., titled: “Method of using a Touch Screen and user interface apparatus employing the same”, the disclosure of which is incorporated herein by reference in its entirety, describes using a touch screen with a plurality of zones having identical keys for different users.

US patent publication 2009/0073002 to Alvarado describes a scheme in which the letters of the alphabet are entered by straight line traces on a touch screen. The touch screen is divided into various cells and traces in different locations are given different interpretations.

US patent publication 2002/0180797 to Backmann uses a combined method of strokes and key presses to enter words. The strokes are assigned to the vowels and to shortcuts.

U.S. Pat. No. 7,519,748 to Kuzmin, titled: “Stroke-Based Data Entry Device, System and Method”, describes a method in which strokes are associated with letters for input. The strokes are interpreted according to their direction and their starting zone.

U.S. Pat. No. 7,170,496 to Middleton, describes an input method using gestures of a data entry system. The system provides feedback in the form of the symbol corresponding to the gesture currently entered, so the user can change the gesture if necessary.

These methods require that the user remember the associations between the strokes and the letters, which may be problematic for some users.

Several other input methods may be used with a keyboard having few keys wherein to each of at least some of said keys more than one symbol such as character or letter are ambiguously assigned. In such keypads, generally an (e.g. a predefined) interaction such as a pressing action on a key may ambiguously correspond to any of the symbols assigned to the key (e.g. such key may be called “ambiguous key”).

According to one method, a multi-tap scheme in which the user indicates the intended letters by using different numbers of taps on the same key may be used for disambiguation. Use of a multi-tap scheme, however, is slow and inconvenient to many users.

According to another method, in order to enter one of the symbols (e.g. such as a letter) among the group of symbols assigned to a key, the user may provide a predefined interaction with the key such as a pressing action on the key and provide a speech information corresponding to the symbol (e.g. such as speaking the appellation of the letter) for selecting the symbol (e.g. a desires letter) among the symbols (e.g. the letters) that are assigned to the key, and wherein the speech information may be detected and analyzed based on at least one of, the user's voice and/or the user's lips movements. According to one method symbols such as letters having ambiguously resembling predefined speech and that are hard to distinguish from each other through their corresponding speech may separately from each other being assigned to different keys.

The data entry systems providing precise characters may be combined with the principles of a word predictive system based on key presses alone, to provide a highly accurate data/text entry system using (e.g. very) few keys. The principles of word predictive systems based on key presses alone are known by people skilled in the art. (e.g. T9).

As an example, for entering the word “ball”, by using a telephone keypad, a user may enter a beginning letter (e.g. “b”) of the word by pressing the key corresponding to said letter and provide a speech corresponding to the letter, and (e.g. then) press the ambiguous letter keys of said keypad corresponding to other letters (e.g. in this example, chain of characters “all”) of the word without speaking. In this example, providing a sequence of key presses only (e.g. without speaking) for (e.g. corresponding to) all of the letters (including the letter “b”) of the word “ball” may also correspond to the word “call”. But because in the above-mentioned example, the beginning letter “b” is precisely entered, the system does not consider the word “call” and may provide the word “ball” which according to a preferred method of selection has the highest frequency of use among the words that correspond to the input information provided by the user.

Alternatively, the user may first provide the ambiguous key presses and the system proposes a word. If the word is not the one the user desires to enter, then the user may proceed to a correction procedure by providing additional information to inform the system of at least one of the precise characters of the word preferably in a specific location within the desired word.

As known by people skilled in the art and described before, the word predictive systems based on key press information use at least a dictionary of words that may also include the corresponding key presses database.

### SUMMARY OF THE INVENTION

This application is generally related to a word predictive data entry system that uses ambiguous and/or unambiguous characters to predict a word. Furthermore, the system is designed to duplicate the functionalities of at least the PC keyboard permitting to enter any special character, command, and function available on the keyboard quickly and easily. The system generally uses a first set of input signals and one or more different sets of second/additional input signals. The main information corresponding to a text input is provided through the first set of input signals. If the output provided by the system based of the input provided through the first input signal is not accurate, then, at least a second set of input signals is also used to help the system to provide an accurate output by considering the input provided through the first and said at least second set of input signals. The first set of input signals has generally less input signals than the second set of input signals.

Although throughout this patent applications, common means such as keys, and interactions such as gliding actions to duplicate key interactions, are generally being used to describe providing said input signals, obviously, any other type of means and interaction may be used by people skilled in the art to provide said input signals to be used with the embodiments, methods, and other features, of the invention.

According to a preferred embodiment of the invention, the system may include a first set of input signals provided for example through a first set of few keys (e.g. the first keypad) wherein at least the letters of one (e.g., or more) language are distributively and ambiguously assigned to at least some (e.g. preferably four) of said few keys such that to each of said at least some of said few keys more than one of said letters are ambiguously assigned (e.g. ambiguous keys). Preferably, said letters are distributed on said keys such that when a user presses the keys corresponding to the characters (e.g. letters) of a desired word (e.g. first input information) mostly the desired word is proposed to the user by the system based on said key presses (e.g. said first input information) alone. It is understood that in some cases the desired word may not be proposed as a first choice to the user (e.g. the desired word may not have the highest priority) and the system may propose another word (e.g. a non desired word that has a higher priority).

According to a preferred embodiment, the system may include at least a second set of input signals provided for example through a second set of keys (e.g. the second keypad) such as a telephone-type keypad keys wherein to at least some of the keys of said second set of keys at least the letters of the same one (e.g., or more) language are distributively assigned such that to each of said at least some of said keys of the second set of keys more than one of said letters are ambiguously assigned.

According to one embodiment of the invention, the letters on said few (e.g. four ambiguous) keys of said first set of keys and the letters on said additional/second set of keys (e.g. telephone-type keypad) may be distributed such that a (e.g. any) key of said ambiguous (letter) keys of said first keypad and a (e.g. any) key of said ambiguous (letter) keys of said second keypad may have at most one common character (e.g. letter).

Thus, by pressing a key of a first set of keys and a key of the second set of keys for a specific character/letter or for a specific character location within a word (e.g. a word may have one or more characters), the user indicates a specific letter/character (e.g. the common letter/character) unambiguously. In other words, in order to enter a precise character/letter the user may first press the key of the first keypad corresponding to said character/letter and then press the key of the second keypad also corresponding to said desired character/letter, or vise-versus. By considering said key presses and the fact that there is at most one common character on the two keys, the system precisely selects/enters the desired (e.g. the common) character/letter.

By using key-presses of two keys, the data entry system of the invention thus provides precise character identification, with the unique, character common to the two keys being unambiguously selected thereby. Although having utility on its own, the system as described hereinabove may usefully be used together with a software based word predictive system wherein ambiguous key selections are compared with words within a database including words and corresponding key press information as known, to predict or confirm the user's intention. The principles of such word predictive systems are known to those skilled in the art.

As an example, in order to enter a desired word, according to one method the user may first provide a first input information by pressing the (ambiguous) keys of the first keypad corresponding to the characters of the desired word. The system may propose a word from the database corresponding to the first input information. In accordance with one method, the word suggested is the word having the highest priority among the words corresponding to the input information. If the proposed word is not the desired word, the user may proceed with what is referred to herein as a correction procedure providing additional input information by pressing a key of the second keypad corresponding to one of the characters, eventually, the first character, of the desired word. By relating the key presses of the first and the second keypad corresponding to the character, and the fact that there is at most one character common to both selected keys, the character is precisely and unambiguously selected, and the system precisely recognizes the character. By considering the combined input information, the system proposes another word from the database corresponding to the combined information. If the new word proposed by the system is not the desired word, the user may provide additional input information, e.g. by pressing the key of the second keypad corresponding to another character preferably the next character of the desired word, and so on, until the system proposes the desired word.

According to another method, the user may first provide precisely at least one character of the desired word as described above, and additionally press the ambiguous keys of the first keypad that (non-uniquely) correspond to the remaining characters of the desired word. By precisely recognizing at least one character of the word and by also considering the ambiguous key presses corresponding to the remaining characters of the word, the system is able to more accurately predict the desired word and proposes it to the user. If the proposed word is not the desired word, the user may provide additional pressing actions on the keys of the second keypad corresponding to the additional characters of the desired word until the system predicts/proposes the desired word.

If the desired word is not in the dictionary, then, in addition to the first input information provided through the first keypad, generally, the user presses the keys of the second keypad corresponding to all of the letters of the desired word.

Preferably, the first keypad of the invention has generally less (letter) keys (e.g. preferably four letter keys) than the second keypad (e.g. a telephone type keypad having eight letter keys). This is because the main portion of a text may be entered through the first keypad without the need of using the second keypad. Obviously, having/using less keys makes the text entry easier and faster.

The data entry system and correction thereof as described hereinabove is a very fast and easy system. Briefly stated, according to a preferred method, the user types the desired word through the first keypad. Generally, the system proposes the right (e.g. desired) word. If not the user begins to retype the word using the second keypad. If the word is in the dictionary, most of the time, the system proposes the word as soon as retyping the word through the second keypad commences. If the word is not in the dictionary, the user generally retypes all of the letters/characters of said word. With such word predictive data/text entry system, the user does not have to worry about if the word is or is not in the dictionary database. He knows that at some point during typing/using the first keypad (e.g. the system may also include a word completion method) or during the retyping procedure using the second keypad the system will propose the desired word.

The first and second sets of keys may support the Latin alphabet and/or any other alphabet of interest, such as Arabic, Hebrew, Korean, etc., or at least portions thereof. Furthermore, the first and second sets of keys may cover additional symbols, such as digits, punctuation marks and/or other symbols conventionally appearing on keyboards. In some embodiments of the invention the system may be used to enter text in languages based on phonetic symbols/alphabet such as Chinese or Japanese.

Alternatively, some symbols which are less frequently used may be provided using unambiguous key strokes, such as using the keys of the first set or of the second set with a state selection key (e.g., a shift button). In one embodiment of the invention one or more of the keys of the first or second set may additionally serve as state selection keys, such as when depressed for longer than a predetermined duration, for example.

Optionally, the number of symbols supported by the system may include substantially all of the elementary symbols, such as alphanumeric characters, punctuation marks, commands, and functions for either the input or editing of a text or for the manipulation of a computer. Other symbols such as macros or portion-of-words (e.g. described in other patent applications filed by this inventor), may also be distributively assigned to the reduced number of keys.

In accordance with an exemplary embodiment of the invention, there is therefore provided: a computerized device, comprising (i) a first input interface adapted to identify a plurality of different first user input signals, (ii) a second input interface adapted to identify a plurality of second user input signals and (iii) a processor configured to ambiguously correspond each of at least one of the first input signals with a first plurality of symbols, and to ambiguously correspond actuation of each of at least one of the second input signals with a second plurality of symbols. The processor associates each of the second plurality of symbols with one of the first input signals, in such a manner that the second plurality of symbols corresponds to a plurality of the first input signals.

The data entry systems of the invention using the first and second set of keys based on principles just described are being described in detail in PCT application WO09/027,817 titled “Improved Data Entry System” filed by this inventor, the disclosures of which are incorporated herein, by reference. It is the purpose of this patent application to provide several enhancements to the data entry systems of the invention.

An aspect of some embodiments of the invention relates to a data entry unit which receives user selections of keys of at least the well known 12 key telephone keypad in the form of gliding actions (e.g. vectors) which indicate respective positions of keys in at least the 12 key telephone pad. For example, the vectors may be interpreted as relating to the key to which the vector points if its start point is at the middle 5 button of the telephone keypad.

Optionally, the data unit is adapted to receive indications of 5 or at least 7 keys of the well known telephone keypad using the vectors. The other keys may be provided using other means or the data unit may not be adapted to receive indications of the other keys.

An aspect of some embodiments of the invention relates to using gliding/taping actions in order to dial a telephone number.

In some embodiments of the invention, the vectors are received in the form of gliding (e.g. swiping) gestures on a touch sensitive surface such as a touch screen of the data entry unit. In another embodiment, the vectors are received in the form of pressing a sequence of two keys in the direction of the vector. Optionally, the vectors are associated with the keys of the 12 key telephone keypad only based on their direction. Alternatively, the length and or the speed of the vector is also taken into consideration. The vectors are optionally associated with the keys without relation to their starting position on the touch screen.

An aspect of some embodiments of the present invention relates to a selection means and its corresponding marker that permits navigating within the letters of the/a (e.g. current) word to select one of its letters and wherein the system relates the next input information provided by the user to said character position.

An aspect of some embodiments of the present invention relates to capitalizing a letter in a character position during the entry of a word, by providing a predefined interaction preferably other than a short taping action a predefined key preferably of the first keypad and providing a pressing action on the desired ambiguous letter key of the first keypad, causing to enter a corresponding letter in said character position in upper case.

An aspect of some embodiments of the present invention relates to creating systems and methods so that the system automatically relates a gliding action or a tapping action to either data entry system of the invention or to a computer mouse function. For example, a gliding/taping action provided during the entry of word may be related to providing input information corresponding to said word, and a gliding/taping action which is not provided during the entry of word may be related to a corresponding mouse function.

An aspect of some embodiments of the present invention relates to grouping symbols such as at least the special characters, functions, commands, etc., in few groups each group based on one or more predefined common characteristics. Each of said group of symbols being assigned a predefined interaction other than a simple taping action with/on preferably the keys other than the keys of the second keypad, preferably to the keys of the first keypad. Said predefined interaction preferably being a long pressing (e.g. and holding) action for at least a predefined of time on the corresponding key. When such predefined action is provided on a corresponding key, the system enters into a corresponding mode instance and predefinely relates each of the characters of the corresponding group to one of the keys of at least the second keypad. Optionally, providing a pressing action simultaneously or immediately after on a key of the second keypad may enter the symbol on said key.

An aspect of some embodiments of the present invention relates to displaying all of the letters relating to each of the ambiguous character positions. Optionally, the letters for each character position are shown in “letter column”. Optionally, the letter columns are displayed when a “BackSpace” key is pressed and are removed when a letter key of the first keypad is pressed.

An aspect of some embodiments of the present invention relates to a first keypad of the invention including ambiguously both the alphanumeric characters of a language and any special character to support entering words including any type of character (e.g. formulas, URLs, computer programming languages, slings, etc.). Optionally, the system may include at least two different second keypads for the correction procedure in case the system does not predict the desired word based on the key presses provided through the first keypad alone.

An aspect of some embodiments of the present invention relates to a data entry unit which receives, for at least some character positions within a word or a chain of characters, user input signals ambiguously associated with a plurality of letters and displays for those character positions a single letter selected in an attempt to guess the letter intended by the user. The data entry unit displays letters representing character positions associated with a plurality of letters in a manner different than it displays letters representing character positions associated with a single letter.

In some embodiments of the invention, the letters of single letter character positions are displayed in a different font, color or size than letters of multi-letter character positions. Alternatively or additionally, letters representing multi-letter character positions are displayed with a marking on, above, or below, the letter. In some embodiments of the invention, the marking includes the other letters with which the character position is associated, preferably in a larger font than the letter of the character position anywhere on the screen.

An aspect of some embodiments of the invention relates to a method of data input in which user swiping gestures result in different functions responsive to the width of the gesture. Optionally, a data entry unit differentiates between swiping gestures provided by a stylus and gestures provided by a finger, or between gestures provided by different fingers.

An aspect of some embodiments of the present invention relates to a data entry unit of an electronic device including a touch sensitive surface (e.g. pad, screen), which relates differently to similar movements on different zones of the screen. Optionally, the unit may also include few hard keys associated with at least the letters to enter the main portion of the text through said hard keys rather through the touch sensitive surface.

Optionally, the screen is divided to at most six zones.

An aspect of some embodiments of the present invention relates to a reduced-size data entry unit used mainly as a keyboard for an electronic device mainly a computing device. The unit may include the first and the second sets of keys as described. Optionally, the unit may include at least one touch sensitive surface (e.g. pad, screen) to replace the second set of keys through different gliding actions. Optionally, the touch sensitive surface may also be used to duplicate the use of the first set of keys, therefore replacing also said first set of keys. The unit may include its own processor which may be a low powered processor used mainly with the data entry system. The unit may also include its own memory which may be of reduced size used mainly with the data entry system. The Unit may also include its own display unit mainly used to print the text for user review. Optionally, the unit communicates with the corresponding electronic device through wires or wirelessly.

An aspect of some embodiments of the present invention relates to a detachable keypad which includes keys corresponding to all the letters of the alphabet, which is operable when detached such that the letters may be split between at least two detachable units. Optionally, the keypad communicates with the corresponding electronic device through wires or wirelessly.

An aspect of some embodiments of the invention relates to a data entry system which during the entry of a word the system displays soft keys for the letters/characters associated with the first character position of the word associated ambiguously with a plurality of characters. Optionally after the user selects one of said characters, the system displays soft keys for the next character position of the word associated ambiguously with a plurality of characters.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a mobile phone, in accordance with an exemplary embodiment of the invention;

FIGS. 2-3 are schematic illustrations of different mode keys on the first keypad, in accordance with some exemplary embodiments of the invention;

FIGS. 3a-3f are schematic illustrations of different groups of symbols on the second keypad, in accordance with an exemplary embodiment of the invention;

FIG. 4 is a schematic illustration of a second keypad displayed on the screen of a device, in accordance with an exemplary embodiment of the invention;

FIG. 5 is a schematic illustration of a small second keypad displayed being enlarged on the screen of a device, in accordance with an exemplary embodiment of the invention;

FIG. 6 is a schematic illustration two second keypads of the invention one including the digits and the other including numeric symbols, in accordance with an exemplary embodiment of the invention;

FIG. 7 is a schematic illustration of unambiguous on-screen keys corresponding to an ambiguous key, in accordance with an exemplary embodiment of the invention;

FIG. 8 is a schematic illustration of arrangement of the keys of the second keypad, in accordance with an exemplary embodiment of the invention;

FIG. 9 is a schematic illustration of location of the second keypad relative to the location of the word being entered, in accordance with an exemplary embodiment of the invention;

FIGS. 10-11 are the schematic illustrations of letter columns each column viewing the choice of characters for each character position in a word, in accordance with some exemplary embodiments of the invention;

FIGS. 12a-12b are schematic illustrations of the letters in on the keys of a preferred second keypad in form of a telephone-type keypad, in accordance with an exemplary embodiment of the invention;

FIGS. 12c-12d are schematic illustrations of the letters in on the keys of a preferred second keypad in form of a telephone-type keypad, and some of the corresponding gliding actions in accordance with an exemplary embodiment of the invention;

FIGS. 13a-13c are schematic illustrations the gliding actions on a touch sensitive surface duplicating interactions with preferably a keypad which is a virtual keypad which optionally is not shown on the screen during the gliding actions, in accordance with an exemplary embodiment of the invention;

FIG. 14a is a schematic illustration of the a split keypad in form of two sensitive pad used as the first keypad and at least as one of the second keypads of the invention, in accordance with an exemplary embodiment of the invention;

FIGS. 15a-15c, are schematic illustrations of the virtual split first keypad in predefined position on the sides of a touch-sensitive surface, in accordance with an exemplary embodiment of the invention;

FIGS. 15d-15g, are schematic illustrations of the virtual split and none-split first keypad dynamically positioned on a touch-sensitive surface, in accordance with an exemplary embodiment of the invention;

FIGS. 16a-16b, are schematic illustrations of finger caps duplicating interactions with the keypads, in accordance with an exemplary embodiment of the invention;

FIG. 17, is a schematic illustration of a remote data entry unit duplicating interactions with the keypads, in accordance with an exemplary embodiment of the invention;

FIG. 17a, is a schematic illustration of an electronic stylus duplicating interactions with the keypads, in accordance with an exemplary embodiment of the invention;

FIG. 18, is a schematic illustration of the second keypad in a different form factor, relative to a pressed key of the first keypad, in accordance with an exemplary embodiment of the invention;

FIGS. 19-20, are a schematic illustration of a second keypad model being a telephone-type and gliding/taping actions corresponding to its keys, relative to a pressed key of the first keypad, in accordance with an exemplary embodiment of the invention;

FIG. 21 is a schematic illustration of the second keypad during a corresponding mode instance, and gliding/taping actions corresponding to its keys, relative to a pressed key of the first keypad, in accordance with an exemplary embodiment of the invention;

FIGS. 21a-21f, are schematic illustrations of the first and second keypads during different mode instances relative to different pressed keys of the first keypad, and the symbols on the keys of the second keypad and on the keys of the first keypad relative to the corresponding monde instance, in accordance with an exemplary embodiment of the invention;

FIGS. 22a-22e, are schematic illustrations of the use of fingers and some portions of the user's fingers used to duplicate interactions with the keys of the first and second keypads, in accordance with an exemplary embodiment of the invention;

FIG. 23, is a schematic illustration of a gliding action other than a single straight gliding action corresponding to interacting with one key of the second keypad, in accordance with an exemplary embodiment of the invention;

FIG. 24, is a schematic illustration of a gliding action other than a single straight gliding action corresponding to interacting with multiple keys of the second keypad, in accordance with an exemplary embodiment of the invention;

FIG. 25, is a schematic illustration of data entry system of the invention installed integrated within a car, in accordance with an exemplary embodiment of the invention;

FIG. 26, is a schematic illustration of data entry system of the invention wherein the functions of the first and second keypads are inversed, in accordance with an exemplary embodiment of the invention;

FIG. 27a, is a schematic illustration of a using each side of a touch sensitive surface for interacting with some of the keys of the a keypad, in accordance with an exemplary embodiment of the invention;

FIGS. 27b, and 28a-28b, are schematic illustrations of different sides/zones of a touch sensitive surface for interacting with the keys of (different) second keypad relative to a different group of symbols, in accordance with an exemplary embodiment of the invention;

FIGS. 29-29a, are schematic illustrations of a first and multiple second keypads wherein (at least some of) their keys include ambiguous characters including letters and many special characters, in accordance with an exemplary embodiment of the invention;

FIGS. 30a-30d, are schematic illustrations of moving an in-word character selection means through a gliding action, in accordance with an exemplary embodiment of the invention;

FIGS. 31-31a, are schematic illustrations of gliding actions over several keys of the first keypad duplicating interaction with said several keys, in accordance with an exemplary embodiment of the invention;

FIGS. 32-32a, and 33-33a, are schematic illustrations of gliding actions provided anywhere on a touch sensitive surface duplicating gliding actions over one or several corresponding keys of a keypad model of the invention, in accordance with an exemplary embodiment of the invention;

FIGS. 34-34a are schematic illustrations of a gliding action provided on each side of a touch sensitive surface to define the location of a portion of split first keypad of the invention on the corresponding side, in accordance with an exemplary embodiment of the invention; and

FIGS. 35a-c, are schematic illustrations of a mouse security means, in accordance with an exemplary embodiment of the invention;

### DETAILED DESCRIPTION OF EMBODIMENTS

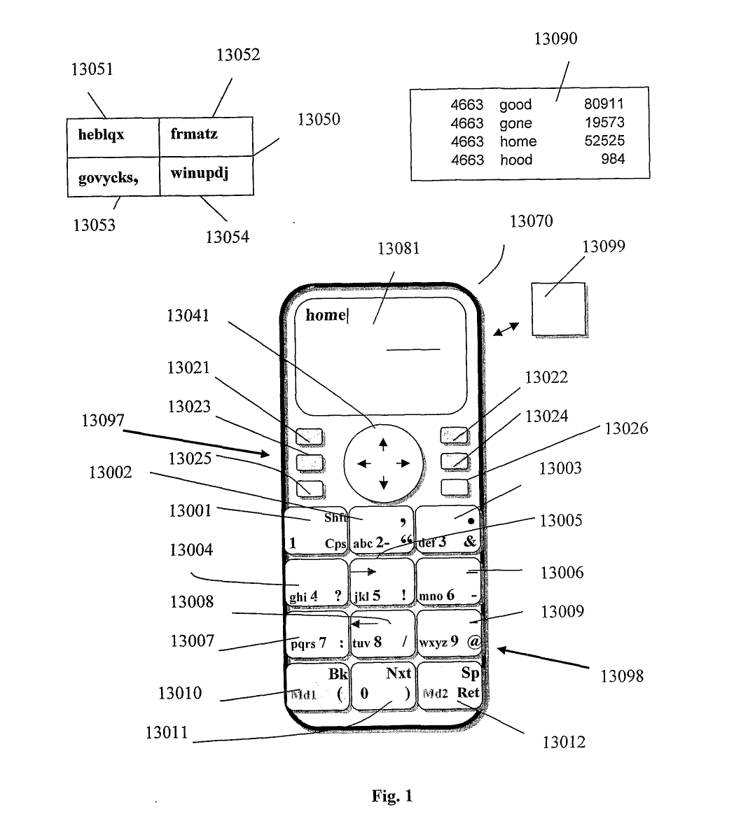

FIG. 1 is a schematic illustration of a mobile phone 13070, in accordance with an exemplary embodiment of the invention. Mobile phone 13070 comprises a plurality of input keys and an output screen 13081. Each input key may be used by a user to provide one or more input signals, which represent letters, numbers, other symbols and/or control functions. In order to simplify the data entry task while limiting the number of keys, at least some of the input signals are ambiguously associated with a plurality of characters. A processor 13099 receives indications of the input signals actuated by the user and selects one character for each received input signal, optionally using an internal word dictionary which lists words with respective ratings of frequency of use. An exemplary portion 13090 of the dictionary is also shown.

In some embodiments of the invention, the keys of mobile phone 13070 are included in two main groups, a first group 13097 and a second group 13098, which each group has keys associated with all the letters of the alphabet. The letters are optionally distributed between the keys in each group, such that each pair of a key from the first group 13097 and a key from the second group 13098 has at most only a single letter in common. Thus, by pressing a first group key and a second group key for a specific character location, the user indicates a specific letter unambiguously. While generally processor 13099 guesses the words intended by the user based on the first keys only, when this does not occur the user can easily use the second keys to indicate the precise letters desired. In other embodiments, one or more pair of first and second keys may have more than one letter in common, in order to reduce the number of keys required. Optionally, the letters in common are ones which are generally not interchangeable in words (e.g., Q and V), such that processor 13099 will nearly always guess which letter is intended, using dictionary. In these embodiments, a mode key may be used to enter a mode in which specific letters can be entered unambiguously.

In an exemplary embodiment of the invention, first group 13097 including keys 13021 to 13026 wherein in this example four of said keys 13021 to 13024 are ambiguous letter keys to which all the letters of the Latin alphabet are assigned. For example, in one embodiment, key 13021 is assigned the letters HEBLXQ 13051, key 13022 is assigned the letters FARMZT 13052, key 13023 is assigned the letters GOVSYCK 13053, and key 13024 is assigned the letters JUINWDP 13054. Other letter arrangements may be used on the four keys 13021-13024 and/or the letters may be arranged on a different number of first group keys. Optionally, the letters are arranged in a manner which minimizes the chances of a sequence of key strokes corresponding to preferably no more than one frequently used word, for example by placing each of the vowels A, E, I and O on a different key. Keys 13026 and 13025 are optionally used for entering a space and a backspace, respectively.

In some embodiments of the invention, second group 13098 includes twelve keys 13001 to 13012 arranged in the standard numeric keypad arrangement used in many mobile telephones, with three columns of four rows. Optionally, the digits are assigned to keys 13001-13010, and the letters of the Latin alphabet are assigned to eight keys, keys 13002-13009.

In a text entering mode, a current character position is defined on display 13081. Optionally, in entering a word, the user presses a sequence of first group keys 13021-13024. When the user presses a first group key 13021-13024 for the first position of the word, the current cursor (e.g. caret) location is associated with all the letters associated with the pressed key. One of the associated letters is displayed in the cursor location on display 13081, for example a letter which in itself is a word or a letter which is most commonly used. The cursor location is then moved to an adjacent position. When the user presses another first group key, the now current cursor location is associated with all the letters associated with the pressed key and one of the letters is displayed in the character position on display 13081. The letter displayed for the current location is optionally selected based on all the keys pressed for the current word and not only the key pressed for the current character location. In addition, the letters displayed for the other character locations of the current word are optionally updated according to all the keys pressed for the current word.

After completing entering a word with the first group keys, processor 13099 generally guesses the word intended by the user. In those cases in which the word was not guessed correctly, the user can enter additional information using the second group keys. In some embodiments of the invention, when the character is positioned at the end of a word, a press on a second group key refers to the first character position of the word associated with a plurality of letters (referred to herein as not disambiguated). Following the pressing of the second group key, the character position is associated only with the letter in common to the letters of the first group key and the second group key pressed for the character position. This letter is displayed on display 13081 for the character position. Optionally, the letters displayed for the entire word are updated accordingly, based on the corresponding contents of word dictionary 13090. The user may then press additional second group keys for subsequent character positions of the word, when processor 13099 was still not able to guess the intended word. This process may be repeated, if necessary, until the entire word is entered again, this time using the second group keys.

In other embodiments of the invention, when a second group key is pressed it refers to any predefined character position such as the last character position of the word that was not disambiguated, rather than to the first letter of the word. It is noted that in some embodiments, the user may press second group keys before entering an entire word, for example when the user knows in advance that the word will not be guessed correctly by processor 13099. It is noted that the processor 13099 is configured to apply a second input signal provided by a second group key to a different position within the current word than a first input signal provided by a first group key, from a same character location.

As mentioned before in the patent applications filed by this inventor, to each key of the first or the second set of keys (e.g. the first or the second keypad), different symbols such as letters, numbers, special characters such as punctuation marks, commands, functions, etc., may be assigned and entered through different methods of data entry of the invention. For example, in addition to providing the initial symbol, each of at least some of the keys of the first keypad of the invention may be used as a predefined (preferably, different) mode key to permit entering additional symbols when said key is pressed (eventually, for at least a predefined lapse of time) in conjunction with pressing (at least) another key of (e.g. preferably) the second keypad or the first keypad.

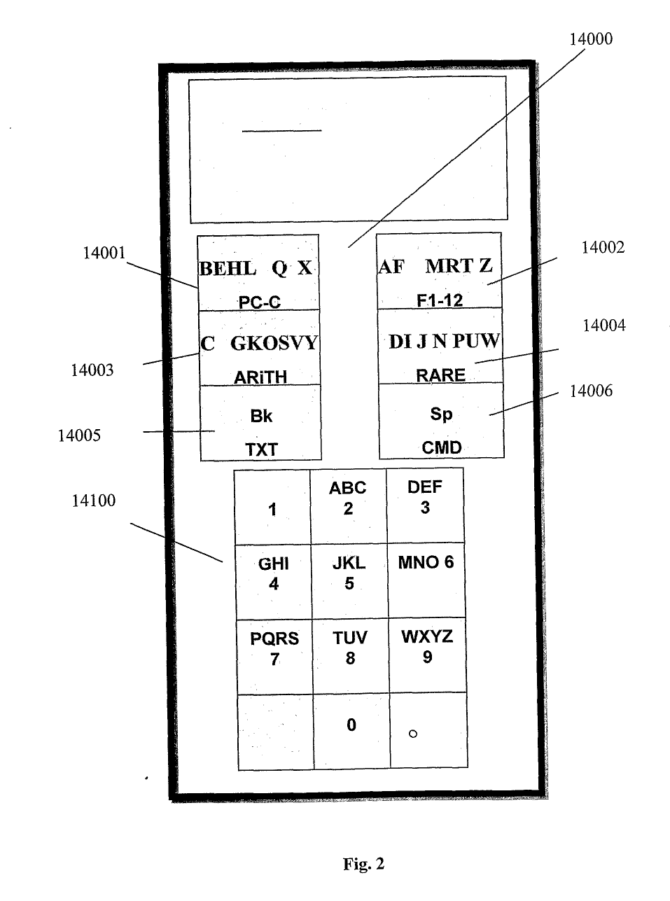

FIG. 2 shows as an example, a device having a first keypad 14000 of the invention having six keys wherein to four of said keys 14001-14004 the letters of the English language are distributively assigned in a manner that has been previously described in detail in the (e.g. current) patent application filed by this inventor. In this example, a single/simple pressing on the key 14006 provides a space character, while a single/simple pressing on the key 14005 duplicates the BackSpace command of a PC (QWERTY) keyboard. The device also includes a second keypad 14100 of the invention.

According to one embodiment of the invention, each of at least some of said keys (e.g. in this example, 14001-14006) may also be used as a (e.g. in this example, different) “mode” (e.g. modifier) key (e.g. if for example, said key is interacted differently). As an example, by providing a predefined (e.g. different) interaction (e.g. such as press-and-holding, double-pressing, pressing a key for a predefined longer time, etc.) on one of said keys and pressing another key such as any of the keys of the second or the first keypad, generally (e.g. preferably) a different symbols may be entered (e.g. simple/single pressing said key combined with pressing another key may also be considered as entering to a corresponding mode).

With continuous description of the above embodiment, each mode (e.g. modifier key situation, hereafter sometimes referred to as “mode” key) may be combined with a number of different keys and provide a number of (e.g. different) symbols (e.g. special symbols).

The symbols used with the data entry system of the invention through a mode key may be grouped in different categories. For example, if the system uses at least the symbols available on a QWERTY keyboard, said symbols may be divided into different groups based on their characteristic wherein each symbol of one of said group of symbols being assigned to a different key of preferably the second keypad and/or to a different key of the (other) keys (e.g. preferably, other than the corresponding modifier key) of the first keypad. Obviously, a symbol may be belong and being assigned to more than one group. Any of said symbols of said group of keys may be entered by pressing the corresponding modifier key (e.g. for entering into the corresponding mode instance) and pressing the key to which said symbol is as signed.

In the above mentioned example, each of up to six groups of symbols may be assigned to a single long pressing action on a different key of the keys of the first keypad, wherein each of the symbols of any of said groups of symbols may be entered by pressing the corresponding modifier key and pressing the key corresponding to said symbol. This may permit to enter at least substantially all of the symbols of a PC keyboard with a simple pressing action. In addition, the user may easily select the mode corresponding to his desired symbol because he/she may easily know to which group it may belong. The appellation of the category of the group may be written on the corresponding (“mode”) key. As an example, the mode instances/groups corresponding to each of the keys 14001-14006 are written on each of said keys.

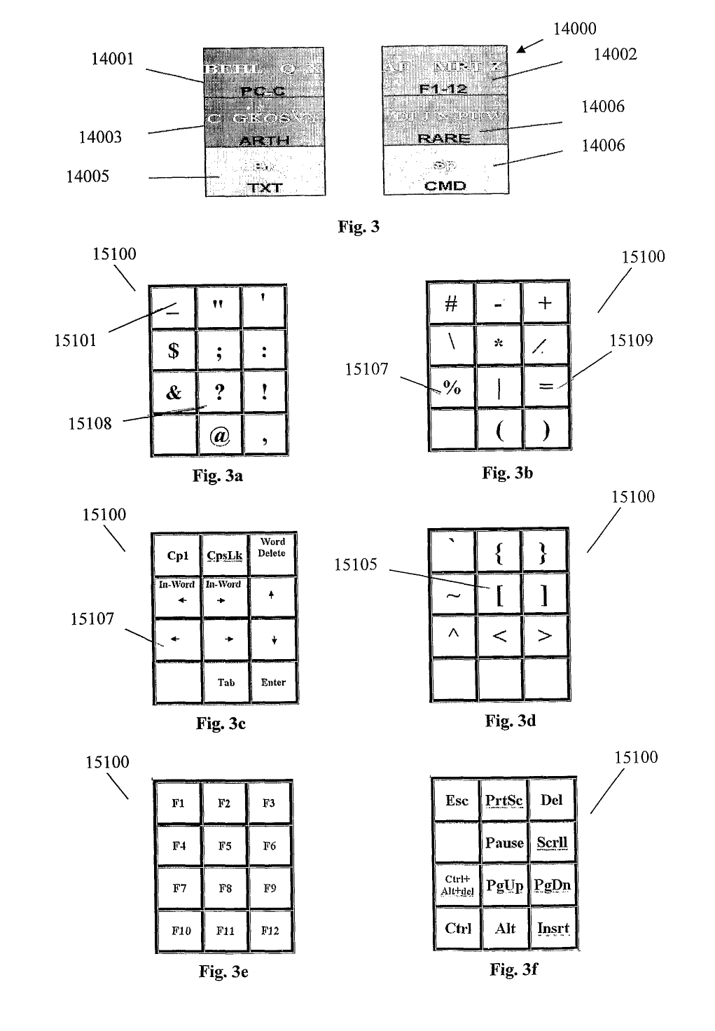

FIG. 3 shows again the first keypad 14000 of FIG. 2, to describe as an example the “mode” keys of the invention in detail. Here, the symbols of each group used with the data entry system of the invention are assigned to six keys 14001-14006. In this example, the symbols include at least substantially all of the symbols of a QWERTY keyboard other than letters and numbers. They also includes some other/additional customized symbols (e.g. In-Word navigation that permits the user to select any of the characters of a word in order to eventually replacing it by another character in said character position within the word, and wherein by considering said replaced character and the rest of input information corresponding to the word provided by the user until then, the system may predict/propose another word). The symbols are categorized in six different categories and assigned to six keys (e.g. when they are used as mode keys) of the first keypad as follow: “TEXT” (e.g. mostly punctuation mark characters) assigned to key 14005, “ARITH” (e.g. mostly arithmetic characters) assigned to key 14003, “CMND” (e.g. mostly related to commands of the PC keyboard) assigned to key 14006, “RARE” (e.g. mostly characters used less often) assigned to key 14004, “F1-F12” assigned to key 14002, and “PC-C” (e.g. mostly PC and/or customized functions) assigned to key 14001.

Each of the FIGS. 3a-3f show the symbols of the group of keys corresponding to its modifier key (e.g. mode instance), wherein said symbols are generally assigned to the keys of the second keypad as shown.

For easy usability purpose, according to one method, a predefined interaction such as a press-and-holding action on a key (e.g. of the first keypad) for at least a predefined lapse of time, may inform the system that said pressing action corresponds to the corresponding mode action assigned to said key. In addition, when the user presses and holds said key, the system may show on the screen the corresponding set of keys (e.g. the second keypad) to which the symbols of the corresponding mode/group are assigned.

FIG. 3a, shows as an example, the symbols that are assigned to the modifier key 14005 (e.g. “Text” symbols). This category generally relates to symbols when writing a text. Any of the symbols shown on (assigned-to) the key of the for example the second keypad 15100 may be entered by pressing (e.g. and eventually, holding) the key (predefined modifier key of for example the first keypad) 14005 and pressing the key corresponding to the desired symbol. For example, in order to enter the symbol “?”, the user may press (e.g. and hold) the key 14005 and press the key 15108. Also for example, in order to enter the symbol “_”, the user may press (e.g. and hold) the key 14005 and press the key 15101.

Accordingly, FIG. 3b, shows as an example, the symbols that are assigned to the modifier key 14003. This category generally relates to “Arithmetic” symbols. Any of the symbols shown on (assigned-to) the key of the for example the second keypad 15100 may be entered by pressing (e.g. eventually, holding) another predefined modifier key for example the key 14003 of for example the first keypad 14000 and pressing the key corresponding to the desired symbol. For example, in order to enter the symbol “%”, the user may press (e.g. and hold) the key 14003 and press the key 15107. Also for example, in order to enter the symbol “=”, the user may press (e.g. and hold) the key 14003 and press the key 15109.

Accordingly, FIG. 3c, shows as an example, the symbols that are assigned to the modifier key 14006, in this example, the “Command” symbols. Any of the symbols shown on (assigned-to) the key of the for example the second keypad 15100 may be entered by pressing (e.g. eventually, holding) the key (another predefined modifier key of for example the first keypad) 14006 and pressing the key corresponding to the desired symbol. For example, in order to enter the symbol “←” (e.g. Left Arrow navigation as on PC keyboard), the user may press (e.g. and hold) the key 14006 and press the key 15107.

Accordingly, FIG. 3d, shows as an example, the group of symbols that are rarely used (“Rare” symbols) assigned to the modifier key 14004. Any of the symbols shown on (assigned-to) the key of the for example the second keypad 15100 may be entered by pressing (e.g. eventually, holding) the key (another predefined modifier key of for example the first keypad) 14004 and pressing the key corresponding to the desired symbol. For example, in order to enter the symbol “[”, the user may press (e.g. and hold) the key 14004 and press the key 15105.

Accordingly, FIG. 3e, shows as an example, the symbols of another group (e.g. F1-F12 of the PC keyboard) that are assigned to the modifier key 14002, and FIG. 3f, shows as an example, the symbols of another group that are assigned to the modifier key 14001 (e.g. some of the PC functions and customized functions).

It must be noted that pressing and holding the key of the second keypad repeats the function of said key.

It is understood that for easiness of use, after the user presses a (modifier) key and the system enters to the corresponding mode, the corresponding symbols and/on the corresponding keys of said mode may be appeared on the screen. Said corresponding keys may be disappeared when the uses releases the “mode” key. This feature may be enabled, or being disabled (e.g. once the user gets used to the system (e.g. can blind type)). According to one method, after the corresponding keys of a group are appeared on the screen if the user releases the mode key without pressing any of the keys of the group the system does nothing.

It must be noted that although the first keypad of the invention is mostly shown and described as being a physical (e.g. hard) keypad, obviously it may also be a virtual for example on on-screen keypad. It must be noted that, for example, the first keypad may include more mode keys. Also it must be noted that in the embodiment just described above the digits 0 to 9 may be considered as a different group and being assigned to a “Number” mode key (e.g. replacing on of said groups or by adding more keys to the first keypad, etc.)

Obviously, a predefined pressing action such as a short single pressing action on a key may correspond to its initial function/symbol such as entering a letter, and another pressing action such as press-and-holding action (e.g. or a double-pressing action, etc.) may correspond to entering to the corresponding predefined mode). For example, based on the principles of the data entry system of the invention as described in detail previously, pressing (e.g. without holding) the keys 14002, 14001, 14004, 14003, may correspond to entering the ambiguous letters of a word (e.g. in this example, the system may provide the corresponding word with highest priority, which is the word “this”), wherein press-and-holding the key 14002 may correspond to pressing said key as a modifier key to enter to its corresponding “mode” as described and shown in FIG. 3e.

According to one method, if the user press-and-holds a key (e.g. enters to its predefined mode) and then releases it (gets out of said mode) without pressing another key, then the system does nothing (e.g. it may only show the corresponding symbols (on their corresponding keys) when the user presses-and-holds said key).

Obviously, at least some of the symbols of a group of symbols assigned to a mode key interaction of a keypad may also be assigned to (e.g. other) keys of the same keypad. For example, press (e.g. and-holding) the key 14005 and (then) (e.g. combined with) pressing the key 14006 may correspond to providing the “Enter” function of a PC keyboard. Also for example, press (and-holding) the key 14006 and (then) (e.g. combine with) pressing the key 14005 may correspond to erasing the whole word before the cursor/caret.

In order to permit to a novice user to be able to enter text immediately easily and with reasonable speed, the (ambiguous) letters assigned to the (e.g. four) keys of the first keypad may be shown (on the keys themselves or on another location such as on the screen or on the body of the corresponding device) arranged in a manner such that the user may find them easily. For example, letters on the device of FIG. 2 are arranged such that they are arranged from left to right in their English order on each key accordingly. In addition they are arranged in eight imaginary/virtual columns each containing at most one of the letters of the alphabet that is located on the corresponding key (e.g. 2-9) of a standard telephone keypad.

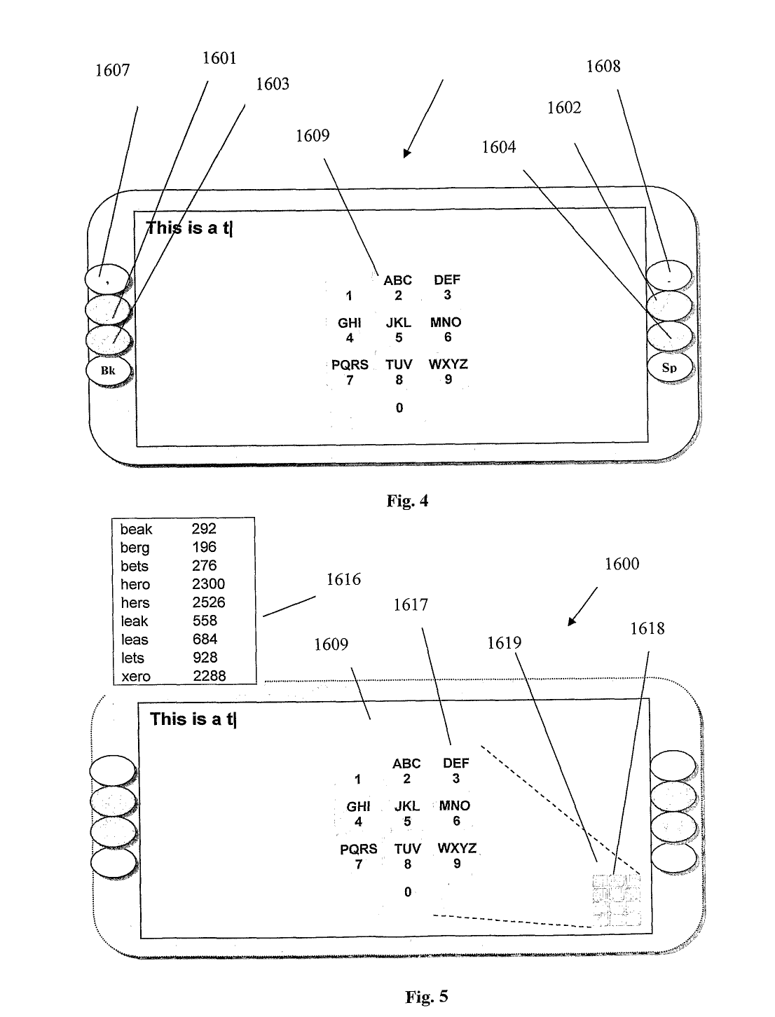

As mentioned before, any of the keypads of the system may be an on-screen keypad. According to one embodiment of the invention, the second (e.g. the telephone-type) keypad of the system may be presented on the screen. This may permit to include only few hard keys on a device also permitting to have a wide screen such as shown in FIG. 4.

Different methods may be considered to show the second keypad on the screen.

According to one method, the second keypad may appear on the screen when the user for example presses a predefined key. FIG. 4 shows as an example, a device 1600 including the first keypad of the invention having eight hard keys 1601-1608 which are split in two groups of (four) keys installed on opposite sides of the device. In this example, four keys 1601-1604 of the first keypad duplicate the letter keys 14001-14004 of FIG. 2. As an example, a predefined pressing action on the key 1607 may cause the system to present the second keypad 1609 of the system on the screen. Also as an example, another pressing action on the same key 1607 may cause to hide/remove said keypad from the screen. Obviously, the four hard keys of each side may be arranged differently relating to each other. For example, they can be arranged in a manner to duplicate the arrangement of the keys of a game consol/device.

According to another method, the second keypad may permanently being shown on the screen.

Preferably according to one example, the second keypad may be shown in a small form factor on the screen, and when the user provides a tapping action on said small keypad then it becomes large so that the user may more easily interact with it. The tapping action on the small keypad may be a tapping action on a key of the small keypad that corresponds to a desired symbol. Because in many cases such as for example the correction procedure of the invention, one tapping action on the a key of the second keypad is mostly enough to obtain the desired word, therefore in many cases tapping action(s) on the enlarged keypad may not be necessary. FIG. 5 shows as an example, the device 1600 having a small (permanent) on-screen second keypad 1619. As an example, by considering the portion 1616 of the words database of the system and that four keys of the first keypad (e.g. two darker keys of the hard keys installed on each side of the device 1600) duplicating the letter keys 14001-14004 of FIG. 2, when the user presses the (four) letter keys of the first keypad corresponding to his desired word “bets”, the system (e.g. based on the priority) may propose the word “hers”. The user then may tap on the key 1618 (corresponding to the letter “b”) of the small permanent keypad 1619. The system may propose the world “beak” corresponding to the input information provided by the user until then (e.g. the methods of the data entry and correction of the system have already been described in detail). In addition, the system may also enlarge the small keypad to provide an enlarged keypad 1609. The user then may tap on the key 1617 of the enlarged keypad corresponding to the letter “e”. The system may propose the word “bets” corresponding to the key pressing actions on the keys of the first keypad and key pressing actions on the keys 1618 and 1617 of the second keypad.

Obviously, preferably, automatically at the end of the word or by providing a predefined interaction the system may hide the enlarged keypad and show the small keypad again.

According to another embodiment of the invention, additional groups of symbols may be considered and assigned to additional “mode” keys (e.g. grouping the symbols according to different categories and assigning them to different keys of the first (and/or the second) keypad has already been described in detail). As an example, as shown in FIG. 4, the first keypad of the invention may have two additional keys 1607, 1608, respectively (e.g. previously, six groups of symbols being assigned to six keys of the first keypad have been demonstrated as example). As an example, press-and-holding action on the key 1607 may correspond to a group of symbols consisting of the letters of the alphabet and being shown on the second virtual keypad on the screen, and a press-and-holding action on the key 1608 may correspond to a group of symbols consisting of the digits 0-9 and being shown on the second keypad on the screen. The method of entry of a symbol of a group has already been described in detail.

In order to ease the user's interaction, according to one method, when the user presses (e.g. and holds) a key corresponding to a group of symbols, the corresponding on-screen second keypad may be shown to the user on the opposite side of the screen.

The data entry systems of the invention using few keys and a speech recognition system have already been described in detail in different patent applications field by this inventor. Obviously, using speech and speech recognition system can be used by the system in addition-to or by replacing the use of the second keypad. Combining the data entry system of the invention having two keypads and using the methods of the data entry system of the invention using speech may be beneficial in different situations. For example, by having both methods available (e.g. within one system), the user may use the speech version in a first environment and the non-speech version in another environment (e.g. very noisy environment, in a meeting, etc.). Optionally, the user may use the speech version for correcting an undesired predicted long chain of characters that not a word available in the database of system.

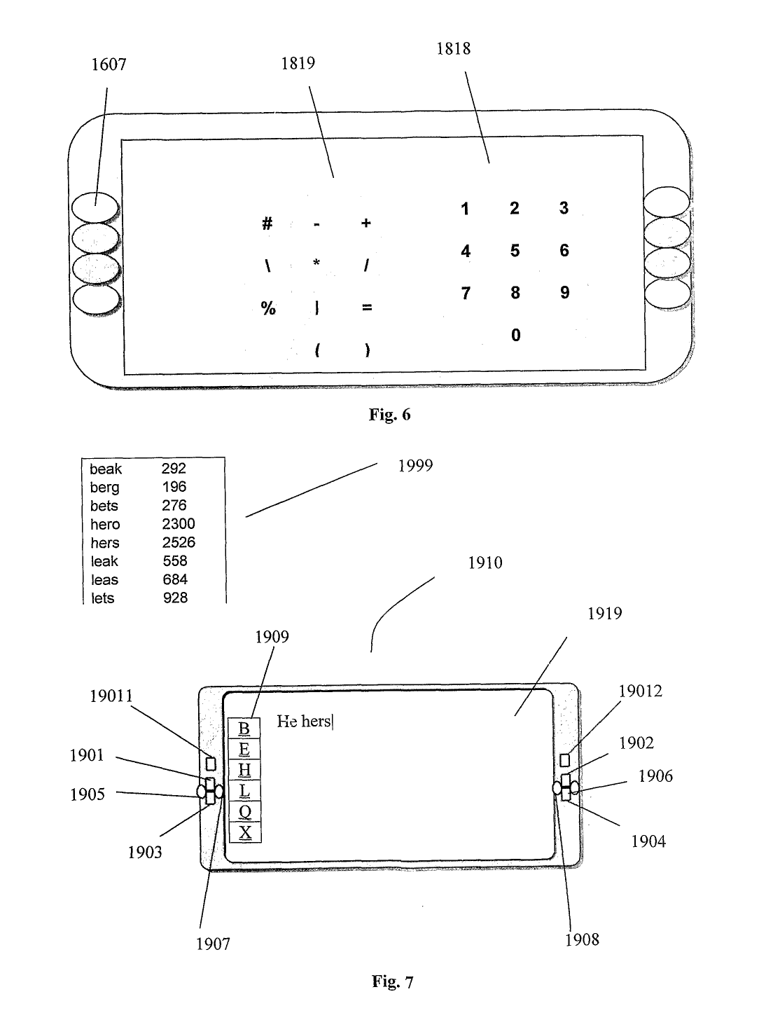

It may happen that a group of symbols has many characters and that the keys of the second keypad may not be sufficient to support them. As a solution to this problem, the system may show said symbols on more than one second-type keypad on the screen. A pressing action on any of keys of said more than one second-type-keypads may correspond to the character of that group that said key represents (e.g. shown on that key on the screen). FIG. 6 shows as an example, two second-type-keypads 1818, and 1819, wherein each supporting some of characters of a predefined group here called as “enlarged arithmetic group” that for example may at least include digits and arithmetic characters. Said group may be assigned to a predefined pressing action on a key 1607 of the first keypad. When such pressing action is provided, the system may show more than one second-type-keypads 1818, and 1819. In this example, a first second-type-keypad 1818 shows the digits and a second second-type-keypad 1819 shows other arithmetic characters. A pressing action on a key of the first second-type-keypad may correspond to the arithmetic symbol shown on said key, and a pressing action on a key of the second second-type-keypad may correspond to the arithmetic character shown on said key. The advantage of this method is that for example, in order to enter arithmetic formulas the user uses less “mode” changing actions.

It must be noted that although the “mode” situations are described and shown as being assigned to a predefined interaction with the keys of the first keypad, obviously, they can be assigned to interacting with any keypad of the system. For example, a press-and-holding action on the “0” key of the second keypad may correspond to one of the predefined groups of symbols of the system.

It must also be noted that obviously, both, the first and the second keypads may be on-screen keypads.

As described in different patent applications field by this inventor, obviously, in addition-to or in replacement of the second keypad, the system may use a full (QWERTY) keyboard. In addition to its habitual functions, such full keyboard may be used with the correction procedures of the invention (e.g. to enter precise characters of an ambiguous word). The special characters and function may be entered through the full keyboard and/or through the “mode” procedures of the data entry system of the invention such as the system using the second keypad or and/or speech as described in detail. According to one method, such full keyboard may be used to enter a word (e.g. which for example does not exist in the word database) directly (e.g. without using the first keypad).

Different methods of entering precise characters have been described in different patent applications filed by this inventor. According to one of said methods, the system may be designed such that when the user presses a first ambiguous key corresponding to a desired character (e.g. letter), the system may provide a number of (soft) keys (e.g. zones on the screen of the device) such that to each of said (soft) keys one of the (“ambiguous”) characters of the ambiguous key is assigned. The user then may press the corresponding (soft) key to enter the precise (unambiguous) character.

FIG. 7 shows as an example, an electronic device 1910 having the data entry system of the invention that uses a first keypad having few (e.g. hard) keys 1901-1908. As an example, by considering the portion 1999 of the words database of the system and that four (ambiguous) keys 1901-1904 of the keypad (e.g. two of the hard keys on each side of the device 1910) duplicating the letter keys 14001-14004 of FIG. 2, in this example, in order to enter unambiguously the letter “d” the user may press the key 1904. The system then may show at least seven on-screen keys each representing/corresponding to one of the letters/characters represented by/assigned to the (to said pressing action on the) key 1904 (e.g. there may be more on-screen keys to represent additional characters, if any, represented by the key 1904). The user then may press the on-screen key corresponding to the letter “d”.

Obviously, the system of entering precise letter(s) through this embodiment may be used during the entry of the words through the predictive data entry system of the invention.

The above-mentioned (on-screen) mapping method may also be used in correction procedure of the invention. For example, after the user provides the initial/first input information (e.g. by using the (four) ambiguous keys 1901-1904 for entering a word, if the proposed word by the system is not the desired word, then according to one method, the user may press a predefined key such as a correction key. The system then may map on several (dynamic) on-screen keys, the characters that correspond to the provided first (preferably, ambiguous) key press corresponding to the first character position of the desired word (e.g. preferably, one character per one on-screen key). Then the user may press the on-screen key that represents/shows the first character of the desired word (e.g. addition/second input information). Based on said additional information combined with the first input information the system may propose another word.

According to one method, (e.g. immediately) after that action, the system may (automatically) map on several (dynamic) on-screen keys, the characters that correspond/are-assigned to the next (e.g. second) provided (ambiguous) key pressing action of the first input information that preferably correspond to the next (ambiguous) character position of the desired word. Then the user if desires, he may press the desired on-screen key to inform the system about the second precise character/letter of the desired word, and so on.

Obviously, according to one method, instead of pressing a predefined key to map the letters of the key (pressing action) corresponding to the first (ambiguous) character position of the word, the system may automatically provide said mapping action after the user provides the (ambiguous) pressing action corresponding to the first (ambiguous) character of the word during providing the first input information.

As an example, by considering FIG. 7, in order to enter the word “lets”, the user may press the ambiguous keys 1901, 1901, 1902, 1903, corresponding to the characters of said word (e.g. first input information). The system may provide the word “hers” (e.g. having highest frequency of use). According to this method, during the entry of the word the system may provide the on-screen keys 1909 (e.g. the six on-screen keys 1909 each having one of the ambiguous characters “bqelxh” of the key 1901) corresponding to the first pressing action provided corresponding to the first character position of the word during providing the first input information. After the system proposes the undesired word “hers”, the user may press the on-screen key corresponding to the letter “l” which is the first letter of the desired word “lets”. The system may propose the word “lets”. According to one method, at this time the system may show to the user the on-screen keys corresponding to the next (e.g. second) key pressing action of the first input information (e.g. on-screen keys corresponding to the pressing action on the key 1901). At this time:
as a first example, if the user presses a space character, then the on-screen keys may disappear and the word “lets” is entered.
as a second example, if the user presses the on-screen key corresponding to the letter “e”, then the system proposes the word “leak” of the database. At this time the system may show to the user the on-screen keys corresponding to the next (e.g. third) key pressing action of the first input information (e.g. on-screen keys corresponding to the pressing action on the key 1902). And so on.

According to one embodiment, the system may include a means/method to navigate on (any of) the letters of a (e.g. proposed) word and wherein the system may show the on-screen buttons corresponding to its corresponding ambiguous key. The user then may correct/change said character as described above and the system may eventually propose another word accordingly. This feature has been previously described in detail.

According to one embodiment of the invention a simplified method for arbitrarily capitalizing letters similar to that of a full-sized QWERTY keyboard may be considered through the data entry system of the invention. Accordingly, in order to enter one of more capital letters the user may predefinely press (e.g. and hold) a predefined key (e.g. duplicating the “Shift” key of a of a PC keyboard) and press the desired (e.g. ambiguous) letter key(s) of the first keypad corresponding to one or more different character positions within said word. Each time the system proposes a different word based on an additional key press provided by the user, the characters within said character positions within the proposed word will be capitalized. As an example, by considering the four letter keys 14001-14004 of FIG. 2, in order to enter the capital letter “E” the user may press (e.g. and hold) the key 14006 and press the key 14001. The letter “e” having the highest priority among the characters/letters assigned to said key will be selected by the system and will be proposed in its capital form “E” to the user. In this example, if the user desires to change the proposed letter “E” (e.g. may be beginning of a word) to another letter assigned to said key such as for example the letter “X”, he may press the corresponding key of the second keypad 14100. The system will propose the letter “X” in its capital form.

Still in another example, in order to enter the world Semi-Final wherein in this example two of its letters must be capitalized, while the user is pressing the keys corresponding to its characters of said word, he may press (e.g. and hold) the mode/Shift key when pressing the letter keys 14003 and 14002 corresponding to the letters “S” and “F”. For easier interaction any of more than one predefined (mode/Shift) keys may be used for the same purpose. For example any of both keys 14005 and 14006 (e.g. or even any of other keys) may be used for the same purpose.

As mentioned before, the distribution of the letters and other symbols on the keys of the second and/or the first keypad may be different than those shown in the examples brought in this application. Also distribution of the “mode” instances of for example the (e.g. six) keys of the (e.g. first) keypad may be different than the examples shown.

As mentioned before, the keys of the first and/or the second keypad may have any number of keys and may have any arrangement. For example, the keys of the second keypad may be arranged on the (e.g. sides of the) (e.g. screen of the) device such that to permit the text being displayed on the screen without being covered/bothered by said keys.

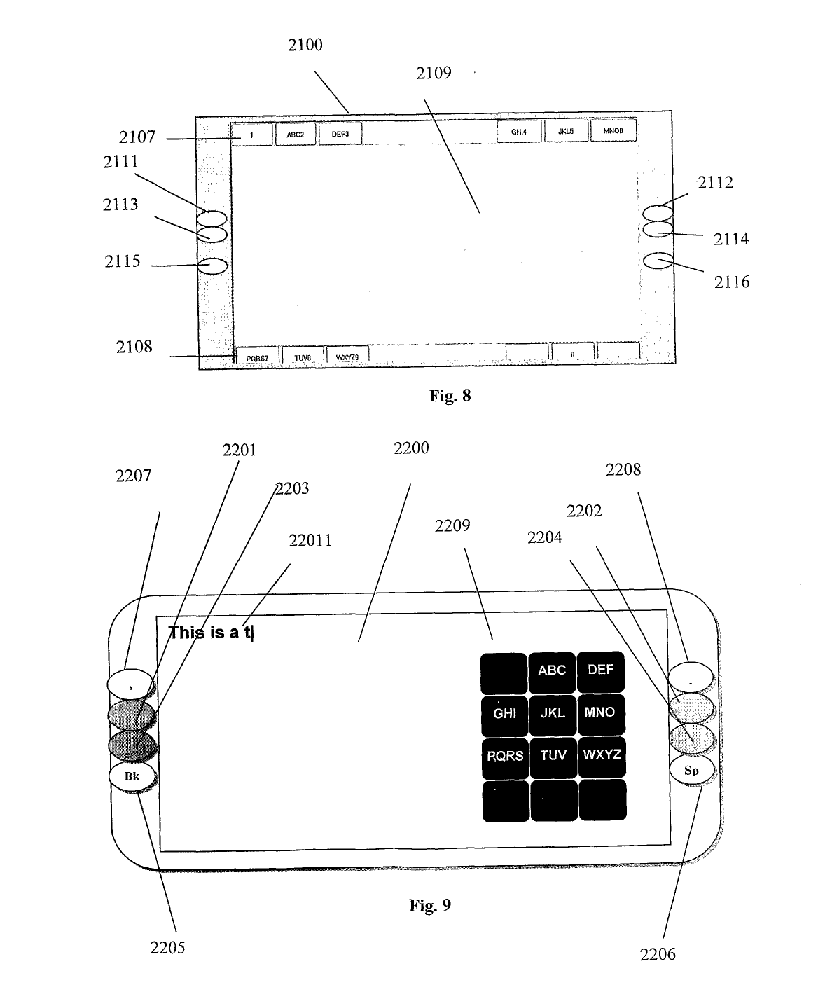

According to one embodiment of the invention, the (e.g. on-screen) keys of the second keypad can be located (e.g. printed) on (e.g. preferably one or two horizontal) rows on the side(s) of the (e.g. screen) of the device. This will permit the text to be displayed without being covered by said keys. FIG. 8 shows as an example an electronic device having the first and the second keypads of the invention. In this example the first keypad of the invention has six hard keys 2111-2116 wherein to four of its keys 2111-2114 the letters of a language are distributively assigned as described before (e.g. they duplicate the letter keys 14001-14004 of FIG. 2). Also in this example the keys of the second keypad of the invention (which in this example duplicate the keys of a telephone-type keypad) are arranged in two rows of keys 2107-2108 on two (opposite) sides of the (screen of the) device. As shown in this example, preferably the row 2107 is located on the top side of the device and the row 2108 is located on the bottom side of the device. This will permit the text to be written on the screen without being covered by the keys of the second keypad.

Obviously, said on screen keys may also be used for the “mode” functions of the data entry system of the invention as shown previously such as those shown in FIGS. 3a-3f. As an example the “TEXT” symbols may be appeared on the corresponding such on-screen keys after the corresponding mode key is pressed (and held). The user then may press the on-screen key corresponding to his desired symbol for entering said symbol.

As mentioned before, any one or more (e.g. the first and the second) of the keypads of the data entry system of the invention may be on-screen keypad.

According to one method, the second keypad may appear on the screen when the user for example, begins to enter a (new) word so that to permit the user to correct (e.g. change) the proposed word if necessary. For easier interaction, said second keypad may be appeared/shown on the screen such that to not cover the current word being entered (e.g. and preferably also not covering the current word's surrounding zone. For example, if the current word is being entered on the left (e.g. or top) side of the screen the second keypad preferably may be shown on the right (e.g. or respectively bottom) side of the screen (e.g. or vise versa). FIG. 9 shows as an example, a device 2200 having a split first keypad having eight keys 2201-2208 divided in two groups of four keys positioned on opposite sides of the device. The keys 2201-2204 are ambiguous letter keys. In this example, a word 22011 is being entered on the left side of the screen 2200 of the electronic device and the second keypad 2209 is shown on the right side of the screen.

With continuous description of the current embodiment, also for example, said second keypad may disappear after the user finishes to enter the word (e.g. by entering an end-of the word signal such as entering a space character, or a return command, etc.). Disappearing the second keypad may permit the user to have the complete view of the screen. In this embodiment, the system shows the second keypad only when it is necessary and hides it when it is not necessary).

As mentioned, when the user provides a predefined interaction such as a long pressing action (e.g. press-and-holding the key for a predefined lapse of time) on a keys of for example the first keypad, the system may show the corresponding second keypad (e.g. including the corresponding symbols) on the screen. According to one embodiment of the invention, the user then may release said key of the first keypad. The system may continue to show said second keypad. At this time the user may press one or more of the keys of the second keypad respectively corresponding to one of more of his desired symbols to enter them. The second keypad may disappear, for example, when/after the user provides a (e.g. predefined) pressing action on a (predefined) key such as a key of another (e.g. the first) keypad.

One of the obstacles to adopt a predictive data entry system is because during the entry of a word the system may propose different words based on each additional key pressing actions provided by the user. In order to solve the ambiguity resulted by such system, according to one embodiment of the invention, during the entry of the first information (e.g. (ambiguous) key pressing actions) corresponding to a word, respectively, the system may also show at least some (preferably, all) of the letters corresponding to every (ambiguous) key press provided by the user corresponding to the character positions within the word, preferably, in a column under each letter of the proposed word, or anywhere on the screen. Such columns are hereafter referred to as “letters column”. Said letter columns may include or exclude the letters of the proposed word. This may permit the user to see and verity if he has pressed the right (ambiguous) keys during the entry of a word.

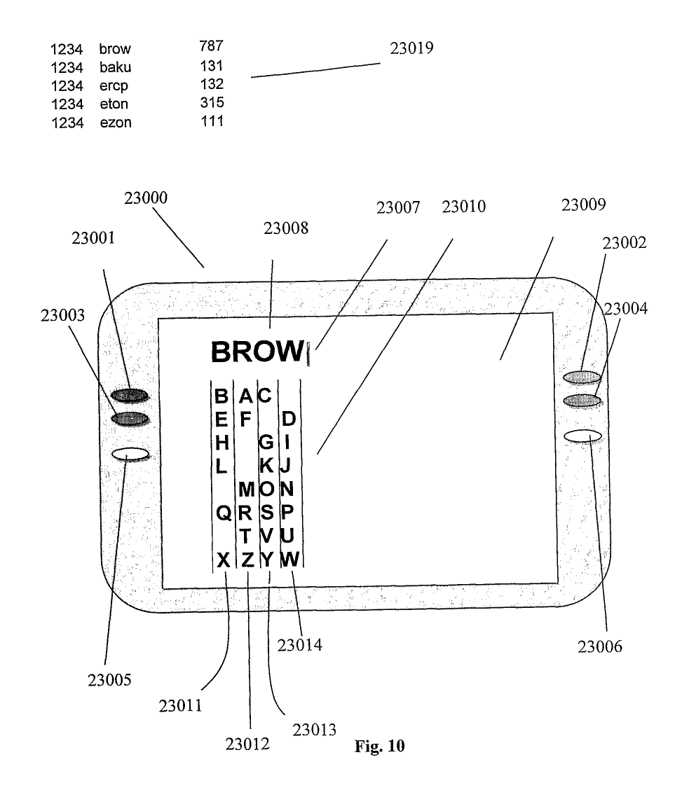

FIG. 10 shows an as example, an electronic device 23000 including the data entry system of the invention having the first keypad and the second keypad (e.g. not shows) of the invention. In this example, the first keypad of the invention has six keys 23001-23006 that duplicate the keys 14001-14006 of the keypad 14000 of FIG. 2.

As an example, by considering the portion 23019 of the words database of the system, if the user presses the ambiguous keys 23001, 23002, 23003, 23004, the system may propose the word “brow” corresponding to said key pressing actions and having the highest priority among the words corresponding to said key pressing actions. In addition to the proposed word the system may also show all of the letters corresponding to each of said ambiguous key pressing actions in corresponding columns 23010. As shown in this example, preferably the corresponding letters of each of said key pressing actions may be shown on in a corresponding column under or above (e.g. or some of the letters above and some of them under) the corresponding letter of the proposed word. In this example, the columns 23011 to 23014 include the letters of the keys 23001, 23002, 23003, and 23004, respectively.

In the example above, if the user has desired to enter the word “baku” he can see that each of the letters “b”, “a”, “k”, and “u”, is included in the corresponding letter column 23011, 23012, 23013, 23014, respectively and that therefore he has correctly pressed the corresponding keys. He then may proceed to the correction procedure of the invention to enter the desired word.

Showing the letters columns may be optional. The user may decide if he wants to have it during the text entry, or during the entry of a word. According to one method during the entry of text the user may use a predefined command such as providing a predefined key pressing action so that to inform the system to show of hide the corresponding letters columns to the user.

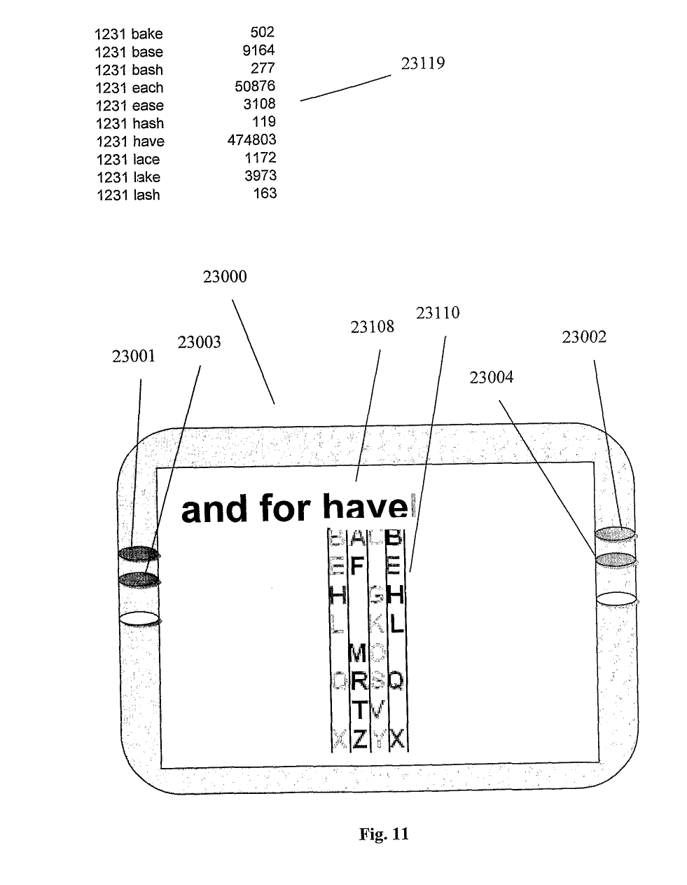

According to another example, as shown in FIG. 11, by considering the portion 23119 of the words database of the system, if the user desires to enter the word “each” he may press the corresponding letter keys 23001, 23002, 23003, 23001, of the first keypad. The system may propose the world “have” 23108 that corresponds to said key presses and that has higher priority than the word “each”. This may confuse users who are not used to use the word predictive systems. For that reason the system may include the mechanism as described above which shows (e.g. on the screen) the corresponding letters columns 23110. After showing the letters columns, as shown in this example, the user can see that although the system has proposed the word “have”, the consecutive corresponding keys presses provided by the user also correspond to (the letters of) the word “each” (e.g. each of the letters “e”, “a”, “c”, and “h”, is included in the respective column of the letter columns 23110 relating to its character position within the word). The user then may proceed to the correction procedure of the invention to enter said the word “each” by for example pressing the key of the second keypad of the invention (e.g. not shown) corresponding to the letter “e” which is the first letter of the desired word. The correction procedures of the invention such as that using a second keypad such as a telephone keypad have already been described in detail in this patent application.

According to another method during the text entry procedure, showing or hiding the letters columns may be provided by the system automatically.

According of one method pressing one predefined key such as the “BkSp” (e.g. “back space”) key, or optionally pressing two predefined key(s) (simultaneously), may inform the system to show (on the screen) the letters columns corresponding to the input information relating to a proposed word (e.g. after said “BkSp” action). This is because during providing the (e.g. ambiguous) key presses corresponding to a desired word (e.g. especially when said word is a long word) and the system does not show the right characters of a desired word, the user may get confused and do not know whether the key presses provided until that moment are correctly provided. At this moment the user may provide a “BkSp” command. After considering said “BkSp” command, the system may propose another word (e.g. having one character less) to the user along with the letters columns corresponding to the input information (e.g. corresponding ambiguous key pressing actions) provided by the user as described above. By consulting the provided letters columns the user may see whether or not he has pressed the right keys. If yes, the user may proceed to entering the (ambiguous) key corresponding to the next letter position of the desired word. At this time optionally the system may hide the letters columns from the screen. This automatic method shows the letters columns generally when it is necessary.

According to one method, if one at least one of the letters of a word proposed by the system is/are entered precisely then the system does not show the corresponding letters column corresponding to said at least one precise letter.

In order to better distinguish the neighboring letters columns from each other each of them may be printed differently such as in a different color or in different font. Also in each letters column the selected letter of the proposed word may be printed differently such as in a different color or in different font.

It is understood that the letters columns may be presented in different manners based on principles described before by people skilled in the art. For example they can be presented in large characters (e.g. larger than the characters of the corresponding word) on any location on the screen of the device regardless of the location of the text caret (e.g. cursor) or the corresponding word. It must be noted that the letters in each of the columns may preferably be arranged in alphabetical order. In addition according to one method they may be arranged such that the letters in the predefined horizontal rows of columns are the same letters as those on the keys of a telephone-type keypad, respectively.

Instead of using the letter columns the system may use colors. According to one embodiment of the invention, (the letters on) each of the ambiguous keys may have a different color. During pressing the ambiguous keys corresponding to a word, at least each of the ambiguous letters of the proposed word may be in the color of the corresponding ambiguous key. According to one method, when the user finishes to enter the word the system changes the color of all of the letters of the entered word to another color (e.g. the color of the corresponding portion (or the rest) of the text (e.g. black)).

According to one method during the entry of a word, each precise character of a proposed word may be presented differently than the ambiguous keys (e.g. different color, different font, etc.).

According to one method, during the entry of a word the system may show only the letter keys of the second keypad (e.g. such as the eight letter keys of the telephone type keypad).

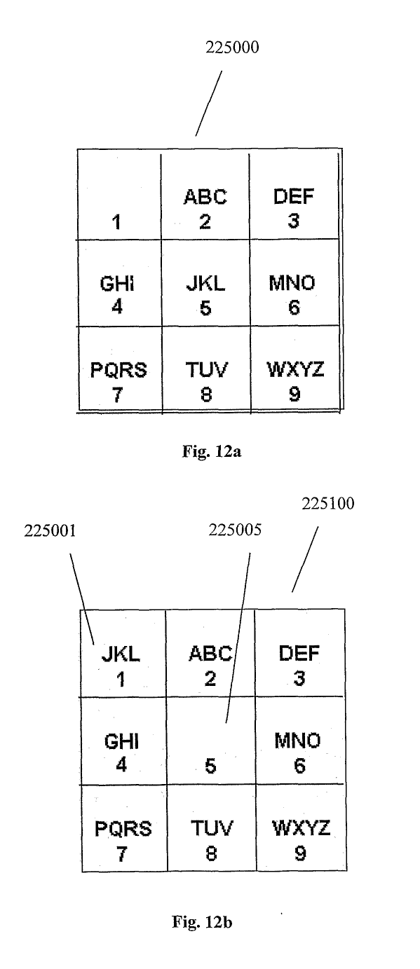

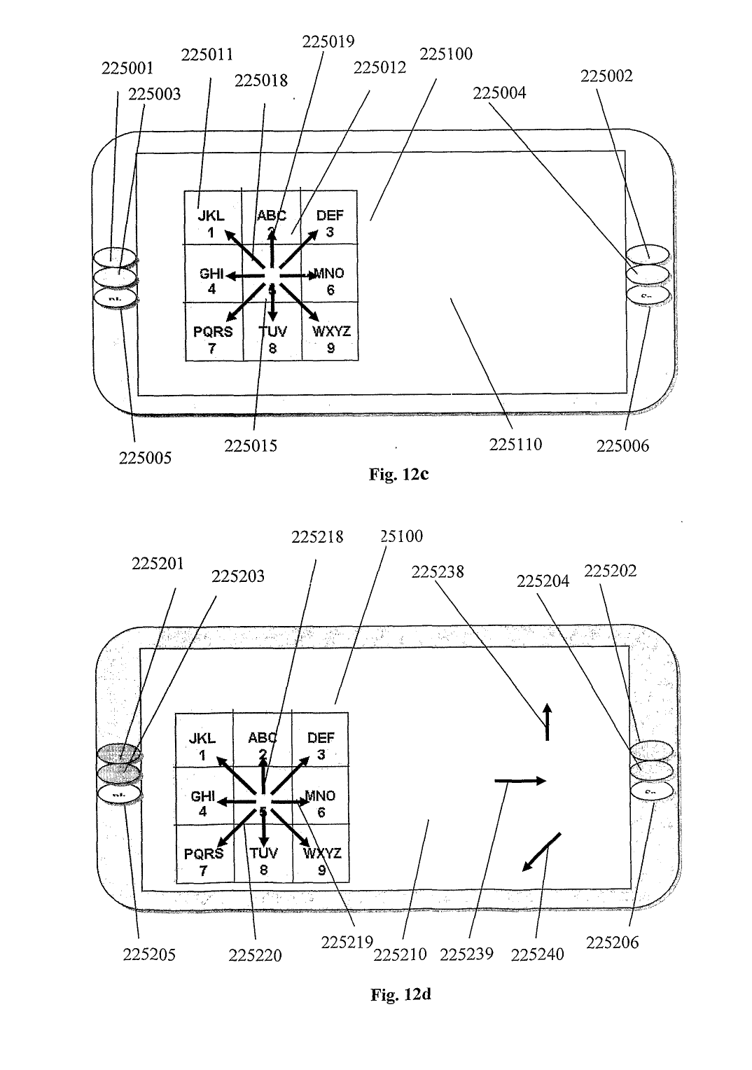

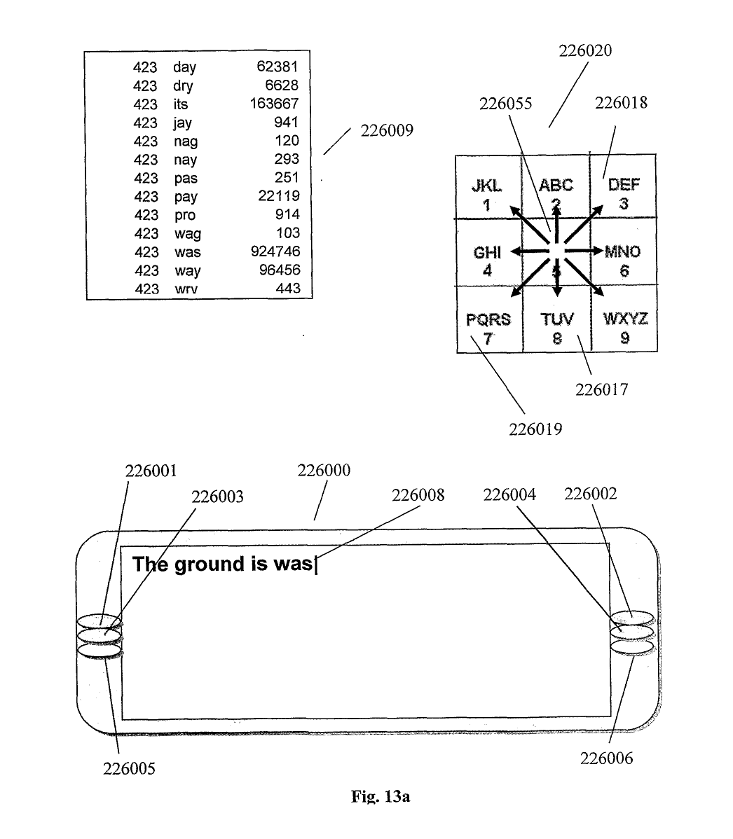

As mentioned previously, different types of interaction may be considered with the keys of the keypads of the data entry system of the invention. The second keypad of the invention may be located on a touch sensitive surface. According to one embodiment of the invention instead of a tapping action on a key of the second keypad a (e.g. predefined) gliding action towards (or departing from) said key may be provided. The system may recognize the corresponding (e.g. said) key based on said gliding action. According to one method, the second keypad of the invention may be arranged such that to form a (square) keypad having three columns of (square) keys by three rows of (square) keys. According to one embodiment, as shown in FIG. 12a, the keys of said keypad 225000 may duplicate the letter keys of a telephone type keypad. FIG. 12b shows the same keypad with minor modification 225100. In this example, letters “jkl” which originally had been assigned to the key 225005 are here assigned to the key 225001. The reason for such letter assignment is described hereafter.

As shown as an example in FIG. 12c, the arrangement of letters on the keys of the exemplary keypad 225100 located on for example the touch screen 225110 of an electronic device permits to provide eight different gliding actions (e.g. vectors) in different directions, from the center (key) 225015 of the keypad towards the (surrounding) letter keys of said keypad (or vise versa). Each of said gliding actions may correspond to (interacting with) a different key of the keypad 225100. For example, the gliding action 225018 corresponds to (interacting with) the key 225011 and the gliding action 225019 corresponds to (interacting with) the key 225012, and so on. In this example, the trajectories of each of the two neighboring gliding actions have preferably an angle of approximately 45 degrees relating to each other. There are two opposite vertical gliding actions, two opposite horizontal gliding actions, one diagonal gliding action towards upper-left side and one its opposite gliding action, and one diagonal gliding action towards upper-right side and one its opposite gliding action.

According to one embodiment of the invention, a gliding action having a parallel trajectory relating to each of said gliding actions may be provided on any location on a touch sensitive surface to duplicate the original gliding action and to correspond to the same key. As an example, by using a device having a touch sensitive surface 225210 as shown in FIG. 12d, the gliding actions 225238, 225239, 225240, provided anywhere on the said touch sensitive surface 225100 duplicate the gliding actions 225218, 225219, 225220, respectively, that may be provided on the exemplary second keypad 225100.

According to one embodiment of invention, showing or hiding the second keypad on the screen may be optional. According to one method, it can be decided by the user. In such method, the user may provide the gliding actions corresponding to the desired keys (of the second keypad) without having said keypad on the screen (e.g. in this case the second keypad is a predefined virtual keypad model). An advantage of having (the letter keys of) the second key pad of the invention in form of a telephone type keypad is because most users are familiar with the location of letters on the keys of a telephone keypad and they may not need to have it shown on the screen. The users may also easily remember the locating of the letters on the slightly modified keypad 225100 of the invention. This permits to have the screen of the device totally free of the user input interface (e.g. keypads).

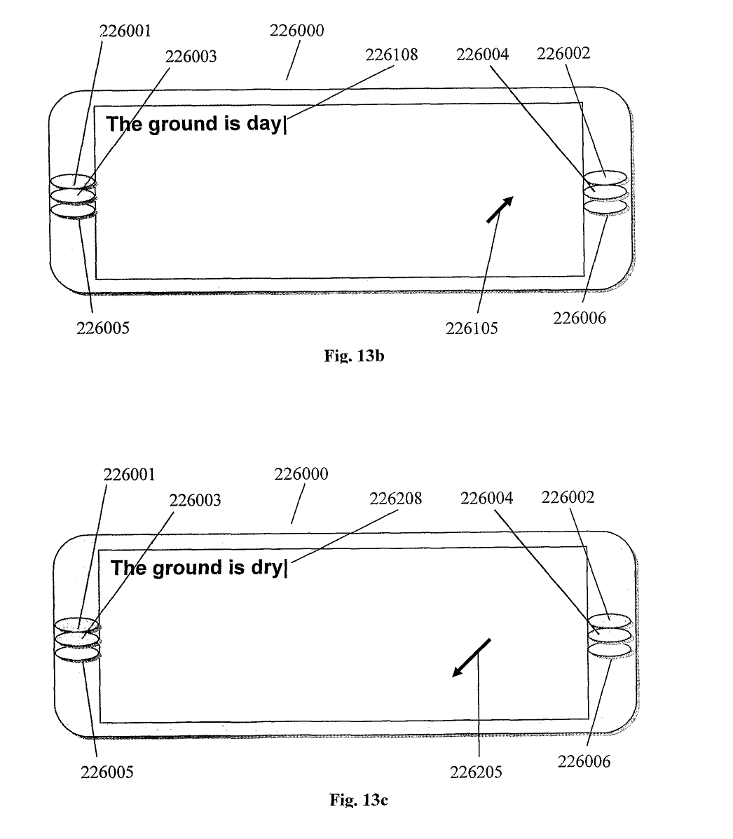

As example of such method of text entry is shown throughout the FIGS. 13a to 13c. FIG. 13a shows a device 226000 including the first keypad of the invention having the hard keys 226001-226006 which duplicate the keys 14001-14006 of the keypad 14000 of FIG. 2. By considering the portion 226009 of the word database of the system in order to enter the word “dry” the user press the corresponding keys of the first keypad. By considering the corresponding words of the database the system may propose the word “was” having the highest frequency of use. At this time the user may proceed to the correction procedure of the invention based on the gliding method as described above. As shown in FIG. 13b, the user now provides a gliding action 226105, that duplicates a gliding action from the center 226055 of the virtual keypad of the invention 226020 towards the key 226018 (e.g. having the letters “def”) as shown in FIG. 13a. Based on the principles of the data entry system of the invention using a first and a second keypad and by considering the database of words of the system, the system then shows the word “day” having the highest priority among the words of the database that begin with letter “d”. At this time, as shown in FIG. 13c, the user provides the gliding action 226205 that corresponds to interacting with the key 226019 of the virtual keypad of the invention 226020 (e.g. the virtual keypad is shown in FIG. 13a). Based on the principles of the data entry system of invention the system understands that the second letter of the desired word must begin with the letter “r” and therefore proposes the word “dry” which in this example is the desired word.

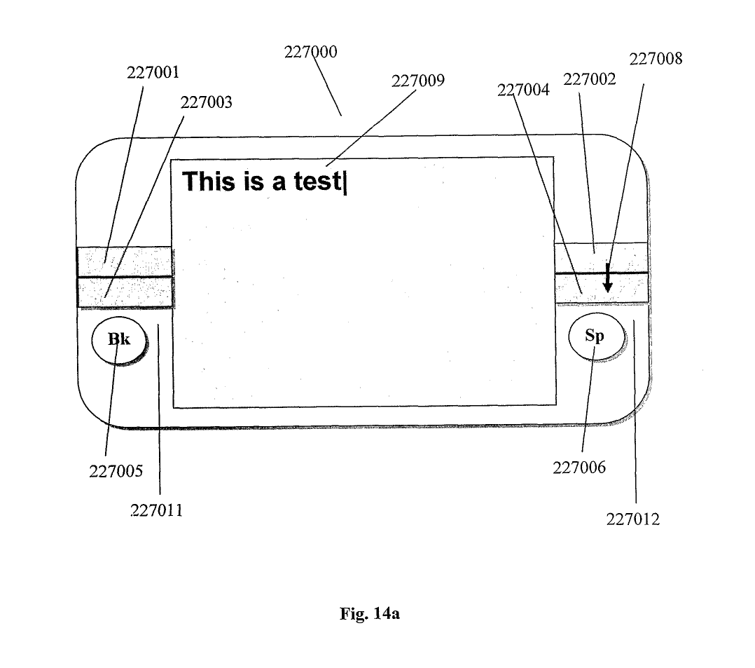

Obviously, any of the first and the second keypads of the invention may use a touch sensitive surface to duplicate its keys. As an example, FIG. 14a shows a device 227000 having one touch sensitive pad on each of its sides wherein each of said pads 227011, 227012, duplicate (at least) two of the letter keys of the first keypad of the invention. In this example, the zones/portions 227001 to 227004 of the pads duplicate the keys 14001 to 14004 of the keypad of the FIG. 2. As an example, in order to enter the word “test” the user may tap on the zones 14002, 14001, 14003, 14002 (e.g. the first input information). The system may propose the word “rest” of the database corresponding to the provided tapping actions. At this time the user may proceed to the correction procedure by providing an additional input information to precisely enter the first letter of the desired word which in this example is the letter “t”. For this purpose, the user may provide a predefined gliding action 227008 (e.g. vertical gliding action towards the bottom) corresponding the relevant key of the (virtual) second keypad of the invention (e.g. the key 226017 of the keypad 226020 as shown in FIG. 13a), on one of the sensitive pads that in this example also are used to duplicate the keys of the first keypad of the invention. Based on the principles of the data entry system of the invention, the system understands that the desired word must begin with the letter “t” and therefore proposes the word “test” corresponding to the combined input information provided by the user. According to one embodiment, the screen of the device may be touch sensitive and be used for at least the mouse functionalities.

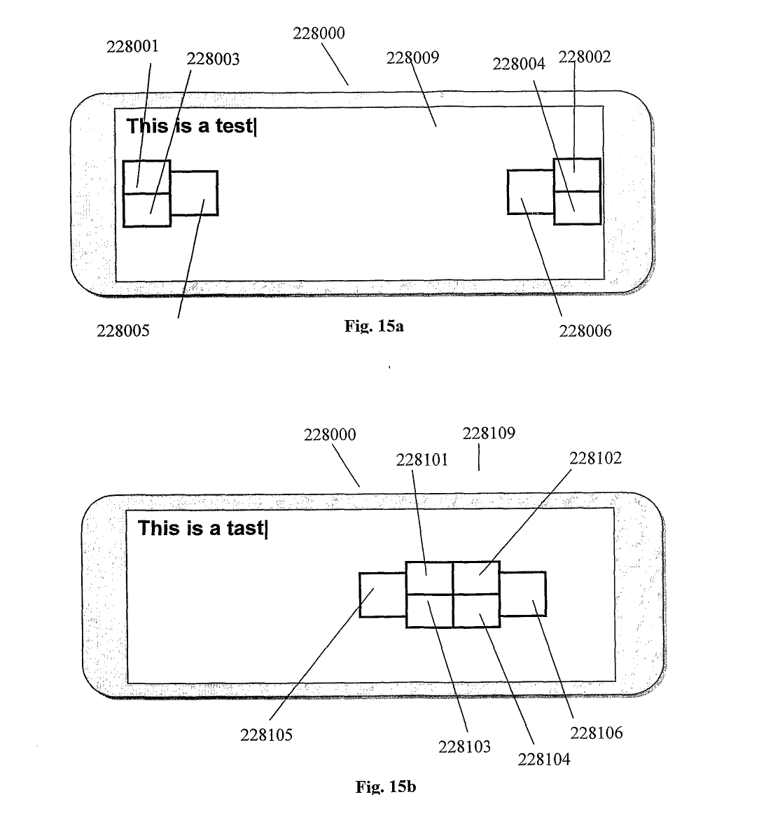

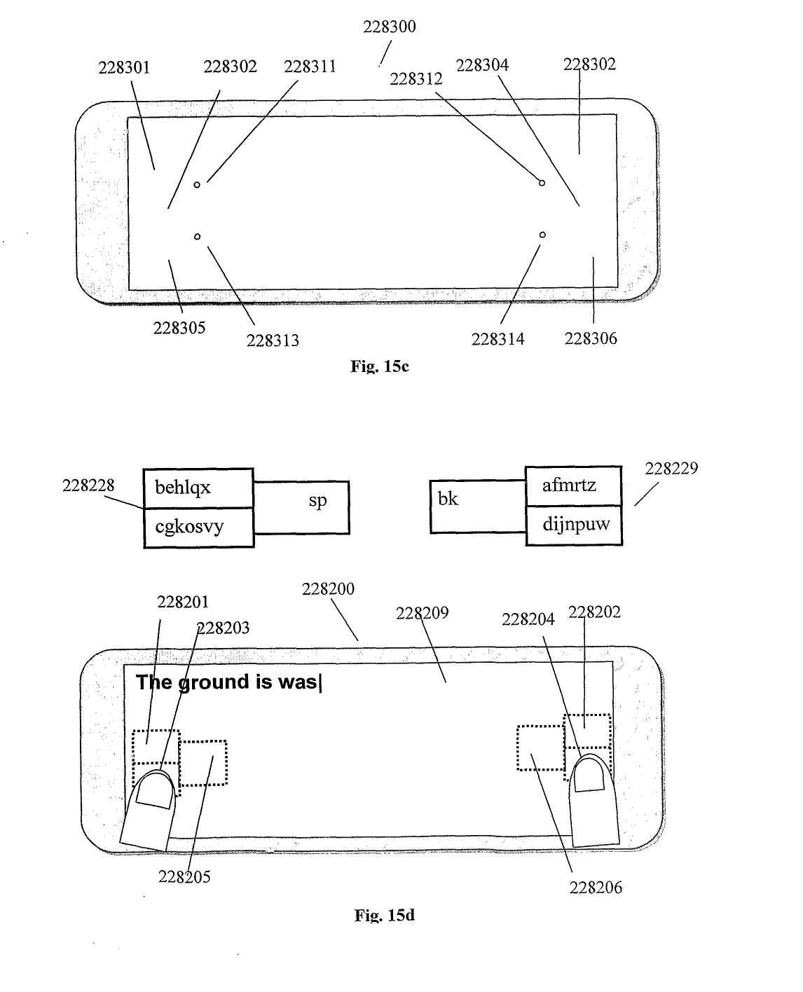

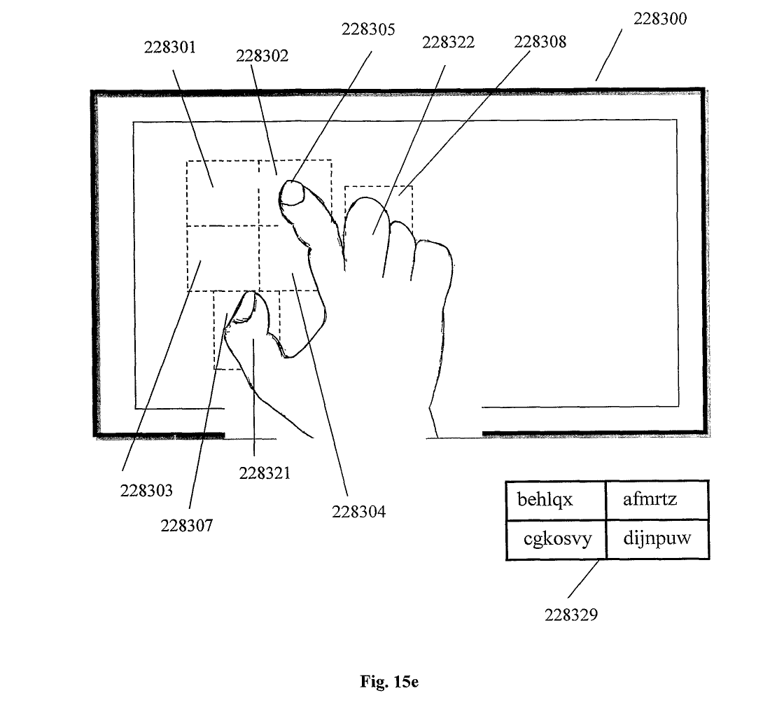

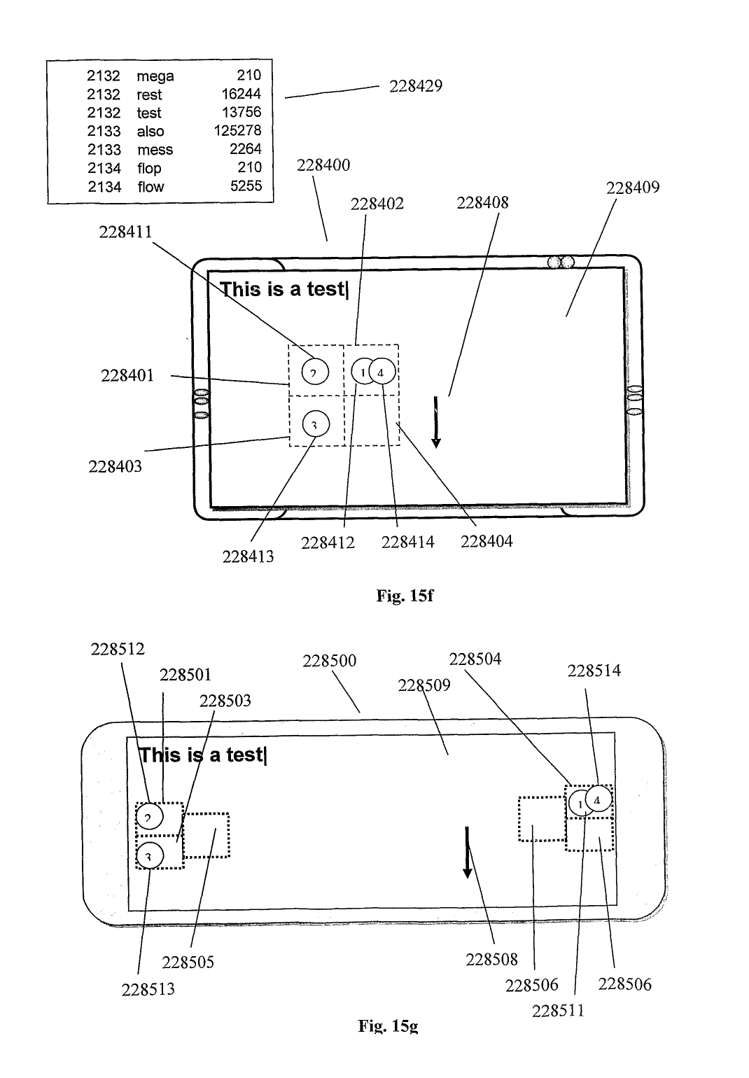

As mentioned before, the first and/or the second keypad of the invention may have any type of keys such as virtual keys, touch-pad keys, on-screen keys, etc. According to one embodiment of the invention the first keypad of the invention may use a touch sensitive surface for example it may be an on-screen keypad and the second keypad of the invention may be a virtual keypad/keypad model as described above. FIG. 15a shows as an example, an electronic device 228000 having a touch screen 228009 and using the first and second keypads of the invention. In this example the first keypad of the invention is a split on-screen keypad arranged on the opposite sides of the device wherein four of its keys 228001-228004 duplicate the keys 14001-14004 of the keypad 14000 of FIG. 2, and the second keypad of the invention is a virtual keypad (not shown) such as the keypad 226020 as shown in FIG. 13a. FIG. 15b shows the same device 228000 wherein the keys 228101-228106 of its on-screen first keypad are closed to each other so that the user can enter text with the finger(s) of a single hand. As in the previous example, the second keypad may be a virtual keypad as described in the description relating to FIG. 15a.

With continuous description of the current embodiment, according to one method, interactions such as tapping/gliding actions corresponding to the second keypad of the invention are allowed to be provided outside the zones of the keys of the first keypad. According to another method, gliding actions anywhere on the screen (e.g. even on the keys of the first keypad) may be related to interacting with the keys of the second keypad of the invention.

The above-mentioned embodiment of the invention permits to devices without hard keys to have a very easy and fast data entry system (i.e. the data entry system of the invention using the first and the second keypads of the invention) wherein the on-screen (e.g. keys of the first keypad) and obviously the virtual keys/keypad model (e.g. of the second keypad) of the data entry system do not occupy the screen of the device therefore the system permits the user to use the whole screen of the device for tasks such as text entry and viewing purpose.

It is understood that the keys on each side on a touch sensitive surface may be arranged differently, for example, forming one column of keys on each side. Accordingly, as shown in FIG. 15c, few small dots 228311-228314 (e.g. in this example two dots on each side) printed on each side of the screen along with the borders of the screen may define and show to the user the borders of the keys of the first keypad 228301-228306 (e.g. in this example, three keys on each sides) without printing said keys on the screen. The zone of the keys on the screen may be used for the output printed on the screen.

Different (hardware) systems using touch sensitive surfaces such as touch-screen of electronic devices, touch sensitive pads, touch sensitive finger caps, touch sensitive gloves, etc. providing dynamic keys duplicating at least the ambiguous keys of a keypad having few keys have been described in detail in different patent applications field by this investor.

According to one method, the system may include at least one predefined (virtual/imaginary) keypad model having few keys that have predefined location relationships relating to each other. Providing tapping actions on different zones (of a touch sensitive surface) having the same relationship relating to each other may duplicate interactions with the corresponding keys of the keypad model.

According to another method, the location of at least a first impact of a user's (e.g. finger/stylus) tap on a surface may dynamically define the corresponding key also defining the location of at least some of the other keys of the dynamic keypad. Generally, by receiving the information corresponding to a taping action provided by the user on few different points on the touch sensitive surface (e.g. hereafter, referred to as “beginning taps”) wherein the relationship between said points is similar to the relationship of the corresponding keys of the keypad model relating to each other, and by considering the keys relationship of keypad model, said information is generally enough for the system to dynamically define the other points on the touch sensitive surface that represent the other keys of the keypad model, all of the points together constituting a dynamic keypad representing the keypad model. Preferably, a predefined zone around each of said points is defined by the system as a key of the dynamic keypad.

Optionally, each time the user begins to type a text at a desired portion on the screen and provides said beginning taps the system provides a new dynamic keypad at said portion. Optionally, during the entry of a text, if the user provides modifications of taping points, the system may adjust the location of the dynamic keypad.

Obviously, the advantage of a dynamic keypad is in that the user can begin to provide interactions anywhere on a touch sensitive surface such as on the screen of a device, and the system dynamically relates said interactions to interacting with the keys of the corresponding keypad model. Additionally, the user may provide the input information (e.g. taping action) on the surface/screen while said surface/screen is in landscape, portrait, and even diagonal, position.

According to one embodiment of the invention, at least the first keypad of the invention may be a dynamic keypad. Optionally said keypad has four ambiguous (letter) keys. Preferably, said keypad has also at least two more keys.

According to one embodiment, at least said letter keys are adjacent. According to another method at least said letter keys of the dynamic keypad may be divided into two groups located on opposite side of a touch sensitive surface relating to each other.

As described, the first keypad of the invention may be a dynamic keypad wherein four of its keys duplicate the four letter keys of the first (virtual) keypad of the invention. By tapping words on four dynamic keys on a touch sensitive surface such as on a touch screen of an electronic device the user may enter text without looking for the keys on the device. As an example, when the user taps on four different locations on the screen to duplicate the tapping actions on four corresponding letter keys of the first keypad of the system, the system can easily recognize the corresponding key of each of said tapping actions based on the relationship of the locations of said tapping actions relating to each other. This matter has already been described in detail in this and the previous patent applications field by this inventor. This will permit to the user to enter the text by tapping on any locations on the device as long as the relationship between the tapping locations on the device sensitive surface duplicate the locations of a predefined virtual first keypad (model) of the invention using preferably at least four keys to which the letters of a language are distributively assigned. The combination of the dynamic first keypad of the invention, and the virtual second keypad (e.g. without being printed on the screen) of the invention interacted by the gliding actions corresponding to its keys wherein said gliding actions may be provided anywhere on the screen can permit the user to provide very fast and easy data/text entry on a device having a touch sensitive screen without looking for the (e.g. location) of the keys on said keypads permitting a totally eye-free input interface.

According to one embodiment of the invention, at least the letter keys of the dynamic keypad may be divided into two groups located on opposite side of a touch sensitive surface relating to each other. Accordingly, the location of at least a first impact of a user's (finger) tap on each side of the surface may dynamically defined the corresponding key also defining the location of at least some of the other keys of the corresponding keypad on at least said side. According to one method, each of the user's thumbs is used to provide tapping actions on its corresponding side (while holding said device by his two hands). According to one method, the user may begin to type with his thumbs and by considering the keypad model also divided in two portions, the system dynamically defined the dynamic keys of the dynamic keypad on each sides. According to another method, before beginning to type, the user provides a predefined calibration procedure such as providing a number of taping actions on one or each sides of the sensitive surface, and then begins to type. The calibration procedures and some methods thereof are being described in previous and the current patent applications of this inventor.

As an example, FIG. 15d shows an electronic device 228200 using the predefined virtual first keypad model of the invention (e.g. having two portions 228228, 228229). For entering a word the user can tap on the touch-screen of the device as if he was tapping on the keys of the virtual keypad (e.g. the location of the tapping actions 228201, 228203, 228205 on the left side of the screen relating to each other being (approximately) resembling to the locations of the keys of the left side 228228 of the virtual keypad relating to each other, and the location of the tapping actions 228202, 228204, 228206 on the right side of the screen relating to each other being (approximately) resembling to the locations of the keys of the right side 228229 of the virtual keypad relating to each other. By doing so (e.g. the system may dynamically create the corresponding on-screen keypad and) can relate each of the tapping actions provided by the user to the corresponding key of the predefined virtual first keypad of the invention.

Obviously the keys of the predefined virtual first keypad of the invention may have different arrangement. As an example, FIG. 15e shows an electronic device 228300 using the predefined virtual first keypad of the invention 228329. For entering a word the user can tap on the touch-screen of the device as if he was tapping on the ambiguous letter keys of the virtual keypad 228329 (e.g. the location of the tapping actions 228301-228304 on the screen relating to each other being (approximately) resembling to the locations of the keys of the virtual keypad 228329 relating to each other). By doing so (e.g. the system may dynamically create the corresponding on-screen keypad and) can relate each of the tapping actions provided by the user to the corresponding key of the predefined virtual first keypad of the invention.

The keypad model may also include additional keys (e.g. in this example they are duplicated on the zoned 228307, 228308) corresponding to locations of other fingers of the user's hand such as his thumb 228321 and 228322, relative to for example the approximate zones of the four letter keys dynamically created based on his forefinger 228305 used for taping on the four letter keys while for example the user's palm of the hand is laid on the surface.

All of the mode keys of the system may also be duplicated through the dynamic keypad. For example, instead of a taping action corresponding to a key, the user may provide a long pressing action corresponding to said key. The system then may enter into the corresponding mode instance. According to one method, the user then may provide a gliding action for entering a desired symbol corresponding to interacting with a key of the second keypad duplicated through said gliding action.

FIGS. 15f and 15g show example of text entry through the dynamic first keypad of the invention combined with the virtual (also dynamic) second keypad of the invention. As an example in FIG. 15f, and by considering the predefined virtual first keypad 228329 of FIG. 15e and the portion 228429 of the exemplary word database of the invention, in order to enter the word “test” the user may tap on the screen as if he was tapping on the corresponding keys of the first virtual keypad of the invention. In this example, in order to enter the desired word the user taps on the locations 228412, 228411, 228413, 228414. By considering the relationship between said tapping actions relating to each other the system relates each of said tapping actions to the corresponding key of the predefined virtual first keypad 228329 (e.g. as shown in this example, said tapping actions may be considered such that if the user has tapped on the keys 228402, 228401, 228403, 228402 of an imaginary on screen keypad duplicating the virtual first keypad 228329 of the invention) and proposes the word “rest”. As mentioned before, at this time the user proceeds to the correction procedure of the invention and provides a gliding action 228408 corresponding to the key of the virtual second keypad of the invention to which the letter “t” is assigned (e.g. described before). At this time the system proposes the word “test”. FIG. 15g shows the entry of the same word “test” through the same types of the first and the second keypad of the invention with the difference that here the keys 228501-228506 of first keypad of the invention duplicates the split virtual keypad of FIG. 15d having two portions 228228, and 228229. After providing the first input information the system proposes the word “rest” and the user provides the gliding action 228508, and correspondingly, the system proposes the word “test”.

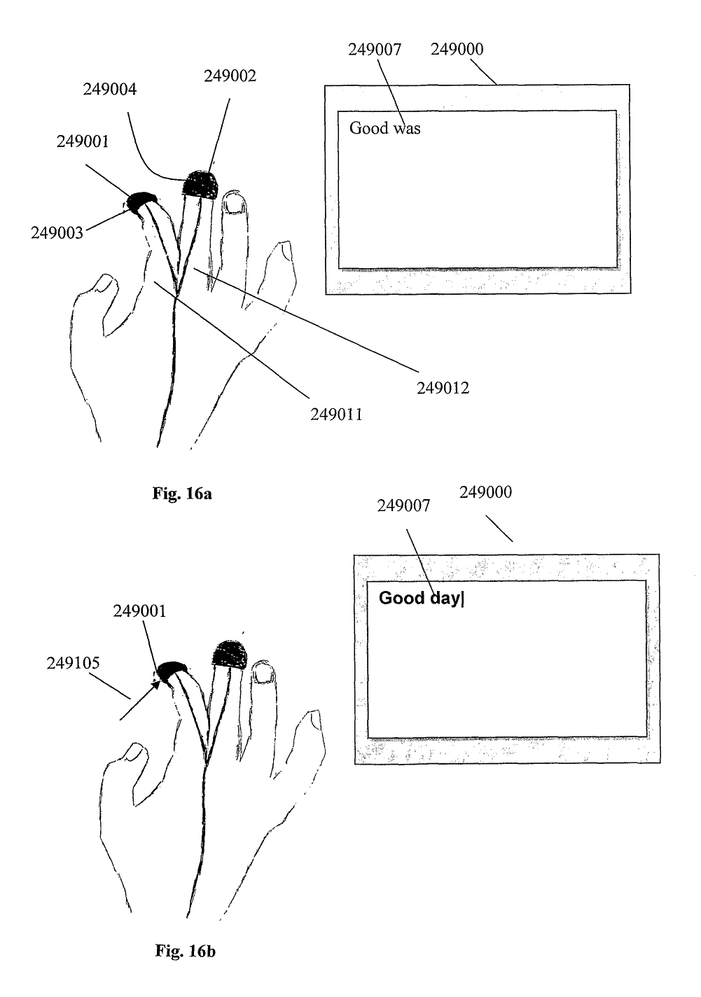

Obviously as described in different patent applications field by this inventor, instead of using a touch sensitive surface for duplicating the first and/or the second keypad of the invention, an external device/means such as a finger-cap system having touch sensitive surface (and being wirelessly or by wired connected to the corresponding electronic device) may be used to duplicate the first and/or the second keypads of the invention. The mechanism of such finger-cap duplicating at least the four letter keys of the (e.g. first) keypad of the invention has been described in detail in those patent applications incorporated here by reference. In brief, as shown in FIG. 16a, according to one method, a finger-cap means having at least two finger-caps having touch sensitive pad (on their surface) may be located on for example at least two fingers 249011, 249012 of a user. By considering the virtual first keypad 228329 of the invention of FIG. 15e having four letter keys:
if the user provides a pressing action with the flat portion of his left finger-cap the system may predefinely relate said pressing action to the upper-left key of the virtual first keypad 228329
if the user provides a pressing action with the tip portion of his left finger-cap the system may predefinely relate said pressing action to the lower-left key of the virtual first keypad 228329
if the user provides a pressing action with the flat portion of his right finger-cap the system may predefinely relate said pressing action to the upper-right key of the virtual first keypad 228329
if the user provides a pressing action with the tip portion of his right finger-cap the system may predefinely relate said pressing action to the lower-right key of the virtual first keypad 228329

In addition to the tapping actions, the user may also provide gliding actions (on any surface) with a (e.g. any) of the finger-caps to for example duplicate the gliding actions relating to the keys of the second keypad of the invention. As an example, in order to enter the word “day” the user may:
tap with the tip portion 249002 of his right finger-cap on a surface
then, he may tap with the flat portion 249004 of his right finger-cap on a surface
and, he may tap with the tip portion 249003 of his left finger-cap on a surface.

By considering said tapping actions and the portion 226009 of dictionary of the words of the system of FIG. 13a the system may propose the word “was”. Then as shown FIG. 16b, the user may provide, with one of his finger-caps, a predefined gliding action 249105 corresponding to the key of the second keypad (in this example, a telephone-type keypad) of the invention including the letter “d”. By considering said combined input information the system provides the word “day”.

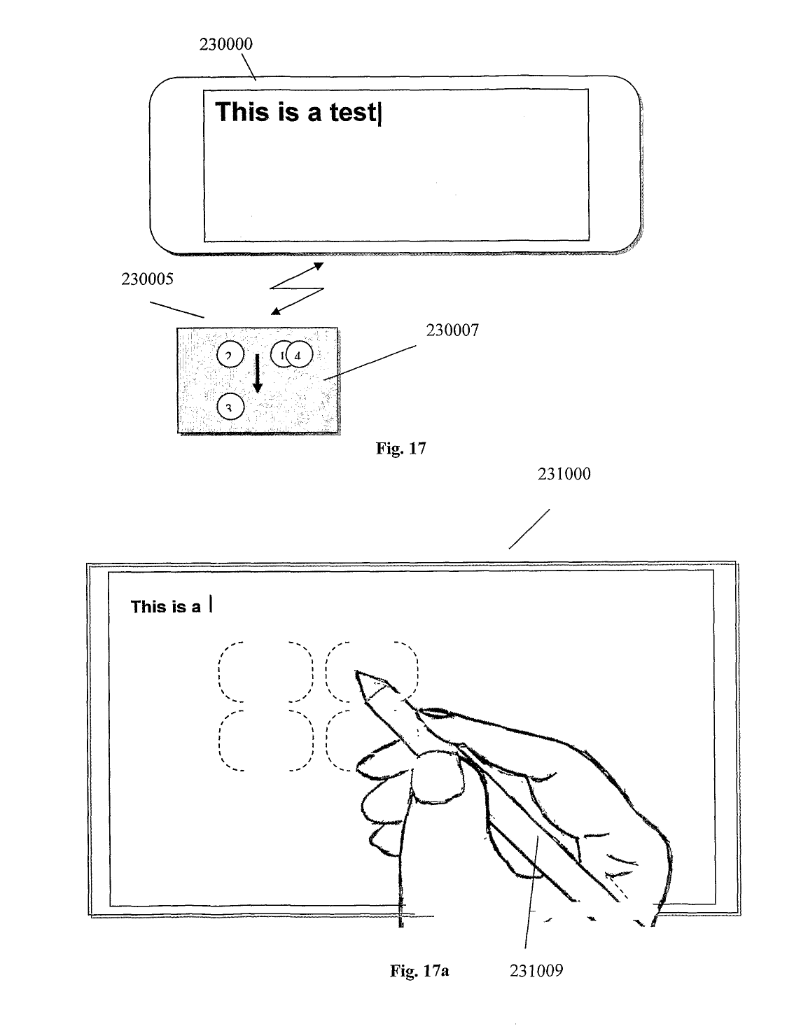

According to one embodiment of the invention, an external input means having a touch sensitive surface may be provided such the user may duplicate the first and the second keypads of the invention as described above. Said input means may be connected wirelessly of by wires to the corresponding electronic device. FIG. 17 shows as an example, an input means 230005 having a said touch sensitive surface 230007 which in this example is wirelessly connected to the electronic device 230000. In this example, the word “test” is entered based on the principles as described above.

It must be noted that the examples of input means described in this parent application are brought to describe the principles of features of the invention. It is understood that other input means duplicating the first and/or the second keypads of the invention may be considered by people in the art. For example, as shown in FIG. 17a, an electronic stylus 231009 detecting the movements of said stylus duplicating the interactions with the first and the second keypad of the invention may be used with the data entry system of the invention.

It must be noted that all of the mode key interactions of the data entry system of the invention may be duplicated with any of the means duplicating the first and the second keypads of the invention. For example, if the first keypad has touch sensitive keys, the user can provide a predefined pressing action such as a press and holding action on a predefined key of said keypad to enter the system into the corresponding mode procedure. The mode procedures of the system have already been described in this patent application.

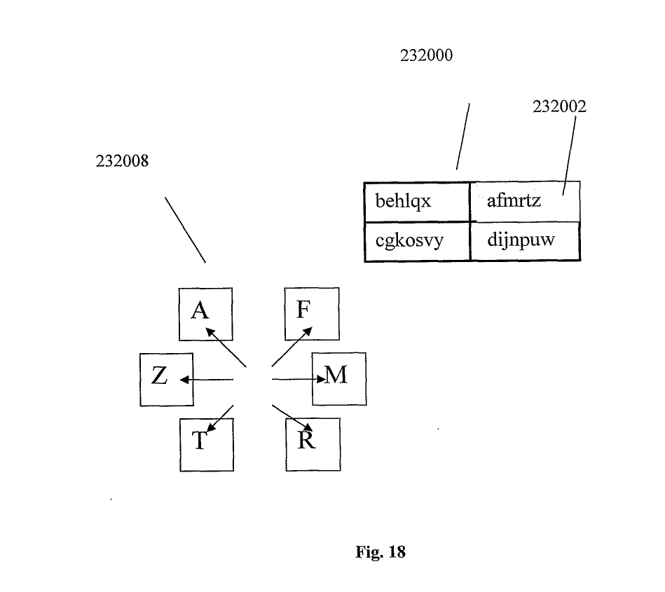

According to one embodiment of the invention, when the user interacts with one of the letter keys of the first keypad of the system the system may show a number of keys wherein each key represents one to the letter on said key of the first keypad being pressed. FIG. 18 shows as an example a key 232002 of the first keypad being pressed. FIG. 18 also shows the keys of (e.g. an on-screen) second keypad 232008 corresponding to said key of the first keypad being pressed. The keys of the second keypad of the invention may be arranged such that a gliding action provided by the user on a touch sensitive surface such as the screen of the corresponding device may easily interpreted by the system and being related to the desired key of said second keypad. In this example, the gliding actions (e.g. vectors) have easily distinguishable different trajectories.

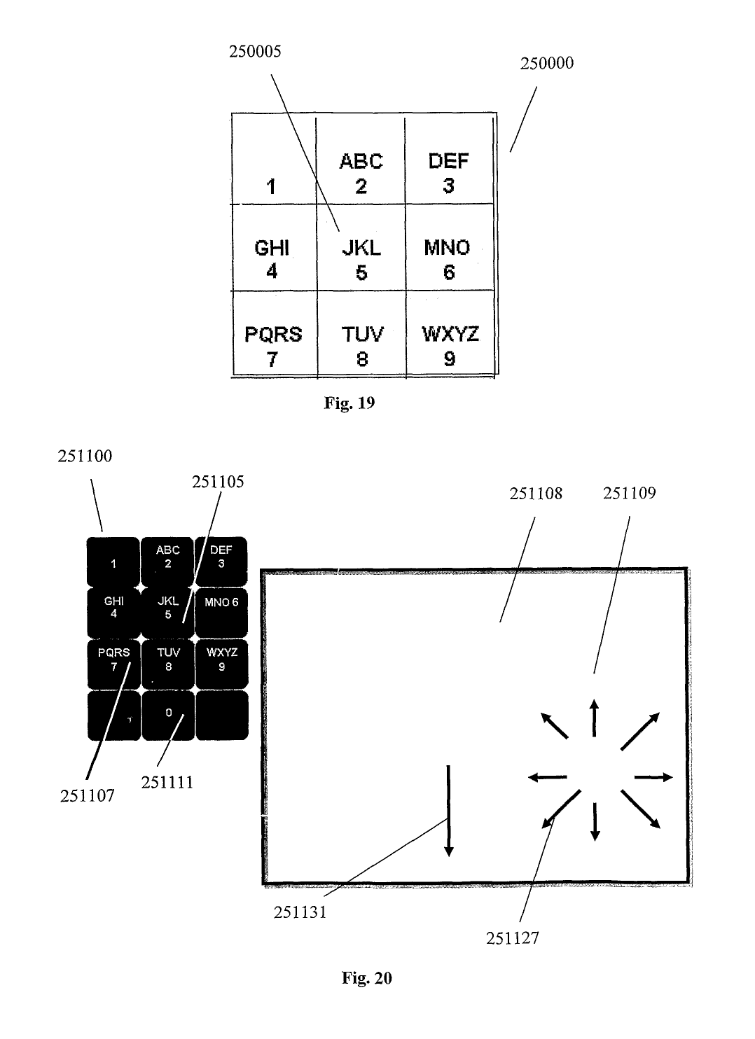

According to one embodiment of the invention, the letter keys of the second keypad of the invention may duplicate the standard distribution of the letters on a standard telephone-type keypad such as the keypad 250000 shown in FIG. 19. In this embodiment, during the correction procedure of a word or during the mode instance of the invention, a tapping/pressing action on the sensitive surface (e.g. the touch-screen, touch-pad) corresponding to the electronic device may correspond to the center key (e.g. in this example, the key 250005 including the letters “jfk”). For each of the other letter keys, the corresponding gliding action as described previously may be provided.

It must be noted that the gliding action procedure corresponding to a key of the second keypad can be integrated within (e.g. the embodiments of) the data entry of the system as an additional feature or to replace the tapping/pressing action on said key. For example, the gliding action corresponding to the entry of a precise character of a word can be provided at any moment during the entry of a word. As an example, by referring to the example of the entry of the word “day” described throughout the FIGS. 13a to 13c, another way of the entry of the said word is to press the key 226004 (e.g. having the letters “dijnpuw”) of the first keypad and then providing the gliding action 226105 corresponding to the key 226018 (e.g. having the letters “def”) of the second keypad. The only common character on said keys is the letter “d”. According to the principles of the data entry system of the invention, the system enters said letter. The user then may press the ambiguous keys 226002, 226003 of the first keypad that correspond to the remaining letters of said word. By considering the combined input information provided by the user the system proposes the word “day”.

According to one embodiment of the invention, each of the several gliding actions provided in different directions without removing the finger/pen from the (e.g. touch) sensitive surface may correspond to its corresponding key.

According to one embodiment of the invention, if the user locates the cursor (e.g. the caret) at the end of a word within a text, then he can proceed to changing said word by either adding additional characters to said word or by proceeding to the correction procedure of the invention (e.g. additional input information). According to one method in both cases the system considers the initial input information provided for the entry of the initial word and provides a new word based on said initial input information and said additional input information.

According to one embodiment of the invention, if the user locates the cursor on a word, then the system may show at least some of the (e.g. most frequently used) other words corresponding to the input information provided by the user for the entry of said word. According to one method, then the user may proceed to the correction procedure of the invention, or selecting one of said words shown by the system.

According to one embodiment of the invention, if the system is neither in the correction procedure instance of the invention nor in a mode instance, the gliding actions on the touch-sensitive surface may be interpreted by the system for the entry of the numbers. FIG. 20 shows the gliding actions 251109 in different directions corresponding to the (the keys containing the) digits 1 to 9 excluding the digit 5 which in this example is provided by a tapping action on the sensitive surface.

For example, the gliding action 251127 duplicating a gliding action departing from the center key 251105 towards the key 251107 of the keypad model 251100, corresponds to the digit “7” located on the key 251107. A tapping action (anywhere) on the touch-sensitive surface 251108 may correspond to the digit “5” which is assigned to the key 251105. For entering the digit “0” situated on the key 251111 a different predefined interaction such a longer-time pressing action anywhere on the screen, or a gliding action 252131 having longer trajectory (e.g. a shorter gliding action in the same direction may correspond to the digit 8) duplicating a gliding action departing from the center key 251105 towards the key 251111 containing the digit “0” may be provided on the touch-sensitive surface.

The methods of interaction for the entry of the digits may also be used for dialing (telephone) numbers.

The mode procedures of the invention for entering at least the other symbols (e.g. symbols other than letters, also called “special symbols” which include at least special characters, pc and customized functions/commands assigned to the keys of the keyboard) of at least substantially a full (e.g. qwerty, azerty, etc.) keyboard have been described before. Obviously, because the gliding action methods corresponding to the keys of the second keypad of the invention duplicate the tapping actions on the corresponding keys of said keypad as described, said gliding actions may also be used for the entry of said other symbols (e.g. through/during the mode procedures/instances of the invention).

After providing a predefined pressing action (e.g. a long pressing action, a press-and-holing action, etc.) on a key of the first keypad of the invention for entering into the corresponding mode instance, the system may show the symbols corresponding to said mode (key) on the keys of the second keypad (e.g. one symbol per key). The user then may provide the gliding/tapping action corresponding to his desired symbol shown on a key of the second keypad, on the sensitive surface of the device.

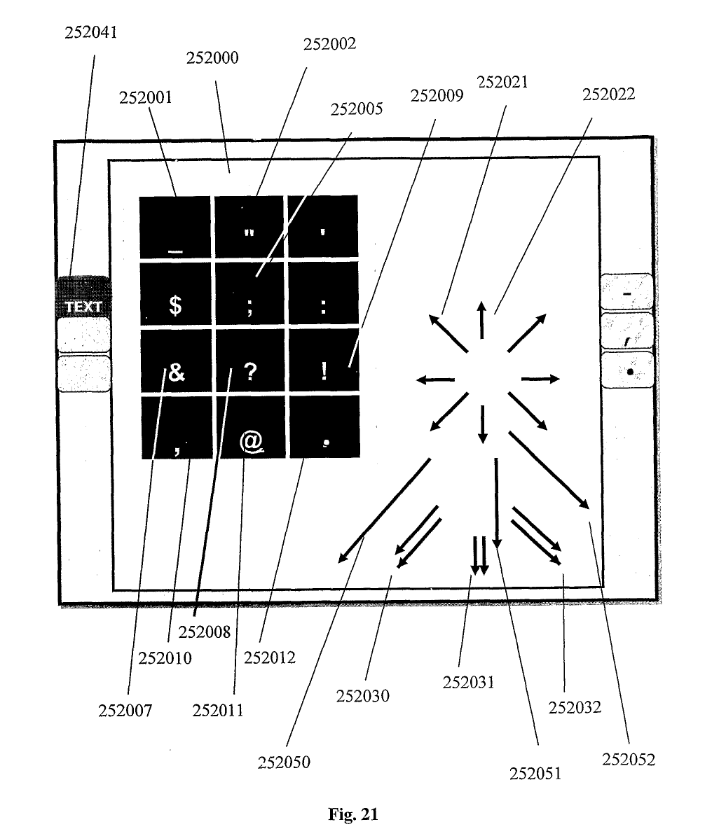

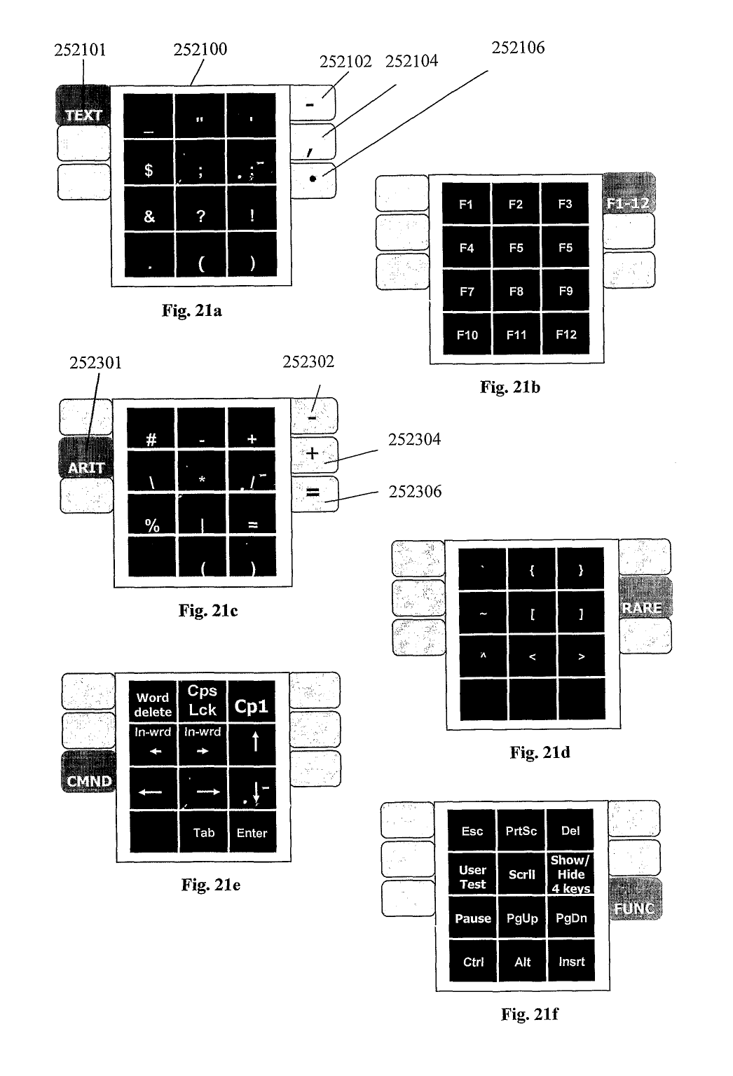

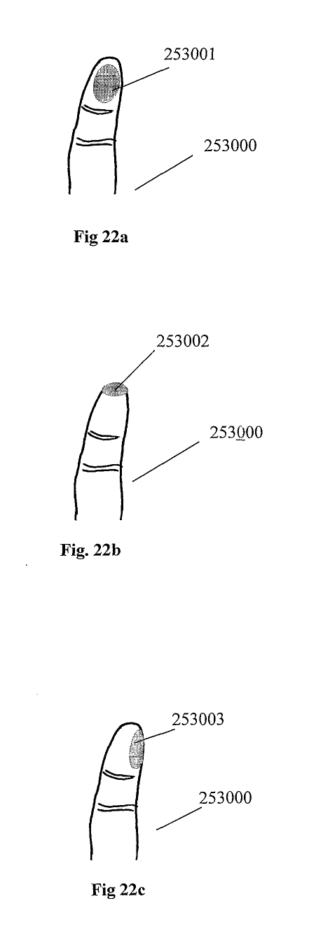

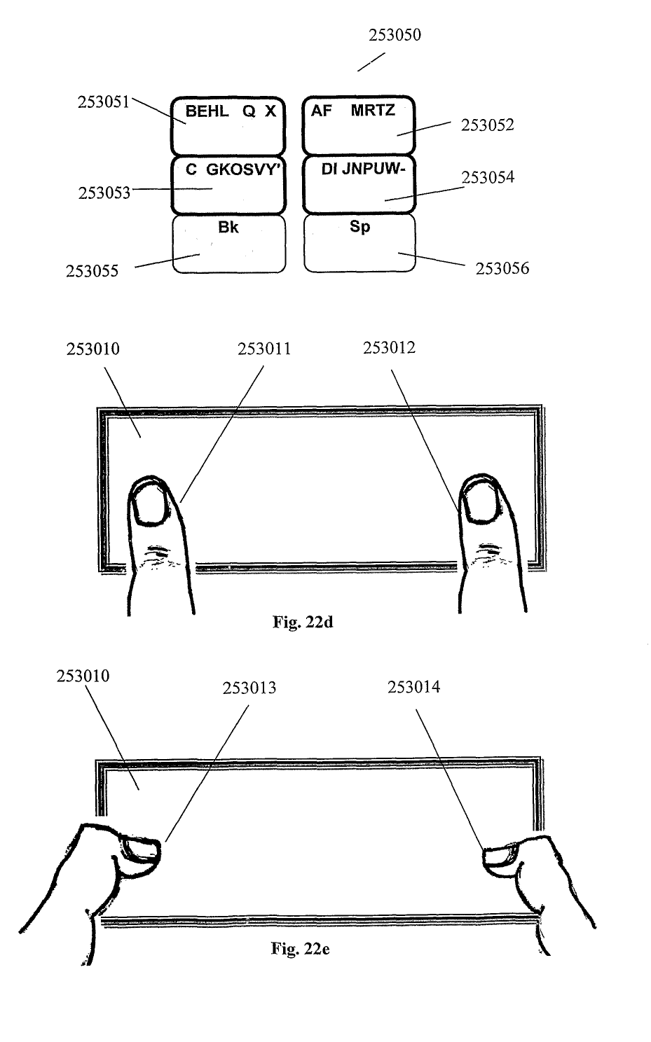

FIG. 21 shows as an example, a second keypad of the invention 252000 corresponding to the mode key/instance “TEXT” being shown on the touch screen of a device after the key 252041 of the first keypad was predefinely interacted/pressed (long pressing action, press-and-hold, double-pressing action, etc.). In this example, the center key may of the second keypad may predefinely being the key 252005. At this time, providing the gliding action 252021 on the touch-sensitive/touch-screen surface may correspond to the key symbol “_” shown on the corresponding key 252001. Also as example, the gliding action 252022 provided on the touch-sensitive surface may correspond to the symbol shown on the corresponding key 252002. Also as example, a tapping action provided on the touch-sensitive surface may correspond to the symbol shown on the center key 252005. For the other keys such as the keys located on the bottom row of the second keypad another type of interaction such as a long gliding action or double-gliding action departing from the center (key) in each of their direction may be considered. For example, the double-gliding actions 252030 to 252032 corresponds to (the characters on) the keys 252010 to 252012, respectively.

With continuous description of the current embodiment, according to one method, short gliding actions duplicating departing from the center key in the direction of the keys around/closed to/neighboring the predefined center key (in this example the key 252005) may correspond to said keys, and long gliding actions departing from the center key in the direction of the farer keys located after said closed keys may correspond to said farer keys. For example, as shown in FIG. 21, the long gliding actions 252050 to 252052 may replace the double-gliding actions 252030 to 252032, respectively. It must be noted that the longer gliding actions may be provided in the direction of the neighboring keys (e.g. in this example, in the direction of the keys 252007 to 252009) but because the trajectory of each of the gliding actions 252050 to 252052 is long the system relates them to the keys 252010 to 252012, respectively. Obviously, the second keypad may have some more keys for example after each side such as the left, right, and top, of it, wherein said keys being interacted through the long gliding actions on the direction of said keys.

FIGS. 21a-21f show the exemplary second keypad of the invention 252100 showing exemplary symbols corresponding to the exemplary modes of the data entry system of the invention. In addition to the keys of the second keypad, some of the (preferably, the frequently used) symbols of the group of symbols corresponding to a predefined mode may (predefinely) be assigned to some of the keys of the first keypad and being entered during the corresponding mode instance (e.g. hereafter referred as “shortcut”). In these examples, the keys of the first keypad of the invention are shown in two groups on two sides of the second keypad. After (the system) is being entered into the corresponding mode instance (e.g. by press-and-holding the key of the first keypad corresponding to said mode) each of said some characters may be entered by providing a pressing action on its corresponding key of the first keypad. As an example, in FIG. 21a, after entering into the “TEXT” mode/instance by providing the corresponding predefined interaction with the key 252101 of the first keypad, pressing the keys 252102, 252104, 252106 (also belonging to the first keypad) may correspond to the characters “-”, “,”, “.”, respectively. Also as an example, in FIG. 21c, after entering into the “ARITH” mode, by providing the corresponding predefined interaction with the key 252301, pressing the keys 252302, 252304, 252306, may correspond to the characters “+”, “−”, “=”, respectively. Obviously, in a “FUNC” (e.g. function) mode different functions may be assigned to said keys.

Obviously, the first keypad of the invention may have any number of keys. Therefore/and, the system may have any number of mode instances too, wherein preferably each predefined mode instance corresponds to a different predefined group of symbols. For example, another group of symbols may be consisting of the digits 0 to 9 which may be assigned to a (e.g. another) mode instance.

As mentioned, the letter key of the second keypad of the invention may use eight keys of said keypad duplicating the letter keys of a telephone-type keypad as is shown on the (partial) keypad 250000 of FIG. 19. As mentioned before, each of the different predefined gliding actions on the touch-sensitive surface may correspond to the corresponding (outside) keys of the keypad, and a tapping action on said touch-sensitive surface may correspond to the center key 250005.

According to one embodiment of the invention, if the user provides a pressing action on the touch-sensitive surface, the system may be designed to recognize by which portion of the user's finger said pressing action has been provided. In this case, according to one embodiment of the invention, the system may easily correspond the pressing action provided by the user's finger on the touch-sensitive surface to a corresponding key of the first keypad. FIGS. 22a-22c, show the front view of a user's left finger. For example, as shown in FIGS. 22a-22c:
if the user provides a pressing action with the flat portion of his finger 253000 on the touch-sensitive surface, the touching impact on said surface may be a large impact 253001. The system may relate said large impact to a first key of the first keypad
if the user provides a pressing action with the tip portion of his finger 253000 on the touch-sensitive surface the touching impact on said surface may be a small impact 253002, The system may relate said small impact to a second key of the first keypad
if the user provides a pressing action with the side portion of his finger 253000 on the touch-sensitive surface the touching impact on said surface may be a long narrowish impact 253003, The system may relate said long narrowish impact to a third key of the first keypad.

The above-mentioned method of duplicating the keys may be used with the data entry system of the invention to duplicate the keys of the first keypad by using a touch-sensitive surface such as the touch-screen of an electronic device.

According to one embodiment of the invention, providing each one of said different finger interactions (e.g. tip, flat, side, etc.) on a different zone/side on a touch sensitive surface may correspond to a different key. For example, the user may use a finger of his (left) hand to provide said tapping actions with the different predefined portions of said finger on the left side of a touch sensitive screen to duplicate the keys of the left portion of a split first keypad of the invention, and he may use a finger of his (right) hand to provide said tapping actions with the different predefined portions of said finger on the right side of the screen to duplicate the keys of the right portion of a split first keypad of the invention.

With reference to the above-mentioned embodiment, FIGS. 22d to 22e show as an example, an electronic device having a touch screen surface 253010. By referring to the keypad 253050 as a predefined virtual (model of the) first keypad of the invention, as an example:
if the user presses on the left side on the screen with the flat portion 253011 of his (left) finger, then the system may correspond said pressing action to the upper-left letter key 253051 of the virtual keypad 253050
if the user presses on the left side on the screen with the tip portion 253013 of his (left) finger, then the system may correspond said pressing action to the lower-left letter key 253053 of the virtual keypad 253050
if the user presses on the right side on the screen with the flat portion 253012 of his (right) finger, then the system may correspond said pressing action to the upper-right letter key 253052 of the virtual keypad 253050
if the user presses on the right side on the screen with the tip portion 253014 of his (right) finger, then the system may correspond said pressing action to the lower-right letter key 253054 of the virtual keypad 253050
if the user presses on the left side on the screen with the side portion of his (e.g. left) finger (not shown), then the system may correspond said pressing action to the lowest left key 253055 (e.g. “Bk” (BackSpace) key) of the virtual keypad 253050
if the user presses on the right side on the screen with the side portion of his (e.g. right) finger (not shown), then the system may correspond said pressing action to the lowest right key 253056 (e.g. “Sp” (Space) key) of the virtual keypad 253050.

If the touch-sensitive surface is used with the first and/or the second (virtual) keypad of the system, then obviously the tapping and/or gliding actions provided by the user may become ambiguous for the system. The system may not know if a tapping/gliding action provided by the user corresponds to the text entry of the invention or it is related to a mouse function. In order to avoid such ambiguity, various procedures may be considered by people skilled in the art. Some of them are described hereafter:

If the touch-sensitive surface used with the first and/or the second (virtual) keypad of the system is a touch sensitive surface such as a touch-screen surface that is also used for mouse functionalities, then obviously the tapping and/or gliding actions provided by the user may become ambiguous for the system. The system may not know if a tapping/gliding action provided by the user corresponds to the text entry of the invention or it is related to a mouse function. In order to avoid such ambiguity, various procedures may be considered by people skilled in the art. Some of them are described hereafter:

According to one procedure, a switching means such as providing a predefined pressing action on a key may switch the system from text entry mode to mouse-function mode (e.g. and/or vise versa).

According to another procedure, if the keys of the first keypad do not use the same surface of a touch sensitive surface such as the touch-screen that the mouse uses, then according to one method, the system is predefinely designed to know that during the entry of a word and/or during the mode instances of the data entry system of the invention the press and gliding actions provided by the user (e.g. preferably, anywhere on the touch-sensitive surface) correspond to the data entry procedures of the system (e.g. corresponds to the entry of said word and/or corresponds to the entry of symbols assigned to the mode instances, accordingly). For this reason, substantially all of special symbols (e.g. including the digits 0-9) may/should preferably be assigned to the mode instances of the system. Accordingly, when the user is not in the middle of entering a word, the system may correspond his gliding actions to corresponding mouse functions. Accordingly:
If the first keypad does not use any portion of the touch sensitive surface (e.g. if it has hard keys), then during the entry of a word taping actions provided anywhere on the touch sensitive surface may be related to the data entry system of the invention, and taping actions anywhere on the touch sensitive surface which are not provided during the entry of a word may be related to mouse functionalities.
If the first keypad does use a portion of the touch sensitive surface (e.g. if it has soft keys), then during the entry of a word, taping actions provided outside the zones used by the first keypad on the touch sensitive surface may be related to the data entry of the system, and tapping actions not provides during the entry of a word outside said zones may be related to the mouse functionalities.

If the first keypad uses the touch sensitive surface and is designed to be interacted by taping and/or gliding actions on its keys, then according to one method, at least the beginning of the gliding actions relating to the mouse and/or to the second keypad key interactions, may be provided outside the zones occupied by the keys of the first keypad.

According to another procedure, quick gliding/taping actions correspond to the text entry of the system and slow motion gliding/tapping actions correspond to the mouse functions (or vise versus). Etc.

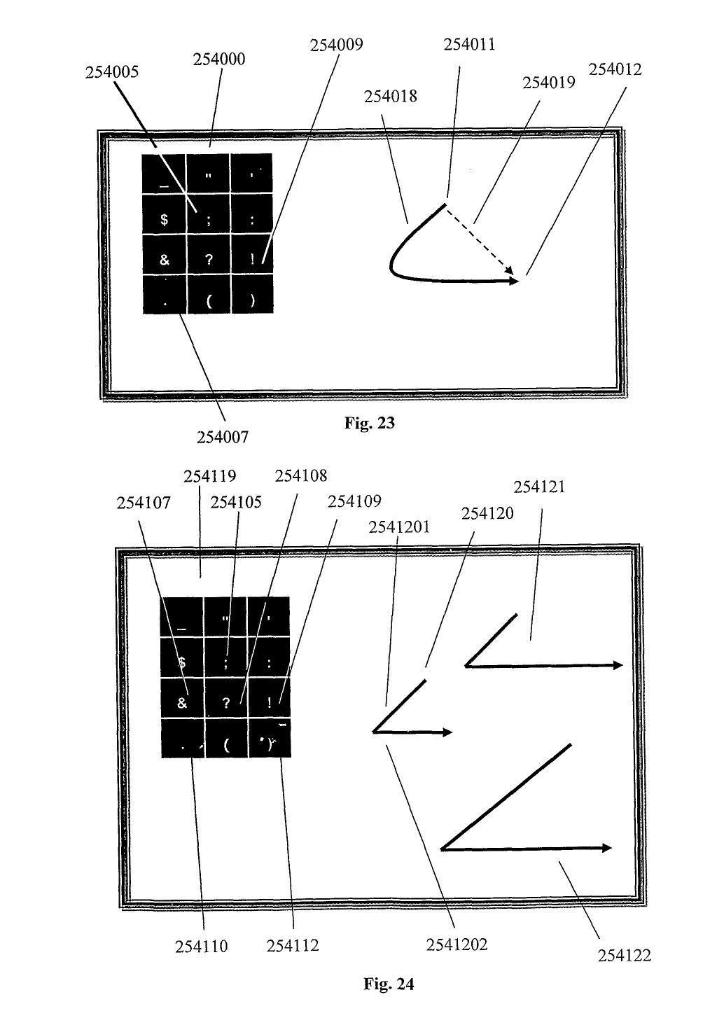

It must noted that although the gliding action on a touch sensitive surface duplicating a gliding action departing from one (e.g. center) key towards another key is shown as being straight (a straight line), according to one embodiment of the invention it may have a different form of trajectory (e.g. being curved, zigzagged, etc.) as long as a virtual straight trajectory departing from the beginning point of said different-formed trajectory and its ending point duplicates a straight gliding action departing from said one key towards said another key. This can be beneficial in some circumstances. For example, many times during providing a gliding action corresponding to a desired key of the second keypad the user may notice that he is erroneously gliding towards a non-desired key. In this case instead of re-providing a new gliding action with a correct straight trajectory the user may change the direction of his current gliding action and glide towards the desired key and end said gliding action at a point/location such that the beginning and ending points of his gliding action could have been the beginning point and the ending point of a straight gliding action duplicating a straight gliding action departing from said one (e.g. the center) key towards said another (e.g. the desired) key. FIG. 23 shows as an example, a second keypad of the invention 254000 shown by the system on the screen of a device after the system being entered into the “TEXT” mode. In this example, the user desires to enter the special character “!”. In this example, at the beginning the user provides an erroneous trajectory (as is shown at the beginning portion of the/his gliding trajectory 254018) duplicating a straight trajectory departing from the key 254005 towards the key 254007. At one point the user may notice the error and may change the trajectory of his gliding action without removing his finger/stylus from the screen and glides on the sensitive surface as if he was duplicating gliding action from the corresponding point on the virtual keypad towards the virtual desired key 254009 of the virtual keypad 254000. The user ends the gliding action at a point/location on the screen such that a straight line (e.g. trajectory) 254019 departing from the beginning point 254011 and the ending point 254012 of the (curved) trajectory 254018 duplicates a straight gliding action departing from the key 254005 towards the key 254009 of the virtual keypad 254000.

According to a different embodiment of the invention, a compound gliding action corresponding to multiple keys (of the virtual second keypad) may be provided by the user and being predefinely interpreted differently from the previous embodiment by the system. In this embodiment, the first gliding action may duplicate a gliding action departing from a predefined key of the virtual second keypad towards another desired key of said keypad. According to one method, each of the next gliding actions may duplicate departing from the current desired key of the second keypad towards the next desired key of said keypad. FIG. 24 shows as an example, an exemplary virtual second keypad of the invention 254119 shown after the user has entered into the “TEXT” mode. Hereafter three examples of the compound gliding actions according to the current embodiment have been explained:
according to a first example the user may provide the compound gliding action 254120 consisting of two consecutive short gliding actions without removing the finger/pen from the screen. According to this embodiment the first portion 2541201 of the compound gliding action 254120 corresponds to departing from the key 254105 towards the key 254107. The second portion 2541202 of the compound gliding action corresponds to departing from the key 254107 towards the key 254108.
according to a second example the user may provide the compound gliding action 254121 consisting of two consecutive short and long gliding actions without removing the finger/pen from the screen. According to this embodiment the first portion of the compound gliding action 254121 corresponds to departing from the key 254105 towards the key 254107. The second portion of the compound gliding action 254121 corresponds to departing from the key 254107 towards the key 254109 (farer than the key 254108 relating to the key 254107).
according to a third example the user may provide the compound gliding action 254122 consisting of two consecutive long gliding actions without removing the finger/pen from the screen. According to this embodiment the first portion of the compound gliding action 254122 corresponds to departing from the key 254105 towards the key 254110. The second portion of the compound gliding action corresponds to departing from the key 254110 towards the key 254112.

The compound gliding action system described in this patent application is being designed and explained to show the principles of using a compound gliding action with the data entry system of the invention. Obviously, different compound gliding action systems may be designed by people skilled in the art. They can be used with the data entry and correction system of the invention.

As mentioned before, the data entry system of the invention using the gliding action with the second keypad of the invention can be totally an eye-free data entry system. This may greatly ease the data entry in several environments. For example, blind people can use it to rapidly enter text. Also for example, the system may be integrated within a car.

During the entry of a word, in order to eliminate the need of interacting by eye with the screen of the corresponding device, a text-to-speech system may speak the proposed word/character (to the user).

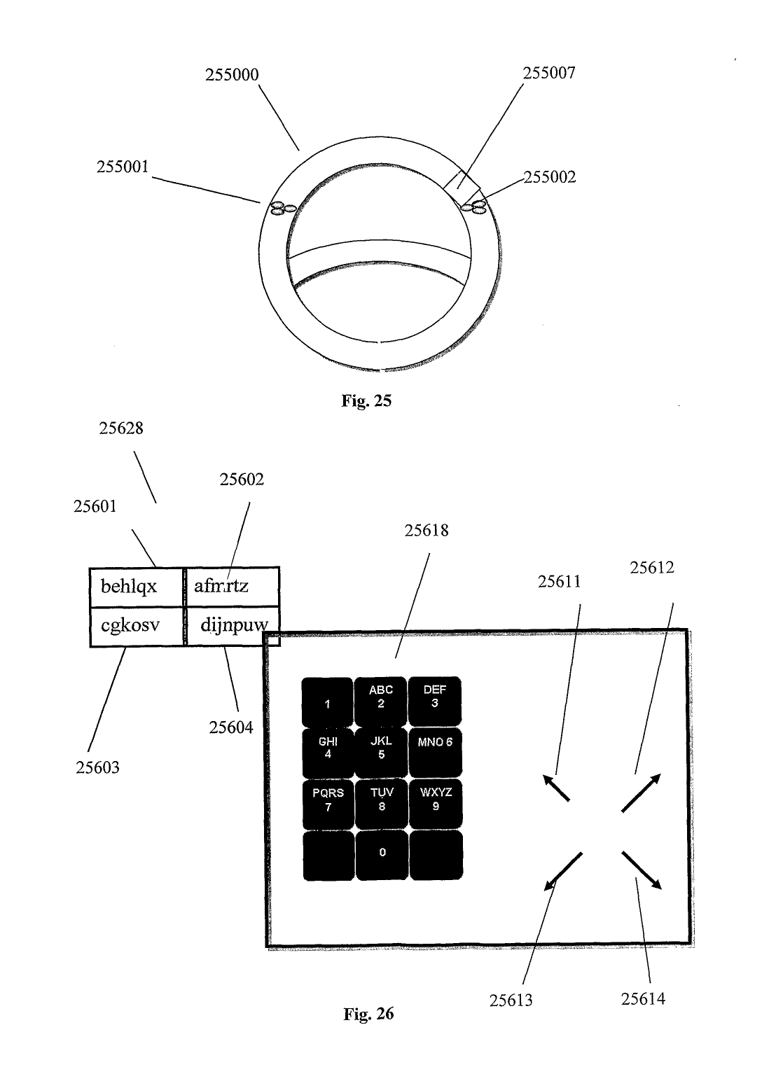

According to one example, the (e.g. hard, soft) keys of the first keypad and touch-screen/touch-pad corresponding to the second keypad of the invention may be integrated within a location such as within the steering wheel of a car. The user may enter text or dial numbers rapidly, without looking at the input or even the output interface. FIG. 25 shows as an example, a car's steering wheel 255000 having the split keys 255001, 255002 of the first keypad of the invention and also having a touch-sensitive surface 255007 for providing the gliding/tapping actions corresponding to the second keypad of the invention. Said data entry system may also include said text-to-speech system so that the driver's eyes can focus only on the road.

Different methods of calibration of the dynamic first keypad of the invention may be considered by people skilled in the art. According to one embodiment of the invention, when the user begins to type on the touch-sensitive surface (e.g. touch screen) of the device through the dynamic keys of the first keypad, his first pressing action provided on the right side of the screen may predefinely be considered by the system as being related to the a predefined key such as the upper-right (e.g. or predefinely lower-right) key of a predefined virtual first keypad model. Alternatively, his first pressing action provided on the left side of the screen may predefinely be considered by the system as being related to the upper-left (e.g. or predefinely lower-left) side key of said keypad model. Based any of said pressing action the system may dynamically define the other keys of the first keypad. If the predefined key is not the one that the user intends to press then the user may press the BackSpace key of the dynamic keypad defined by the system and proceed to entering the text through said dynamic keypad.

According to one embodiment of the invention, if the second keypad is shown on the screen, the user may either press the keys of said on-screen keypad or he may provide the corresponding gliding actions anywhere on the screen.

It must be noted that although the gliding action duplicating a pressing action on a desired key (e.g. of the second keypad) was described to have a trajectory departing from a predefined location such as a first key (of the second keypad) towards said desired key, obviously, for the same purpose said gliding action may be provided in the opposite trajectory/direction (departing from the desired key towards said predefined location). For example, in the example of FIG. 20 the gliding actions 251109 corresponding to each of the corresponds keys of the telephone-type keypad may predefinely be considered to be provided in opposite direction (departing from the outside keys of the telephone-type towards its center key 251105). Also as an example, the gliding actions shown in other figures such as the fig. FIG. 12c may also be designed to be provided in opposite direction relating to directions shown in the said figure for the same purpose.

As demonstrated, the first keypad of the invention has generally less (letter) keys (e.g. four letter keys) than a second keypad (e.g. a telephone type keypad having eight keys). Alternatively, according to one embodiment of the invention, the first keypad may have more keys that the second keypad. For example, the first keypad may be a telephone-type keypad and the second keypad may be a keypad having few letter keys such as four keys. The first keypad is preferably used to enter the first input information corresponding to the desired word, and the second keypad may be used for the correction procedure of the invention, as long as a pair of a key of the first keypad and a key of the second keypad have at most one character/letter in common. Using this embodiment for entering text may be slower but it may permit the current users of predictive data entry systems using a telephone-type keypad such as T9, to enter text as they are used to, and correct the undesired word by using the second keypad Obviously, after getting used to letter configuration/assignment of the keys of the second keypad (e.g. in this example, the four letter keys), the user may inverse the keypads and use the system according to the preferred embodiments (e.g. using four letter keys to enter the first input information and using a the telephone-type keypad for correction procedure). This may permit a gradually user adaptation towards an optimal use of the data entry system of the invention. A mode key may be used for switching/inversing said keypads and their usage. As an example, as shown in FIG. 26, the first keypad of the system for entering the first input information may for example be a telephone keypad 25618 and the second keypad (e.g. for at least the correction procedure) of the system may for example be a (e.g. virtual/imaginary) keypad 25628 having four letter keys. In this example, for example, each of four different gliding actions 25611-25614 provided on a touch sensitive surface may predefinely correspond to one of said four keys 25601-25604 of the keypad 25628, respectively.

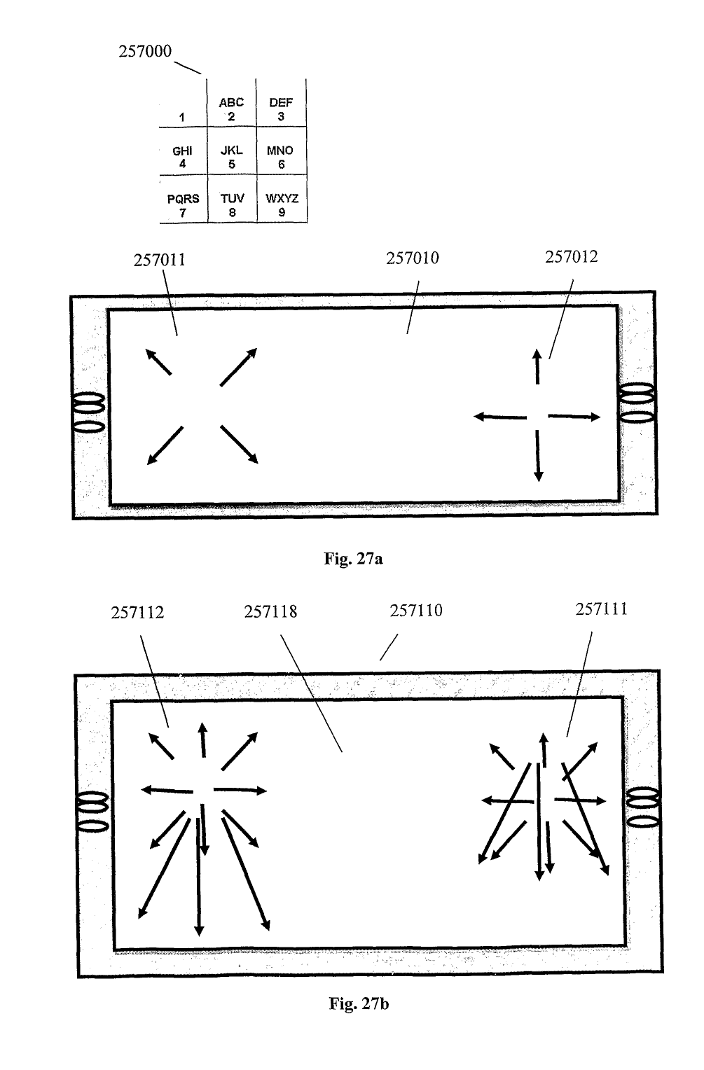

According of one embodiment to the invention, a group of predefined gliding actions on a first predefined zone of the touch sensitive surface (e.g. the gliding/taping actions on the right side of the touch sensitive surface) may be predefined to duplicate interacting with such as pressing on some of the keys of the (e.g. virtual) second keypad, and (at least) another group of predefined gliding actions on (at least) a second predefined zone of the touch sensitive surface (e.g. the gliding/taping actions on the left side of the touch sensitive surface) may duplicate interacting with some other keys of the second keypad. FIG. 27a shows as an example, a second keypad 257000 of the invention in this example corresponding to the correction procedure of the invention wherein interacting with some of its keys (e.g. here referred by their numeric symbols, 2, 4, 6, 8) are duplicated by the corresponding (e.g. horizontal and vertical) gliding actions 257012 provided on the right side of the touch-screen of the device 257010. FIG. 27a also shows as an example, some other keys (e.g. here referred by their numeric symbols, 1, 3, 7, 9) of the second keypad of the invention wherein interacting with said keys are duplicated by (e.g. diagonal) gliding actions 257011 provided on the left side of the touch-screen surface of the device 257010. Also as an example, a tapping action on (any side of) said surface may correspond to interacting with the center key (e.g. numeric key, 5) of the second keypad.

According of one embodiment to the invention, a group of predefined gliding/taping actions on a first predefined zone of the touch sensitive surface (e.g. the gliding/taping actions on the right side of the touch sensitive surface) may be predefined to correspond to interacting with the keys of the second keypad corresponding to a first group of symbols (e.g. the letters) and a group of predefined gliding/taping actions on a second predefined zone of the touch sensitive surface (e.g. the gliding/taping actions on the left side of the touch sensitive surface) may be predefined to correspond to interacting with the keys of another second keypad corresponding a second group of symbols, and so on.

FIG. 27b shows an example, wherein the gliding actions 257111 provided on the right side of the touch screen 257118 of the device 257110, that in this example may correspond to interacting with the keys of a first (virtual) second keypad including a first group of symbols such as the “TEXT” symbols such as shown previously in this application, and wherein the gliding actions 257112 provided on the left side of the screen 257118 of the device 257110, may correspond to interacting with the keys of a an additional (virtual) second keypad including a second group of symbols such as the “PUNC” symbols as shown previously.

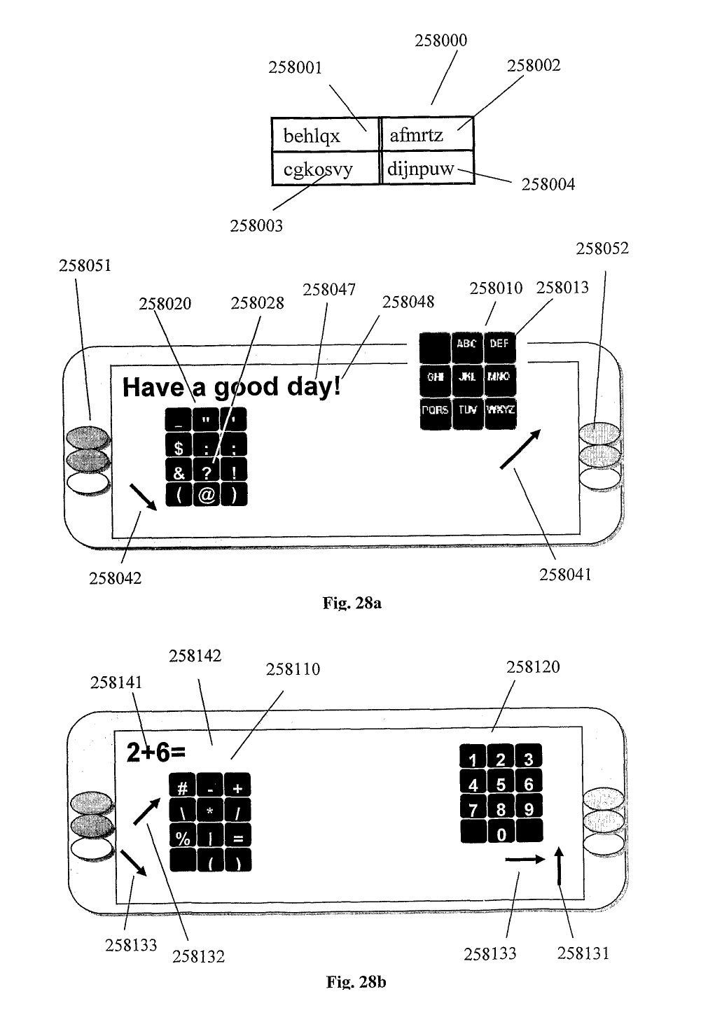

With continuous description of the current embodiment, FIGS. 28a and 28b, show some examples of the benefits of (predefined) gliding actions provided on different (predefined) zones of a touch sensitive surface. In the example of FIG. 28a, after the user presses the keys of the first keypad (e.g. in this example having two portions 258051 and 258052 wherein the darker keys are letter keys that have substantially the same letter arrangement of the four keys 258001 to 258004 of the keypad 258000) corresponding to the word “day” the system preferably proposes the word “was” (not shown) which is an undesired word. The user may proceed to the correction procedure of the invention by using the right side of the touch-screen surface of the device wherein the gliding actions on said side predefinely duplicate/correspond to interacting with the letter keys of a second (e.g. virtual) keypad (e.g. in this example a virtual telephone-type keypad 258010 which in this example is not shown on the screen of the device) and provides a gliding action 258041 that corresponds to interacting with the key 258013 of said second keypad. The system proposes the word “day” 258047. In this example, he user then uses the left side of the touch-screen of the device wherein a predefined gliding actions on said side predefinely duplicates/relates to interacting with the keys of anther second keypad 258020 of the invention that corresponds/represents the symbols of the “TEXT” group (e.g. shown/described before), and provides a gliding action 258042 on said surface to duplicate interacting with the key 258028 that represents the special character “!”. The system provides said character 258047 at the end of the word day.

With continuous description of the current embodiment, FIG. 28b shows the data entry system of the invention having two on-screen second keypads wherein a first second keypad 258120 (on the right side) corresponds to the digit group (e.g. “NUMB” group) and an additional second keypad 258110 (on the left side) corresponds to the arithmetic characters (e.g. “ARITH” group). For example, the user may enter some numeric formulas by using gliding actions on the left and right side of the screen. in this example, by providing the gliding actions 258131, 258132, 258133, 258134, provided on respective sides of the device, the user has quickly entered an arithmetic calculation 258141 on the screen 258142.

It must be noted that after entering into a mode instance, the system may be designed such that to stay within said mode until the user provides a predefined interaction that causes the system to exit from said mode. Accordingly, during a mode instance, the user may enter several (e.g. consecutive) symbols relating to said mode instance. According to one method, (e.g. then) if the user provides a quick pressing action (e.g. a tapping action) on a letter key of the first keypad without pressing (and-holding) another key, then the system exits from the/said mode instance and may consider said tapping action as being related to entering an ambiguous letter of said key (e.g. entering at least part of the first input information corresponding to a word). Also, tapping on another key such as the “space” key may also exit the system from the mode instance and enter a “space” character.

As an example, if the system displays on the screen an active second keypad of the invention to which the symbols of a corresponding pressed mode key is assigned, consecutive pressing actions on the keys of said on-screen keypad may be permitted to enter several symbols. The system may remove said keys from the screen after the user for example, presses a key other than the on-screen keys corresponding to the pressed mode key. According to another example, if the second keypad of the invention is a predefined virtual/imaginary keypad model, then, after a mode key is pressed, the user may provide one or more tapping or gliding actions corresponding to interacting with the keys of said virtual keypad model to which his desired symbols within said mode instance are assigned to enter said one or more symbols. According to these examples, to enter a telephone number using the data entry system of the invention, after the user enters the system into the “NUMB” mode, he may either press the consecutively the number keys (e.g. of a telephone-type keypad) displayed on the screen or he may provide tapping/gliding actions corresponding to interacting with the keys a virtual second keypad model of the invention, respectively.

It must be noted that according to one method, the user can define which of the zones/sides of the touch-sensitive surface corresponds to which one of the second keypads. For this purpose a means such as a corresponding predefined pressing action on a predefined key may be used for providing corresponding second keypad or for providing a combination of said second keypads (relating to a zone of the screen or printing it/them on the screen). According to another method, the system may automatically/dynamically assign at least one of the zones to one of the second keypads. For example, if the user is in the middle of entering a word, the system may assign the right (or left) side of a (touch) sensitive surface to the second keypad of the invention representing letters used for the correction procedure of the invention.

According to a preferred embodiment of the invention, the words of the database of the system may include any symbol such as letters, numbers/digits, punctuation characters, etc. Obviously, in many cases such as when the first keypad of the invention has only few keys such as four keys, one second keypad of the invention may not be enough to include all of said ambiguous symbols/characters such that, preferably, any ambiguous key of the first keypad and any ambiguous key of the second keypad have at most one common symbol/character. For example, if the first keypad of the invention has four ambiguous keys only and the words of the database of the system include substantially any of the characters available on a PC keyboard then having at least an additional (e.g. at least one more) second keypad may become necessary. This is because each key of the first keypad may, preferably, include at most a number of characters which does not exceed the number of keys of the second keypad or vise-versus.

Using a device having a touch-sensitive surface wherein tapping/gliding actions on a first side of said touch-sensitive surface corresponds to interacting with a first second keypad of the invention, and tapping/gliding actions on at least a second side of said touch-sensitive surface corresponds to interacting with at least an additional second keypad of the invention may permit the entry of any word having any (type of) character.

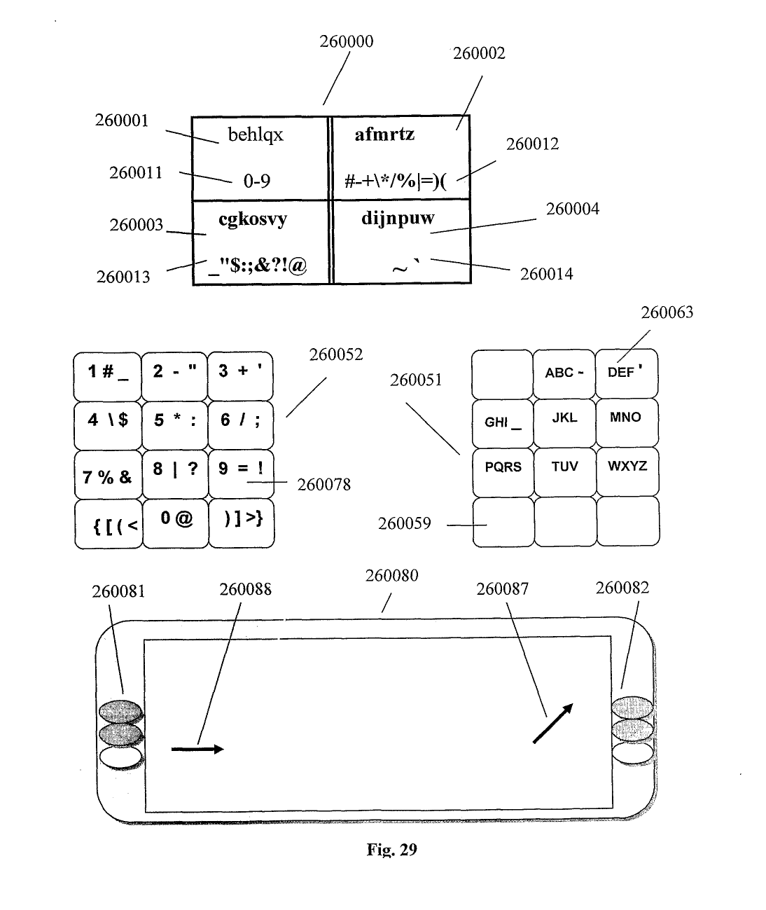

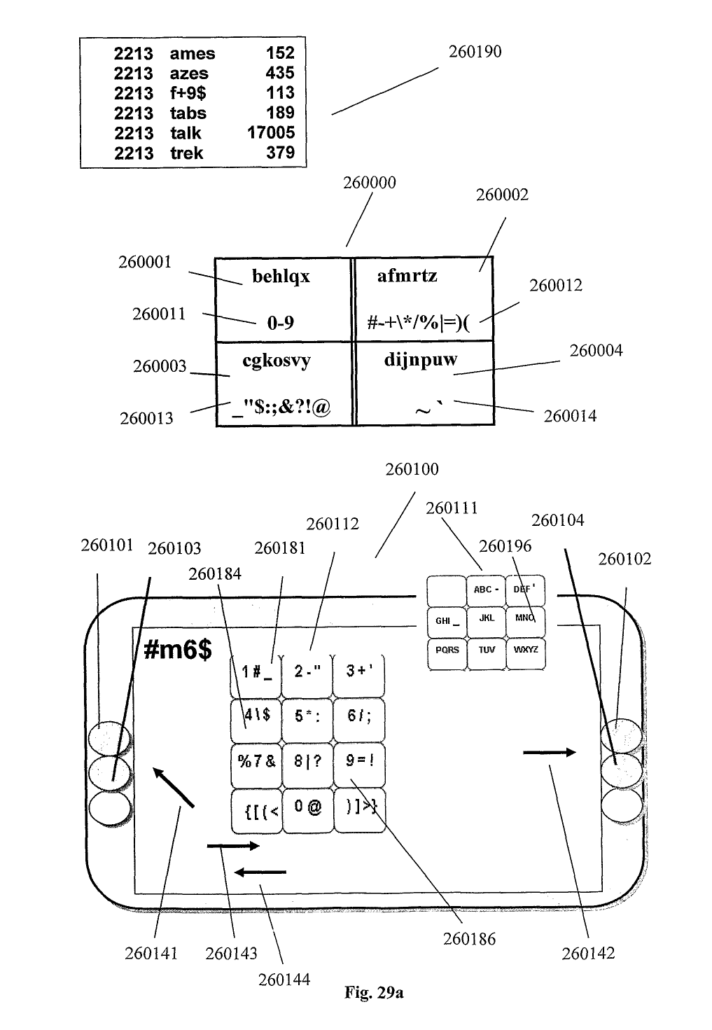

FIG. 29 shows as an example, a first (virtual) keypad of the invention 260000 having four ambiguous keys 260001-260004 as shown in many embodiments before. In this example, in addition to letters each key includes other ambiguous characters. For example, key 260001 includes the digits 0 to 9 (e.g. the “NUMB” group of characters 260011), key 260002 includes the arithmetic characters 260012 (e.g. the “ARITH” group of characters), key 260003 includes the text punctuation characters 260013 (e.g. the “TEXT” group of characters), and key 260004 includes the rare characters 260014 (e.g. the “RARE” group of characters). Preferably, the characters available on the keys of the first keypad are also distributed on the keys of two second keypads 260052, 260051, such that any pair of keys consisting of an ambiguous key of the first keypad and an ambiguous key of any of the second keypads, have at most one common character. In this example, in addition to the first keypad of the invention (e.g. split into two portions 260081, 260082 wherein its four ambiguous keys duplicate the ambiguous keys 260001-260004 of the virtual keypad 260000), the device also includes the two (e.g. virtual) second keypads 260051 and 260052 (e.g. which may be considered as two second keypad models). In this example, predefined tapping/gliding actions (e.g. 260087) on the right side of the touch screen of the device 260080 may correspond to interacting with the keys of the second keypad 260051 (e.g. the first second keypad), and predefined tapping/gliding actions (e.g. 260088) on the left side of the touch screen of the device 260080 may correspond to interacting with the keys of the second keypad 260052 (e.g. the additional/second second keypad).

As an example of the above mentioned embodiment, FIG. 29a shows a device 260100 having the data entry system of the invention that includes a (split) first keypad of the invention as shown before, wherein four of its keys 260101-260104 duplicate the four ambiguous keys 260001-260004 of the keypad model 260000. The system also includes two (e.g. virtual) second keypads 260111 and 260112, wherein in this example the first second keypad 260111 mostly includes the letters of the alphabet and the second (e.g. additional) second keypad 260112 includes many of the special symbols distributed on its keys as described above. By considering the portion 260190 of the database of the system, according to a first example, in order to enter the word “f+9$” that is included within the dictionary database, the user may first press the corresponding keys 260102, 260102, 260101, 260103, of the first keypad corresponding to the characters of the desired word. The system may propose the word “talk” corresponding to said pressing actions and having the highest priority. The user may provide a gliding action (not shown) on the right side of the screen to duplicate interacting with the key of the second keypad that corresponds to the first character (e.g. “f”) of the desired word. In this example, the only word that corresponds to said combined information is the word “f+9$”. The system proposes said word.

With continuous description of the embodiment, according to a second example, in order to enter the word “#m6$” which does not exist in the dictionary, the user may first press the corresponding keys 260102, 260102, 260101, 260103, of the first keypad corresponding to the characters of the desired word. The system may propose the word “talk” corresponding to said pressing actions and having the highest probability. At this time the user begins to reenter said word through the keys of the second keypads. For this purpose, the user:
first provides a gliding action 260141 on the left side of the screen that corresponds to interacting with the key 260181 of the corresponding second keypad 260112. The only common character between the key of the 260102 and the key 260181 is the character “#”. The system enters said precise character.
the user then provides a gliding action 260142 on the right side of the screen that corresponds to interacting with the key 260196 of the corresponding second keypad 260111. The only common character between the key of the 260102 and the key 160181 is the character “m”. The system enters said precise character.
the user then provides a gliding action 260143 on the left side of the screen that corresponds to interacting with the key 260186 of the corresponding second keypad 260112. The only common character between the key of the 260102 and the key 160181 is the character “6”. The system enters said precise character.
the user then provides a gliding action 260144 on the left side of the screen that corresponds to interacting with the key 260184 of the corresponding second keypad 260112. The only common character between the key of the 260102 and the key 160181 is the character “$”. The system enters said precise character.

The desired word is being displayed on the screen and preferably added to the word database of the system so that next time that the user desired to enter said word, it can be entered faster.

By including substantially all of the characters available at least on keyboards within the first and several second keypads of the invention based on principles as described, the user may be able to enter a rich text such as formulas, URLs, computer programming languages, slings, etc., in a very fast manner. For example, after entering a URL and adding it to the word database of the system, each time the user desires to re-write said URL he can enter it very quickly mostly by using the first keypad of the invention alone (URLs are long word, therefore they may be unique choice for the sequence of the pressing actions provided through the first keypad). In addition, a word completion system may be used with the system so that many of (such type of) the words may be entered during providing the key presses through the first keypad.

Preferably, the group of ambiguous special character assigned to a key is (substantially) the same as the group of the special characters/symbols of the mode instance assigned to a said key. Therefore, the user may easily remember the location of said groups of characters. It must be noted that instead of printing the ambiguous special characters on the keys of the first keypad the name (e.g. TEXT, NUM, ARITH) of the corresponding groups may be printed on said keys.

The embodiments just described and shown through FIGS. 29-29a, may also be applied to devices without touch sensitive surface (e.g. a low-end mobile phones), that have a first and second keypad having hard keys. According to one embodiment, all of the symbols including letters, digits 0-9, and special characters may ambiguously be assigned to keys of the first keypad of such device as described in detail in said embodiments. The second keypad of such device may have two instances. According to one method, preferably, the first instance is by default proposed to the user without requiring interacting-with/pressing-on a modifier/shift key and in order to enter into the second instance the system requires interacting-with/pressing-on a modifier/shift key. According to another method, a switching means such as a modifier/shift key may be used to switch said second keypad between the two instances. Accordingly, the same said all of the symbols may also be distributively (e.g. and at least mostly ambiguously) assigned to the keys of the second keypad within the two instances. Preferably, the letters may be assigned to the keys of the second keypad in the first instance, and the special characters including digit 0-9 may be assigned to said keys in the second instance. The rest of this embodiment may resemble those described in the embodiments just described above and shown through FIGS. 29-29a.

It must be noted that instead of or in addition to using the sides of a touch sensitive surface for duplicating more than one second keypad of the invention, the device may have at least one touch pad on each side of its body for the same purpose. For example, gliding on each of the touch pads 227011, 227012, of the device 227000 of FIG. 14a may be related to the second keypad of the invention in a different mode. According one method, said touch pads may duplicate the first second keypad and the second/additional second keypad of the invention.

Optionally, the second keypad corresponding to a first side and the second keypad corresponding to a second side on the device may have different number of keys may be arranged in different form factor.

It must be noted that if needed the system may have any number of second keypad of the invention. The system may also use any type of interactions to duplicate the interactions with, such as pressing actions on, the keys of the second (e.g. and the first) keypad(s). For example, a long gliding action corresponding to a key may be duplicated by a long-time pressing action on the screen, and vise versa.

During the correction procedure of a word, it may happen that the user provides an erroneous key press or gliding action relating-to/on a (non-desired) key of the second keypad and the system may propose an undesired precise letter (e.g. and obviously may propose an undesired word) (e.g. and may automatically proceed to selecting the next ambiguous character of the word). A method of navigating/selecting between the letters of a word has been described before. According to another (e.g. a simplified) method, during correcting a proposed word (e.g. after one or more precise letter is/are entered), a predefined interaction such as a gliding or a pressing action provided on, or corresponding to interacting with a key of a second keypad wherein said key is preferably is not related to the correcting a word may cause the system to preferably, predefinely, select the last corrected character/letter within said word so that the user can re-correct said character (obviously, this may cause the system to also propose another word).

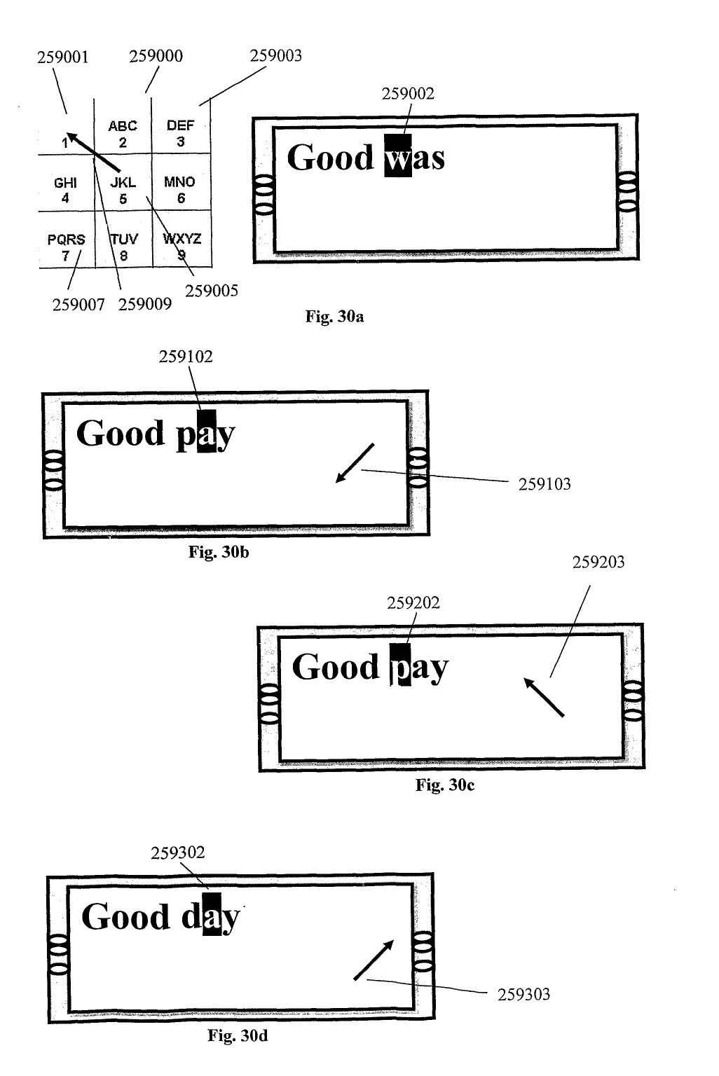

As an example, if said second keypad is partial telephone-type keypad such as the keypad 259000 of FIG. 30a, according to one method, a gliding action 259009 duplicating a (e.g. virtual) gliding action departing from the center key 259005 of the second keypad 225000 towards the key 259001 that according to one letter arrangement method has no letters on it informs the system to reselect another character of said word (e.g. preferably reselect the last selected and corrected character of the proposed word). Alternatively, if the second keypad resembles to the keypad 225100 of FIG. 12b, a tapping action (anywhere) on the touch-sensitive surface of the device may be used for the same purpose.

With continuous description of the current embodiment, as an example, by considering the portion 226009 of the exemplary database of words of the system shown in FIG. 13a and the exemplary second keypad of the invention 259000, as shows in FIG. 30a by using the first keypad of the invention, if the user desires to enter the word “day” he types said word through the first keypad, the system may propose another word corresponding to said typing action and that has the highest priority which in this example is the word “was” (and automatically selects the first ambiguous character 259002 of said word). At this time as shown in FIG. 30b, the user may proceed to the correction procedure of the invention so that to provide an interaction such as a gliding action corresponding to pressing the key of the second keypad that corresponds to the letter “d” but erroneously provides a gliding action 259103 that corresponds to another key 259007 of the keypad 259000. Based on the combined information, the system may propose a non-desired word which in this example is the word “pay” (and automatically selects the next ambiguous character 259102 of the word). As shown in FIG. 30c, at this time the user may notice his error and may provide a gliding action 259203 corresponding to interacting with the key 259001 of the virtual keypad 259000 which indicates to the system to select the previous selected/corrected character 259202. As shown in FIG. 30d, the user now may provide the required gliding action 259303 corresponding to interacting with the key 259003 that includes the letter “d”. The system provides the desired word “day” and automatically selects the next ambiguous character 259302 of the proposed word). it must be noted that instead of or in addition to the gliding action towards the key 259001 the system may be designed to receive another type of input information such as a predefined key interaction for the same purpose.

It is also noted that instead of providing gliding/pressing actions on any portion of the screen corresponding to the second keypad(s), the system may show the corresponding keypad(s) on the screen and the user may press on the keys of said keypad(s).

According to one embodiment of the invention, an interaction with one or more keys of the first and/or the second keypads of the invention may be provided by providing a gliding action on said keys. For example by considering the keypad 260000 of FIG. 30, a gliding action departing from on the key 260001 and ending on the key 260002 may duplicate providing pressing action provided (consecutively) on each of said keys. According of one method even an interaction with one key may be providing through a gliding action on said key. Gliding actions on the keys (e.g. soft keys such as keys provided on touch sensitive surfaces, dynamic keys as described in this and previous patent applications field by this inventor, etc.) may be used with the embodiments and methods of the entry system of the invention to duplicate other interactions such to pressing action provided (on the keys) in such embodiments.

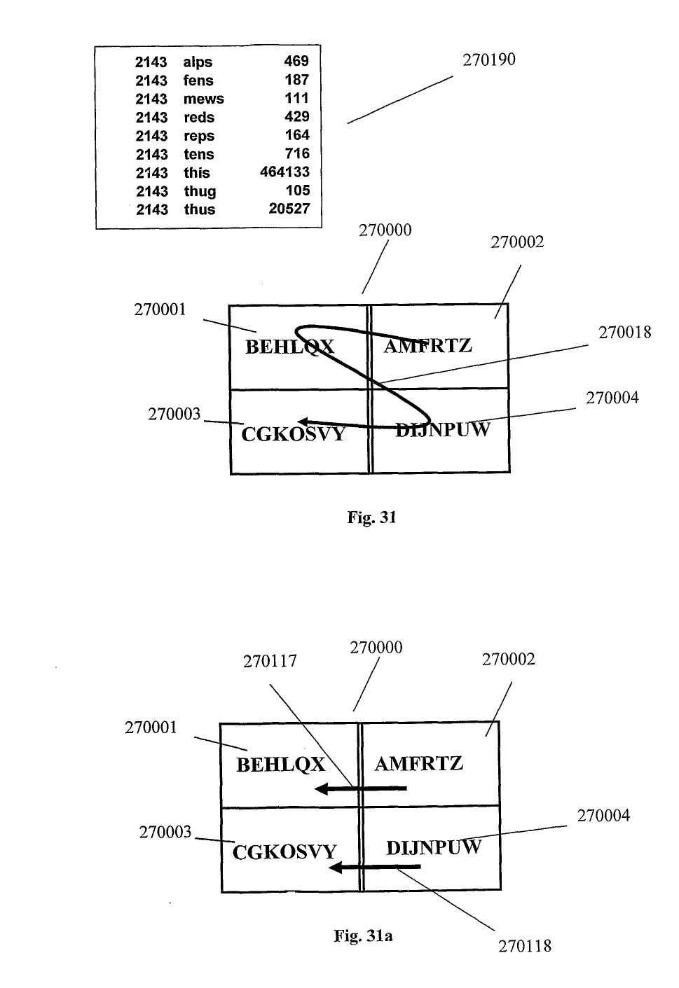

For example, by considering the FIG. 31, a touch sensitive 270000 is shown that duplicates the keypad (model) 260000 of FIG. 30a. FIG. 31, also shows as an example a portion 270190 of the word database of the system. In order to enter the word “this” the user may provide a gliding action of the corresponding keys of the first keypad of the invention 270000. Based on the (e.g. approximate shape of the) trajectory 270018 of such gliding action which is this example began on the key 270002, continued on the keys 270001, 270004, and ended on the key 270003, the system may propose the word “this” corresponding to the keys being interacted and having the highest priority. In this example, at the end of the entry of the word the user may lift his finger (or the stylus) from the sensitive surface and preferably the system may enter automatically a space character.

According to another embodiment of the invention, instead of a providing a single gliding action for entering a word several gliding action (e.g. the user lifts his finger from the surface after each gliding action) corresponding to different (consecutive) portions of said word may be provided. FIG. 31a shows as an example two gliding actions provided for the entry of the word “this”. The user first provides the gliding action 270117 departing from the key 270002 and ending on the key 270001. He then removes his finger/stylus from the touch sensitive surface and provides another gliding action 270118 departing from the key 270004 and ending on the key 270003. He then removes his finger/stylus from the touch sensitive surface the user then provides an end-of-the-word signal such as a space character. The system understands that the interaction with the keys corresponding to the entry of the word through the first keypad of the invention is ended. The system may consider said keys being interacted by said trajectories and may compare them with the key presses corresponding to the words of the dictionary database available with the system. If there is one matched word, then the system inputs/outputs said word. If there are more than one words, then the system may, for example, either select the most frequently used word and provides the corresponding word “this”, or optionally, it may present the corresponding words to the user so that the user selects one of them. As mentioned, the disambiguation methods and the procedure of selections of a word when there are more than one words corresponding to interacted keys, are known by the people.

It must be noted that the user even may combine tapping actions and gliding actions to entering a word. For example in order to enter the word “this” the user may first tap on the keys 270002 and 270001, and then provide the gliding action 270118.

Obviously, the tapping and/or gliding actions may be provided to duplicate interacting with the first and/or second dynamic keypads of the invention.

According to one embodiment of the invention, the first keypad of the invention may be located on a predefined location on a touch sensitive surface such as the touch screen of a corresponding device. The user may provide the first input information corresponding to the desired word through said keypad by providing the gliding and/or tapping actions as described. If the word proposed by the system corresponding to said input information, is not the desired word, then the user may proceed to the correction procedure of the invention through a fixed second keypad (e.g. by tapping on the corresponding keys of the second keypad) or a second keypad (e.g. providing gliding actions duplicating interacting with the keys of the corresponding predefined virtual/imaginary second keypad) of the invention as described before.

According to another embodiment of the invention, interacting such as providing dynamic tapping and/or single/compound gliding actions on a first location (e.g. anywhere on the right side) of a sensitive surface may duplicate interacting with the keys of the first keypad of the invention, and interacting such as providing dynamic tapping and/or gliding actions on a second location (e.g. anywhere on the left side) of a sensitive surface may duplicate interacting with the keys of the second keypad of the invention. For example, by considering the embodiments 30 to 30a, and considering that said first and second keypads are virtual keypad models, dynamic tapping/gliding actions on the right side on a touch sensitive surface may duplicate the interactions with the keys of the first keypad described in said embodiments, and dynamic tapping/gliding actions on the left side on a touch sensitive surface may duplicate the interactions with the keys of the second keypad of the invention.

In order for the system to distinguish between the gliding/tapping actions corresponding to the keys of the first and the second keypad several other methods may be considered.

If the first keypad of the system is a touch sensitive fixed keypad, then according to one embodiment the gliding/tapping actions provided on said keypad correspond to interacting with the keys of the first keypad. In this embodiment the gliding/tapping actions corresponding to the second keypad of the invention (e.g. for correction procedure) are preferably provided outside the surface of the first keypad.

It the first keypad of the invention is a dynamic keypad, then obviously preferably the gliding/tapping actions corresponding to interacting with said keypad may be provided at any location on the touch sensitive surface. Different methods may be considered to distinguish the gliding/tapping actions corresponding to interacting with the keys of the first keypad from the gliding/tapping actions provided for interacting with the keys of the second keypad.

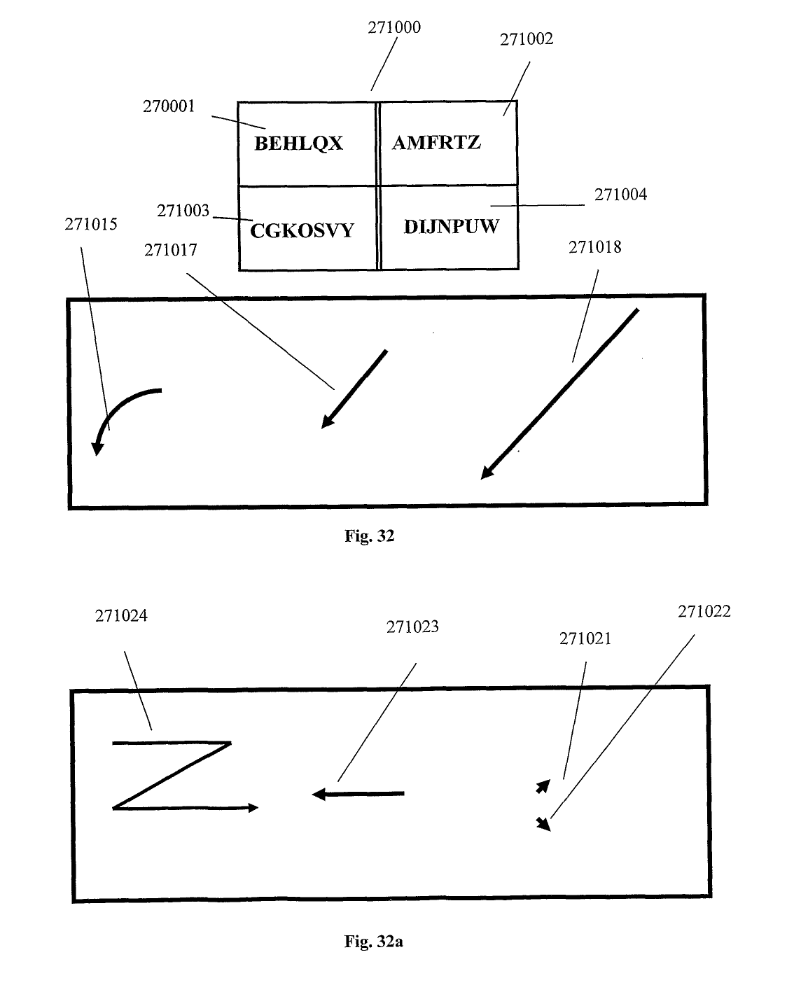

According to one method, short gliding actions may correspond to duplicate interacting with the keys of the first keypad and long (e.g. or curved) gliding actions may correspond to duplicate interacting with the keys of the second keypad, or vise versus. As shows in FIG. 32, as an example, short straight gliding action 271017 provided (anywhere) on the screen of a touch sensitive surface may correspond to the corresponding to interacting with the keys 271002 and 271003 of the corresponding first keypad model 271000, and long straight gliding action 271018 of alternatively curved gliding action 271015 provided (anywhere) on the screen of a touch sensitive surface may correspond to the corresponding key of the corresponding second keypad (e.g. the telephone keypad key having the letters “pqrs, not shown).

In the methods above, because the tapping action may also be used for duplicating interaction with the first and the second keypad, then according to one method, preferably tapping actions corresponding to interacting with the keys of the first keypad may be replaced by very short gliding actions from the center of said keypad towards the corresponding keys. Obviously, because the keypad is a dynamic keypad, preferably generally, the gliding actions may be provided at any location on the touch sensitive surface. As shows in FIG. 32a, the very short gliding actions 271021 and 271022 may correspond to interacting with the respectively the keys 271002 and 271004 of the first keypad 271000. The longer straight gliding action 271023 corresponds to interacting with the keys 271002 and 271001. The compound trajectory gliding action 271024 corresponds to interacting with the keys 271001, 271002, 271003, and 271004.

According to one embodiment of the invention, in addition to words, the database of the invention may also include the stems, wherein each of said stems may be assigned to a predefined interaction such as a long pressing action on one of the keys of the first keypad (e.g. preferably the key having the beginning letter of said stem. For example the stem “ture” may be assigned to the key of the first keypad having the letter “t”. As an example, in order to enter the word “future”, the user may short-press each of the keys 271002, and 271004, and provide a long pressing action on the key 271002. The system may look for a word in the dictionary that corresponds to an ambiguous letter corresponding to each of the short pressing actions and also corresponding to an ambiguous stem corresponding to the long pressing action and proposes the word corresponding to said input information and propose the for example, the word having the highest priority.

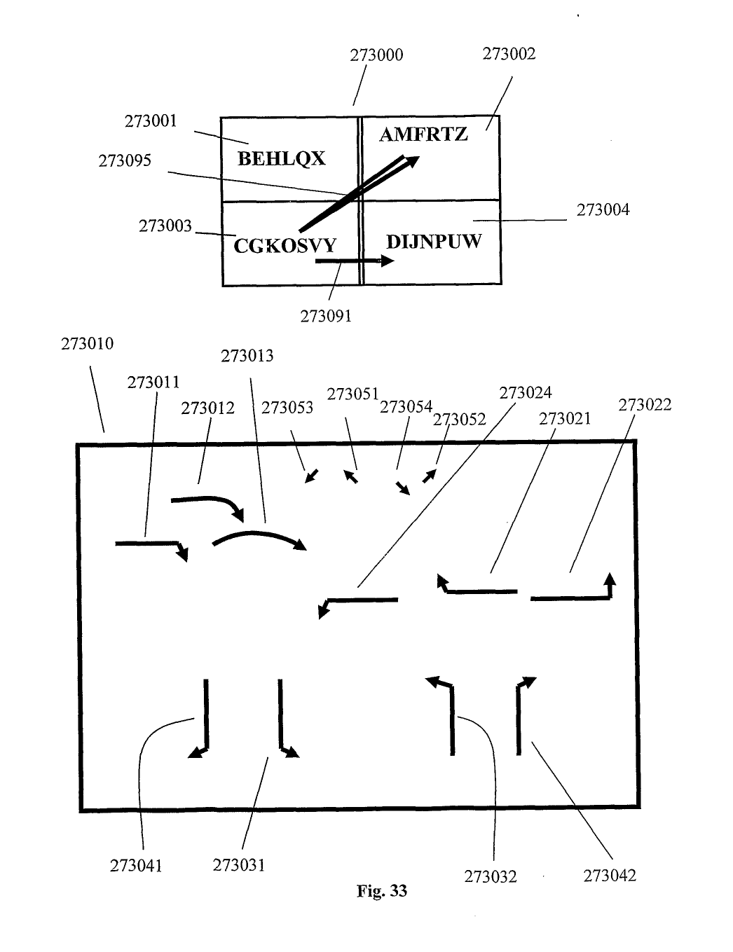

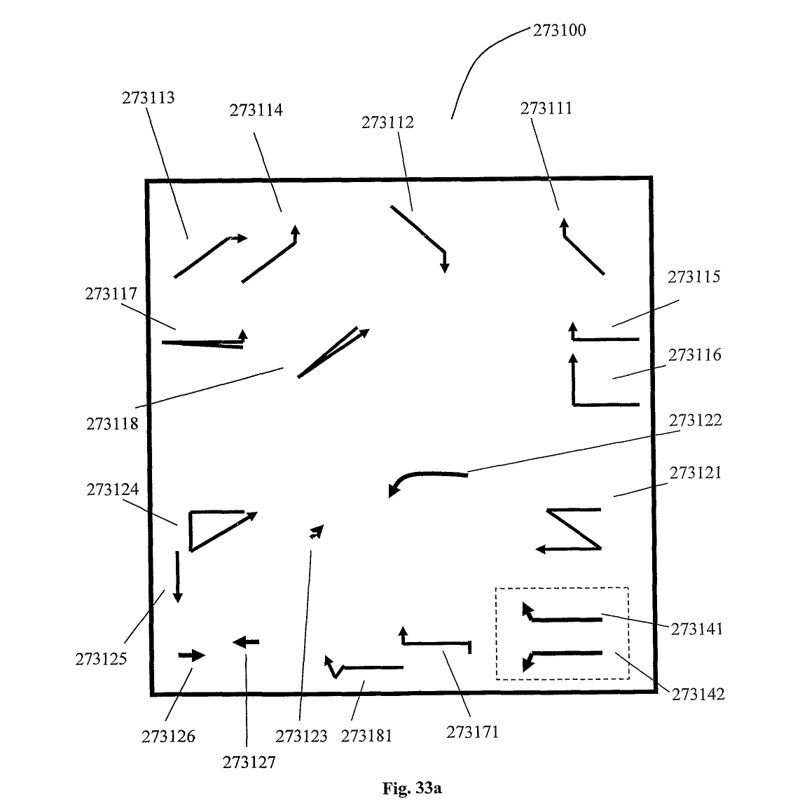

According to one embodiment of the invention, the gliding/tapping actions anywhere on the screen corresponding to the correction procedure of the invention may be maintained as they were described earlier, and a different method of gliding actions anywhere on the screen may be considered duplicating the gliding actions provided on a virtual/predefined first keypad of the invention for the entry of the word (e.g. providing the first input information). Optionally, said different method of gliding actions may, generally, preferably being consisted of a continuous gliding actions that includes more than one single straight gliding action having different directions as will be described hereafter. In addition, in some cases, a gliding action relating to the first keypad may be consisted of a single very short gliding action. This method is a logical method and may easily be adopted by the users. It is described in detail hereafter. FIG. 33 which includes the virtual/imaginary predefined keypad model 273000, shows some of the principles of such different method of gliding action duplicating the interactions with the first keypad of the invention.

As mentioned before, a very short gliding action on any location on the (e.g. touch sensitive) surface relating-to/of a device, duplicating a gliding action departing from the center of the letter keys of the virtual first keypad 273000 towards the desired key (e.g. or predefinely in the opposite direction) may duplicate a tapping action on said key. For example, each of the short gliding actions 273051, 273052, 273053, 273054, respectively duplicates a tapping action on the keys 273001, 273002, 273003, 273004, of the virtual keypad 273000.

According to one method, compound/complex gliding actions such a long gliding action combined/continued with a very short gliding action (or vise versus) without removing/lifting the finger/stylus from the (touch sensitive) surface may duplicate interacting with two letter keys of the first keypad 273000 of the invention. The longer line and its trajectory may correspond to interacting with the two corresponding keys on the side of the keypad to which the shorter line trajectory points to. As an example, the gliding action 273011 duplicates an imaginary/virtual gliding action 273091 on the keys 273003 and 273004 (e.g. interacting with said keys) of the virtual keypad model 273000. In this example, the long gliding action defines interacting with two keys from left to right in a landscape row, and the ending portion of the trajectory (e.g. the short gliding action) pointing towards down informs the system that said line/row of keys is the bottom row keys. Accordingly, the gliding action 273021 corresponds to interacting with the keys 273002 and 273001, the gliding action 273022 corresponds to interacting with the keys 273001 and 273002, the gliding action 273024 corresponds to interacting with the keys 273004 and 273003. Also, the gliding action 273031 corresponds to interacting with the keys 273002 and 273004, the gliding action 273032 corresponds to interacting with the keys 273003 and 273001, the gliding action 273041 corresponds to interacting with the keys 273001 and 273003, the gliding action 273042 corresponds to interacting with the keys 273004 and 273002.

It must be noted that the short and long lines and the trajectory of the short line are used as demonstration only. Other form of trajectories for achieving the same results may be considered by people skilled in the art. For example, in the examples above wherein the trajectories have two continuous straight lines, a long straight line ending curved towards the desired side of the first keypad may be used for the same purpose. For example, in the example wherein the trajectory 273011 has two continuous straight lines, a long straight line/trajectory ending curved towards the desired side 273012 may be used for the same purpose. Still for more simplifying said gliding action a curved line/trajectory ending towards the desired side 273013 may be used for the same purpose.

The same principles may be used for the diagonal trajectories. It must be noted that although a single straight diagonal line may be enough to define interacting with the corresponding keys, because the same line may-be/is used in the correction procedure of the invention (e.g. with the 2^{nd} keypad), therefore to avoid confusion the diagonal gliding action corresponding to interacting with the keys of the first keypad preferably may have a long gliding action ending with a short gliding action as described above. As shown in FIG. 33a, as an example, the trajectory 273111 corresponds to interacting with the keys 273004 and 273001. Accordingly, the trajectory 273112 corresponds to interacting with the keys 273001 and 273004. The direction of the short gliding action used with the diagonal gliding action may be in any direction other than the long diagonal gliding action. For example, the gliding actions 273113 and 273114 may correspond to interacting with the same keys 273003 and 273002, of the keypad 273000.

If the user provides a gliding action that duplicates interacting more than two times with the keys of the first keypad 273000, then:
If the interaction is provides with two keys on the same side, said gliding action should end with continuous additional short gliding action indicating the corresponding side of the keypad as described above. For example, the gliding action 273117 corresponds to interacting with the keys 273002, 273001, 2731002.
Other gliding actions corresponding to interacting more than two times with the keys of the first keypad may not need to include the additional continuous short gliding action. For example, the gliding action 273118 duplicates an imaginary/virtual gliding action 273095 on the keys 273002, 27303, 273002 of the keypad model 273000 of FIG. 273. Accordingly, the gliding action 273116 having two long continuous straight gliding actions corresponds to interacting with the keys 273004, 273003, 273001, while the gliding action 273115 having long and short gliding actions corresponds to interacting with the keys 273002 and 273001.

By considering the principles of the gliding actions corresponding to the first and second keypads of the invention as described, as an example, in order to enter the sentence “this is a test” the user may first provide the gliding action 273121 corresponding to the word “this” (e.g. the trajectory of the gliding action duplicates the gliding action over the keys 273002, 273001, 273004, 273003 of the keypad model 273000). He then may provide the gliding action 273122 that corresponds to the word “is”. The user then may provide the short gliding action 273123 that corresponds to a single pressing action on the key 273002 of the keypad 273000 causing the system to propose the letter “a”. The user, then, may provide the gliding action 273124 that corresponds to the word “rest”. This is not the word that the user desired to enter. The user proceeds to the correction procedure of the invention by providing a straight gliding action (e.g. without additional short gliding action) downward 273125. Based on the principles of the as described, the system understands/knows that the single long gliding action provided by the user corresponds to the correction procedure of the invention and duplicates interacting with the key of the second keypad of the invention that includes the letters “tuv”. Based on the principles of the correction procedure of the invention the system replaces the word “rest” by the word “test”. Obviously, between the entry of each of said words the user may enter a space character. For that purpose, a very short gliding action towards the right side 273126 anywhere on the surface may correspond to a space character. Accordingly, a very short gliding action towards the left side 273127 anywhere on the surface may correspond to a BackSpace function.

It must again be noted that a word of the dictionary may be entered by providing corresponding several gliding actions wherein the user can lift/remove his finger from the surface after providing each of said gliding actions. After providing all of the gliding actions corresponding to the entry of a word, the user may provide an end-of-the-word signal such as a space character. The gliding actions provided after that end-of-the-word signal will not be combined with the gliding actions provided before said end-of-the-word signal to predict/propose a word. As an example, in the example above, instead of the (complex) gliding action 273121 for entering the word “this”, the user may provide two separate gliding actions, 273141 (e.g. corresponding to interacting with the keys 273002 and 273001) and 273142 (e.g. corresponding to interacting with the keys 273004 and 273003) to provide the same word.

Other additional gliding rules deriving from the principles described here may be considered to simplify or accelerate the entry a word. For example, providing a number of (e.g. one or more) short gliding actions, at the beginning, in the middle, or at the end, of one of the within a compound/complex gliding actions (e.g. as described above) may correspond to interacting a number of times equal to said number of short gliding action with the corresponding key represented at that location. As an example, the gliding action 273115 may correspond to interacting with keys 273002, 273001 (e.g., corresponding to the word “me”) and the gliding action 273171 may correspond to interacting with keys 273002, 273002, 273001 (e.g., corresponding to the word “are”). Accordingly, the gliding action 273181 may correspond to interacting with keys 273002, 273001, 273001 (e.g., corresponding to the word “the”).

Using gliding actions for entry of a word while preferably the first keypad of the invention has only four letter keys (e.g. forming a two by two array of keys) has great advantage over methods of gliding actions using a large number of keys such as a full QWERTY keyboard. The user of the data entry system of the invention can easily and blindly remember the location of said four letter keys relating to each other. In addition, such simple keypad also requires simple gliding actions permitting the system to easily recognize the corresponding key interaction although the gliding action can be provided almost anywhere on the corresponding (touch sensitive) surface.

It must be noted that other features of the data entry system using the first and the second keypads of the invention may also be duplicated through the gliding systems of the invention. For example, the user may provide a short gliding action corresponding to duplicating an interaction with a key of the first keypad and do not lift/remove his finger/stylus from the (touch sensitive) surface for at least a predefined laps of time (e.g. a gliding and holding action) causing the system to enter into the corresponding mode instance/procedure (e.g. “TEXT”, “ARITH”, etc.). In addition to the four diagonal direction corresponding to four keys of the first keypad and their corresponding mode instances, a short gliding and holding action upward and a short gliding and holding action downward on the screen may correspond to tow additional different mode instances.

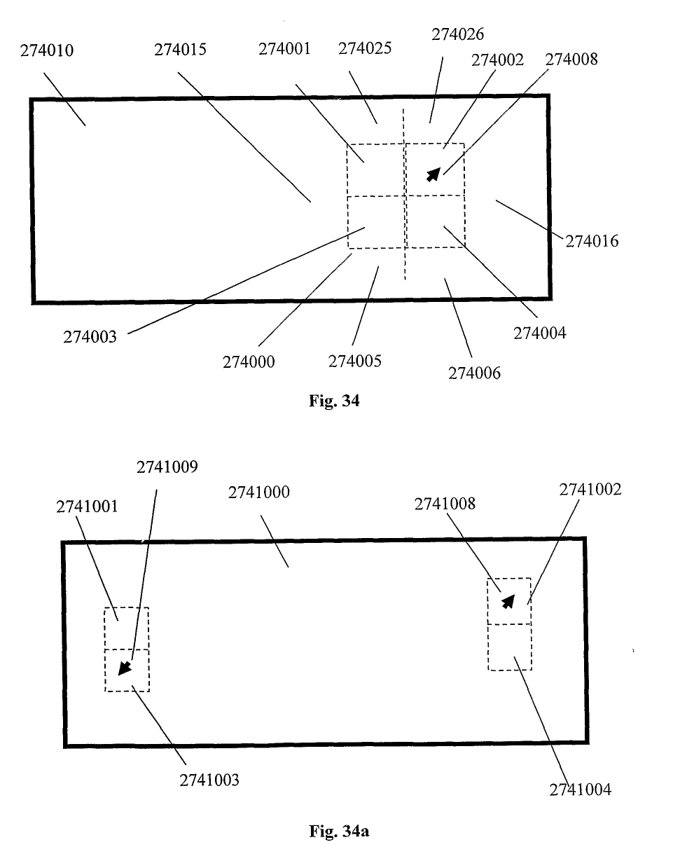

As mentioned before, a very short gliding action on any location on the (e.g. touch sensitive) surface relating to a device, duplicating a gliding action departing from the center of the letter keys of the virtual first keypad such as the keypad 273000 of FIG. 33 towards the desired key may duplicate a tapping action on said key. According to one embodiment of the invention said method may be used to dynamically define the location of any corresponding key of the first keypad of the invention. FIG. 34 shows as an example, a short gliding action 274008 provided on the screen 274000 of a device. Said gliding action corresponds to the key 273002 of the keypad 273000 of FIG. 33. Providing such gliding action may inform the system to define a dynamic keypad 274000 duplicating the virtual keypad 273000 on the screen 274010 wherein the location of the key 274002 of the dynamic keypad being a (predefined size of) zone around said short gliding action, and based on that the system defines the location of the other keys of the dynamic keypad. In this example, the system accordingly has defined the letter keys 274001-274004. According to one method, if the user presses/taps on a zone at the right side of the median line 274050 outside the right keys 274002 and 274004 (e.g. the zones 274006, 274016, 274026), then said tapping action may be interpreted as interacting with at least an additional key such as the space key of the first keypad 274000 (e.g. the (space) key has been shown in various figures in this application). Accordingly, if the user presses/taps on a zone at the left side of the median line 274050 outside the left keys 274001 and 274003 (e.g. the zones 274005, 274015, 274025) then said tapping action may be interpreted as interacting with at least an additional key such as the BackSpace key of the first keypad 274000 (e.g. the (BackSpace) key has been shown in various figures in this application).

It must be noted that after the system defines the dynamic first keypad of the invention, the user may continue to interact with its keys by providing tapping actions on the dynamic keys. Obviously every time the user provides the calibrating short gliding action on any location on the surface, the system recalibrates the dynamic keypad.

Obviously, the dynamic keypad as being defined/described above is being shown as an example only. Other forms of dynamic keypads may be suggested. For example, the location of the right keys could be defined based on location of the short gliding action provided by the user, and the left keys can be at any location on the same horizontal level on the screen. In this case/example, the space key may be defined to be on the lower side of the two right keys, and the backspace key may be defined to be on the lower side of the left two keys, etc.

According to another method, the user can define the location of the dynamic keys of each side of the keypad as/where he desires. For this purpose, as an example, the user may provide a calibrating short gliding action for each pair of keys of each sides of the keypad. FIG. 34a shows as an example, two short gliding actions 2741008, 2741009 provided by the user on each side of the surface 2741000 wherein each said short gliding actions independently defines the dynamic keys on the corresponding side of the dynamic keypad of the invention.

It must be noted that showing/hiding the first and the second keypad(s) may be optionally decided, for example by the user.

It must be noted that although in this patent application different means and methods such as a first and at least a second keypad, taping and/or gliding actions, etc., are being described to provide the input signals corresponding to the first set of input signals and said at least one additional/second set of input signals, obviously, other means and methods may be used for the same purpose by people skilled in the art.

According to one embodiment, in the middle of the entry of (e.g. a non-completed) word, the user may proceed to correction procedure to correct said portion such that to correspond to the beginning characters of the desired word so that when he continues to enter the remaining characters of the word, at least said beginning portion of the word does not fluctuate (e.g. does not change) on the screen. According to one method, for example, during the pressing actions provided on the first keypad corresponding to an ambiguous word, the user may provide the interaction with the keys of the second keypad so that to provide the additional input information corresponding to correcting the word that the system is going to propose (e.g. before the wrong word is being proposed).

According to one embodiment, the user may place the cursor after any character of the proposed word to change said character by pressing the corresponding key of the second keypad. It must be noted that the correction procedure (e.g. pressing action(s) on the keys of the second keypad for correcting/changing a proposed word) may preferably be possible if the cursor is located at a predefined position relating to said word such as at the end of said word/chain of characters (e.g. preferably, predefinely after the last character of said word). This permits to correct a (e.g. non-desired) word either immediately after the system proposes it, or accepting said non-desired word and later proceeding to the correction procedure by for example repositioning the cursor at the end of said (non-desired) word.

It must be noted that in several patent application filed by this inventor, many features and methods have been described to improve the easiness and speed of the data entry in the mobile environment. Obviously, in many cases those methods and features may be used separately or being combined.

It must be noted that the first and the second keypads of the invention are shown as examples to demonstrate the different embodiments, methods, features, etc., of the data entry system of the invention. Optionally, said keypads may have any number of keys having any shape, any key configuration, any configuration of symbols on their keys, any type of keys (hard, soft, on-screen, zones, etc.), using any type of surface including but not limited to touch-sensitive surface, etc. Additionally, the system may be designed such that to permit different types of predefined interactions to provide different input signals. Also, the symbols of the system may be grouped in any number of groups based of any (e.g. arbitrary) category, etc., all of that by respecting the principles of the data entry system of the invention.

It must be noted that the arrangement of at least the keys of the second keypad of the invention may be different than those shown and described in this patent application. Said keys may preferably be arranged such that to ease the recognition of the intended key interaction by the system, through a corresponding gliding action providing by the user.

According to one embodiment of the invention, during providing a gliding action on for example a touch sensitive surface if the user does not move his/her finger on said surface for at least a predefined laps of time and immediately after that removes his/her finger from said surface, the system does not consider said gliding action and optionally does not provide any action relating to said gliding action.

The gliding actions corresponding to interaction with the keys of the second keypad are generally shown and described as to depart-from or end-at the center key (e.g. the key to which the digit 5 is assigned) of a telephone type keypad. Obviously, any type of gliding action, departing from or ending at any other key may predefinely be considered to duplicate the interaction with different corresponding keys of the second keypad of the invention.

Assigning ambiguously substantially all of the alphanumerical characters of at least one language and/or the special characters thereof to four keys of a first keypad having few keys wherein said four keys forming two columns wherein each columns includes two of said keys, and using them either by one finger or using each of said columns with a different user's thumb, and additionally, assigning unambiguously substantially all of the alphanumerical characters of at least one language and/or the special characters thereof to gliding/taping actions anywhere on a surface combined with pressing one of said few keys of the first keypad mainly under thumbs (e.g. mode instances) permits the user an eye free very fast and easy complete data entry such as rich text entry. Still additionally, as described earlier, when user intends so, the system may be designed to automatically relate user's gliding/taping actions to mouse functionalities.

Optionally, few more keys such as one or two keys at each side of said four letter keys, may be provided and be used for example for providing more mode keys assigned to additional groups of special symbols, or being used as mouse keys. Preferably, said four keys may be closed to each other, and said more keys may at a farer distance from said four keys. If said letter keys are split keys, for example, in addition to two letter keys on each of the two side of a device, the first keypad may have two more keys on each of said sides to the resembling to a standard gaming device interface having four keys on each side.

The data entry system of the invention may be used to enter text in any language those having alphabetical characters such as Italian, Arabic, Korean, and those having phonetic symbols such as Chinese and Japanese. In languages using phonetic symbols to input text, instead of the letters as described throughout this application, the phonetic symbols may be assigned to the keys of the first and at least one additional/second keypads of the invention by respecting the principles of the distribution of symbols as described in detail.

According to some embodiments o the invention the gliding/taping actions relating to at least the second keypad may be provided in the space/air. In order to ro recognize said gliding actions, the system may be equipped with appropriate detecting and receiving means such as a camera.

A mouse having a touchpad is an important feature of a laptop computer. Although the touch sensitive pad of a mouse is user-friendly, there is at least one major problem when using it: even a slight contact with the mouse touch sensitive pad may provide an unintentional mouse (e.g. navigating) procedure. For example while a the user is typing on the computer keyboard many times his hands may touch the mouse touch sensitive pad which causes undesired mouse interaction. Some computer manufacturers such as HP have provided a switching button within that type of mouse so that to inactivate or deactivate that mouse. Obviously such switching actions are uncomfortable for the user.

According to one embodiment of the invention, a mouse security means may be integrated/attached to the computers having such type of mouse such that the computer system may recognize the intention of user and to avoid an unintentional activation of said mouse when the user does not intend it. According to one embodiment of the invention, an input receiving means (naturally) interacting with the palm of user's hand when the user uses the mouse touchpad may be located/integrated within said computer. The location and form of such means may be such that when for example the user lays his hand on the computer during typing, said means is not interacted with (e.g. is not (naturally) touched by) a portion (palm of) of the user's hand.

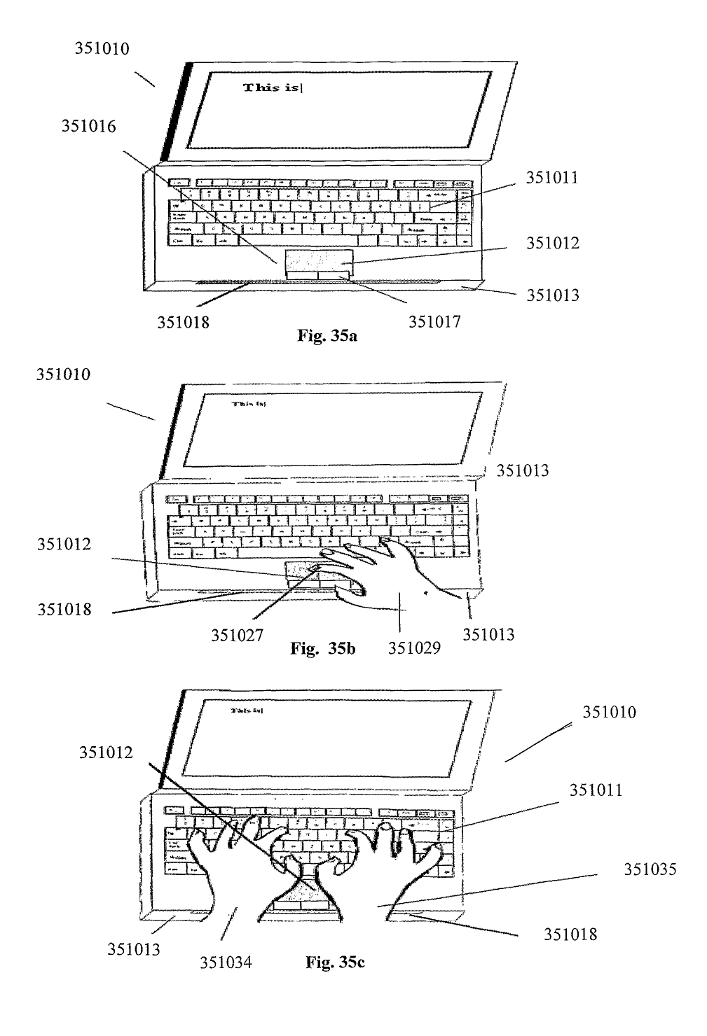

According to a preferred embodiment, the mouse security means is in form of a narrow and long touch sensitive pad being located on the lateral (e.g. diagonal, vertical) surface under the front surface where the keyboard and/or the mouse touch pad are located. FIG. 35a shows as an example a laptop computer 351010 having a keyboard 351011 and a mouse system 351016 having a mouse touch sensitive pad 351012 and mouse buttons 351017. In addition to the mouse touch sensitive pad 351012 said mouse system may also include an additional touch sensitive pad 351018 used as the mouse security means based on the principles as described above.

As shown in FIG. 35b, when the user lays his hand on the computer 351010 and uses (e.g. interacts with his finger 351027 with) said mouse touch sensitive pad 351012 generally the palm of his hand 351029 naturally interacts-with/touches said mouse security touch sensitive pad 351018 which in this example is preferably located on the lateral side 351013 of the device 351010 under the mouse navigating pad 351012 (e.g. lateral side of the device under the mouse, may be vertical or diagonal relative to said front side). By receiving simultaneously, touching inputs from both the mouse security sensitive pad 351018 and the mouse navigation touchpad 351012 the system understands that the interaction with the mouse touch sensitive pad 351012 has been provided intentionally and considers said mouse interactions and provides the corresponding mouse functionalities.

On the other hand, as shown in FIG. 35c, when the user uses (e.g. interacts with or types on) the keyboard 351011, his hands 351034, 351035 generally do not interact with said mouse security pad 351018 (e.g. as mentioned before, in this example the security touch sensitive pad 351018 is preferably located on the vertical side 351013 of the device 351010) therefore even the user's hand erroneously interacts with the mouse pad 351012 because his hands do not (e.g. simultaneously) interact with the mouse security touch sensitive pad 351018 the system understands that the interaction provided by the user with the mouse touch sensitive pad 351012 has been provided erroneously and therefore the system does not consider that interaction with the mouse touch sensitive pad 351012.

As shown in FIGS. 35a to 35c the security touch sensitive pad 351018 may preferably may have a longish form so that to permit to, both, left-handed and right-handed people to benefit from its performance. Obviously, instead of a touch sensitive pad, any other input means being able to detect the location of the user's palm may be considered by people skilled in the art. For example, instead of said touch sensitive security pad the mouse system may include an (e.g. longish) optical input means, etc.

The principles of the mouse security system regarding laptops as just described may be generalized such that to be implemented within other devices. Said principles include:
researching to define if another portion of a user's hand interacts with another predefined location of the body of a device when a first predefined means of said device is interacted with the user's finger;
researching to define if another portion of a user's hand interacts with said predefined another location of the body of the device when a second predefined means of said device is interacted with the user's finger;
implementing a touch sensitive means on/relative-to said predefined location of the device if said predefined location is not interacted by another portion of user's hand during said interactions with both the first and the second predefined means.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature.

1. A data entry system, comprising:
a plurality of first keys;
a plurality of second keys;
a display; and
a processor adapted to interpret a first type of user interaction with the first keys as entrance of one or more characters and to interpret a second type of interaction with the first keys as mode signals which change the meanings of at least three of the second keys.

2. A system according to claim 1, wherein the first type of user interaction comprises actuation for a short period and wherein the second type of user interaction comprises actuation for a longer period.

3. A system according to claim 1, wherein the second keys comprise soft keys.

4. A data entry system, comprising:
a user input interface adapted to receive user signals in the form of directed vectors; and
a processor adapted to interpret at least five different directed vectors received by the user input interface as corresponding to keys of the 12 key telephone keypad located in the direction of the vector from a start point.

5. A system according to claim 4, wherein the processor is adapted to interpret at least seven different directed vectors received by the user input interface as corresponding to keys of the 12 key telephone keypad.

6. A system according to claim 4, wherein the processor is adapted to interpret the directed vectors as corresponding to keys of the 12 key telephone keypad located in the direction of the vector from a center key of the keypad.

7. A system according to claim 4, wherein the user input interface comprises a touch screen and interprets sweeping gestures on the touch pad as vectors.

8. A system according to claim 7, wherein the input interface is adapted to interpret the direction of the sweeping of the gesture as a straight line from its start point to its ending point.

9. A system according to claim 7, wherein the input interface is adapted to interpret sweeping gestures on the screen which include curves as a plurality of separate vectors, each straight line segment corresponding separately to a key of the 12 key telephone keypad.

10. A system according to claim 4, wherein the user input interface comprises a plurality of keys and interprets pressing of key sequences as vectors in the direction from the first key in the sequence to the last key in the sequence.

11. A data entry system, comprising:
a user input interface adapted to receive user signals corresponding ambiguously to letters of the alphabet and to receive a fixation signal; and
a processor adapted to receive user signals corresponding ambiguously to letters for a plurality of character positions of a word and to provide guess letters for the character positions, wherein the processor is adapted to update its guesses of character positions responsive to receiving additional user signals corresponding ambiguously to letters for the same word and wherein the processor does not change the letters of character positions for which the fixation signal was applied.

12. The system of claim 11, wherein the fixation signal is received responsive to simultaneous pressing of two keys.

13. The system of claim 11, wherein the fixation signal applies to a single character position each time it is pressed.

14. The system of claim 11, wherein the fixation signal applies to all the character positions in a current word, before a current cursor position.

15. The system of claim 11, wherein the fixation signal applies to a first ambiguous character position of the current word, regardless of a current cursor position.

16. A data entry system, comprising:
a user input interface adapted to receive input signals corresponding to characters, including signals corresponding ambiguously to a plurality of characters;
a screen; and
a processor adapted to select for character positions for which an input signal corresponding ambiguously to a plurality of characters was received, a single character to represent the character position, and to display, on the screen, for each character position, a single character, in a manner which differentiates between character positions associated ambiguously with a plurality of characters and character positions associated with a single character.

17. The system of claim 16, wherein the processor displays characters in character positions associated ambiguously with a plurality of characters in a different color than characters in character positions associated with a single character.

18. The system of claim 16, wherein the processor displays adjacent character positions associated ambiguously with a plurality of characters markings not displayed near character positions associated with a single character.

19. The system of claim 16, wherein the processor displays character positions associated ambiguously with a plurality of characters in a manner which associates the character position with a key of the user input interface which is used to generate the specific plurality of characters of the character position.

20. A data entry unit, comprising:
a touch screen; and
a processor adapted to interpret sweeping gestures on the touch screen as indicating one or more characters, according to a trajectory and starting point of the sweeping gesture,
wherein the touch screen is considered to be divided into up to 10 zones each covering at least 10% of the area of the touch screen, and sweeping gestures of a specific trajectory starting anywhere in a zone are interpreted to correspond to the same one or more characters.

21. The unit of claim 20, wherein the touch screen is considered as divided into at most six zones.

22. The unit of claim 20, wherein the touch screen is considered divided into two zones.

23. A data entry unit, comprising:
a plurality of first keys including fewer than 10 keys, which together are associated with all the letters of the alphabet;
a touch screen; and
a processor adapted to associate character positions of input words with groups of characters responsive to first key actuations and to provide on the touch screen soft keys for each of the letters associated with the first character position of the current word which is associated ambiguously with a plurality of characters, regardless of which first key was pressed most recently.

24. The data entry unit of claim 23, wherein responsive to actuation of a soft key to associate the first character position of the current word which is associated ambiguously with a plurality of characters with the character of the actuated soft key and to automatically provide soft keys for the subsequent first character position of the current word which is associated ambiguously with a plurality of characters.

25. The data entry unit of claim 23, wherein a plurality of the first keys are associated with at least one non-alphanumeric symbol.

26. The data entry unit of claim 25, wherein each of two or more of the first keys is associated with a plurality of non-alphanumeric symbols.

27. A data entry unit, comprising:
a user input interface adapted to identify user movements;
a screen; and
a processor adapted to control reception of words and their display on the screen and to control a mouse pointer on the screen responsive to identified user movements when the processor is not in the middle of entering a word and to interpret identified user movements as referring to groups of one or more characters when the processor is in the middle of receiving a word.

28. The unit of claim 27, wherein the screen comprises a touch screen and the user input interface identifies the user movements on the touch screen.

29. The unit of claim 27, wherein the user input interface identifies movements of fingers in the air.

30. The unit of claim 27 wherein the processor is considered in the middle of receiving a word immediately after receiving an input signal corresponding to one or more letters and is considered not in the middle of receiving a word immediately after receiving a space signal, a return signal or a tab signal.

31. A telephone unit, comprising:
a touch sensitive surface; and
a controller adapted to identify sweeping gestures on the touch sensitive surface, to correlate the sweeping gestures with digits according to the direction of the gestures and to dial a telephone number form of a sequence of digits determined from sweeping gestures.

32. The telephone unit of claim 31, wherein the controller is adapted to identify the digits corresponding to sweeping gestures, without relation to their starting point on the surface.

33. The telephone unit of claim 31, wherein the controller is adapted to identify the digits corresponding to at least some of the sweeping gestures, as the digit on the key of the known 12 key telephone keypad in the direction of the sweeping gesture from the middle key corresponding to the digit 5 of the 12 key telephone keypad.

34. The telephone unit of claim 31, wherein the controller is adapted to identify a tapping on the surface as the digit 5.

35. The telephone unit of claim 31, wherein the controller is adapted to associate the sweeping gestures with digits without relation to the length of the sweeping gestures except possibly for a single direction.

36. The telephone unit of claim 35, wherein the controller is adapted to identify a short downward sweeping gesture as the digit 8 and a longer downward sweeping gesture as the digit 0.
